(19) United States
(12) Patent Application Publication
(10) Pub. No.: US 2018/0365628 A1
(43) Pub. Date: Dec. 20, 2018

(54) AGILE TEAMS FREELANCE-SOURCING: ONLINE SYSTEM AND METHOD FOR ENHANCING SUCCESS POTENTIAL OF FREELANCE PROJECTS

(71) Applicant: Sujith Kattathara Bhaskaran, Kochi (IN)

(72) Inventor: Sujith Kattathara Bhaskaran, Kochi (IN)

(21) Appl. No.: 16/007,436

(22) Filed: Jun. 13, 2018

(30) Foreign Application Priority Data
Jun. 16, 2017 (IN) 201741021109

(51) Int. Cl. G06Q 10/06

(52) U.S. Cl. CPC G06Q 10/063118; G06Q 10/06314; G06Q 10/063112; G06Q 10/06393

(57) ABSTRACT

The present invention relates to an Online Freelancing system 300 having an Online Freelance platform 302, Project Managers 304, Freelancers 306, Customers 308, Freelance Companies 309, and jobs, and a method that enhances success potential of Freelance projects. The Online Freelance Platform 302 forms a hub of the proposed system and connects other major elements. The Customer 308 publishes the job in the said system 300. The Project Manager 304 reviews, analyse, and estimate the job, and determine the tentative number of Freelancers 306 and Freelance Company 309 having appropriate number of Freelancers required, engages a combination of Freelance Company 309 and Freelancers 306 as required by the job published. Freelance Project Management is implemented using Agile or Scrum or Sprints methodology to enable iterative and incremental requirements gathering and work execution approaches into jobs execution, thus making jobs execution structured and modular, and trackable.

### STATEMENT OF RELATED APPLICATIONS

This patent application is the non-provisional of and claims the benefit of Indian Patent Application No. 201741021109 having a filing date of 16 Jun. 2017.

### BACKGROUND OF THE INVENTION

### Technical Field

The present invention relates to an Online Freelancing system, and more particularly to a system and method for enhancing success potential of large jobs, projects and project portfolios using said Online Freelancing system.

Despite a very significant opportunity to cut expenditure and improve their financial bottom line, Customers of Freelancing services are reluctant to execute a major portion of their Organizational work streams comprising large jobs or projects and Project Portfolios via Online Freelancing systems. Instead, they prefer to have their complex work executed using in-house resources or via outsourced teams. This reluctance stems from systemic shortfalls in existing Online Freelancing systems and the significant risk expected while executing work via Online Freelancing systems. The anticipated risks may arise from the following:

1) Existing Online Freelancing systems' inability to force structure, modularity, traceability, and verifiability into Customer jobs' definition.

2) Existing Online Freelancing systems' inability to provide insight into Freelancers' and Project Managers' Freelance work domain exposure, skills and skill levels.

3) Existing Online Freelancing systems' inability to provide insight into Freelancers' bandwidth availability to support jobs.

4) Existing Online Freelancing systems' inability to provide insights into Freelancers' prior experience in execution or delivery of jobs with job type and job complexity similar to that of proposed Customer jobs.

5) Existing Online Freelancing systems' inability to provide insights into Project Managers' prior experience in leadership of jobs with job type and job complexity similar to that of proposed Customer jobs.

6) Existing Online Freelancing systems' inability to support planning of large projects effectively in a collaborative fashion.

7) Existing Online Freelancing systems' inability to provide visibility into work execution status consistently across all job Stakeholders.

8) Existing Online Freelancing systems' inability to provide control over remotely working Freelancers and their productivity or effectiveness.

9) Existing Online Freelancing systems' inability to enable monitoring and assurance of quality of Freelancer service delivery.

10) Existing Online Freelancing systems' inability to support dependencies within and across jobs.

11) Existing Online Freelancing systems' limited ability to force timely and accurate payments against invoices, etc.

Each Stakeholder group consisting Customers, Project Managers, Freelancers, Freelance Companies may have differing “Project success objectives”. Further, “Success potential” of jobs, projects, and Project Portfolios may be comprised of several dimensions. These “project success objectives” and “success potential dimensions” need to be carefully identified, analysed, prioritized, and actioned, in order to achieve the stated objectives in an efficient manner. There is a need for a method or system which can be utilized by Customers and Freelancers to execute their large projects and project portfolios in a transparent and effective manner, visibly and unquestionably eliminating the shortfalls that have been documented above.

### Prior Art

WO 2016/118655 A1 titled “Systems and methods for crowdsourcing technology projects” discloses a technology to enable a Customer to readily view, and securely connect with, Project Managers and Freelancers who complete projects on behalf of the Customer. A project specification is posted by the Customer through a crowd-sourcing platform. The Project Managers submit proposals through a freelancing platform and thus compete with each other. If the Customer selects a proposal, the Project Manager corresponding to the proposal can construct a team having one or more Freelancers who accomplish the technology project under the Project Manager's supervision. The Project Manager and/or freelancer(s) can be paid as and when milestones are completed, from an escrow account maintained by the administrator. Additionally, or alternatively, invoices for completed work could be generated by the team and delivered to the Customer.

In the above prior art, a system for Freelance Project Management of projects is included but the aspects that are central to the present invention are not covered such as enablement of projects success, leveraging key Project Management processes such as iterative or incremental development, Kanban Visual Management of User Stories and Features, Dependency Management, Burn-up or Burn-down charts and Critical Path Method to enable predictability of outcomes, etc. Elimination of non-payment of Freelancer invoices, leveraging practices like Milestone-based payments, implementing a Customer Credit score-like system to assess financial reliability of Customers, etc. Enablement of identification of “true matches” to specific job needs, by categorizing work items on the basis of Freelance work domains, skill needs, and Contract size, as well as capturing Freelancer Performance and leadership ratings at a granular level to make Freelancer Performance scores more reliable and context-sensitive. Enablement of Customer Project Portfolio Management to support Organizational Strategy execution. Enablement of Freelance Company Project Portfolio Management to drive up Customer focus.

U.S. Pat. No. 8,374,905 B2 titled “Predicting success of a proposed project” discloses a computer-implemented method, system, and/or computer program product envisages success of a currently proposed project. Said currently proposed project obtains responsive answers to a survey questionnaire which facilitates to create an anticipated success score for the currently proposed project, based on a pattern of responsive answers to a programmed combination of questions from the survey questionnaire. The actual success scores of previous projects are compared with and matched to the predicted success score of the currently proposed project. The proposed project is accepted for implementation if the percentage of previous projects that retained their success scores through completion exceeds a predetermined precision threshold.

The discussed prior art covers a system to predict the success of a proposed project based on two key input components such as responses to a set of questions submitted against the project and its context, and comparison of the responses received to similar responses received for historical projects. While the proposed invention does not seek to predict the success of a project, instead enhances the success potential by leveraging a series of pre-defined actions and templates or methods, like usage of Agile Iterative or Incremental development, Kanban Visual Management, Dependency Management, Agile Burn-up or Burn-down charts, Critical Path method, etc.

US 20120079449 A1 titled “Systems and methods for facilitating visual management of an agile development process” disclose systems and methods to facilitate visual management of an Agile development process are provided. A plurality of attributes to be accomplished during an Agile development procedure for a software product may be identified. A corresponding number of predetermined time units to be assigned for development of each feature may be determined. Based upon the identification of predetermined time units, each of the features may be allocated to a respective development unit included in a plurality of development units. A design of the plurality of features assigned to the plurality of development units may be created. The design may include, a respective identifier of the feature for each feature, and a respective indication of the predetermined time units allocated to the feature. The output displayed to a user is the generated design.

The above prior art seeks to depict execution schedule of simultaneous User Stories and Features being executed or planned to be executed by same or different Sprint teams on a GANTT chart-like representation, so that a Product Manager may have a view of the various tracks of execution and can eliminate blockages of key User Stories and Features while also improving Teams' utilization. In the present invention, the visual representation of work plans and execution is achieved using Kanban Boards and Cards.

US 20130007694 A1 titled “Project story board to board communication tools” discloses systems and methods provide for presenting one or more server computers having a Project Management software. The Project Management software may consist of the first storyboard with one or more stories for a first team. The first storyboard may be managed by one or more first storyboard control panels. The Project Management software may also comprise a second storyboard with one or more stories for the second team. A sub-story may be created using the one or more first storyboard control panels. In one embodiment, this sub-story may be incorporated into a backlog list for the second storyboard and a notification may be displayed on the second storyboard requesting the second team to implement the sub-story from the backlog list into the second storyboard. In another embodiment, the stories on the second storyboard may be about, but not used by, a second team. The first team may be responsible for updating the one or more stories to move the one or more stories, including the sub-story, through the second storyboard.

The above prior art seeks to implement dependency relationships between User Stories on one Kanban Board to sub-stories on another Kanban Board, and thus to identify any blockages where one User Story execution on one Kanban Board is being stopped or delayed by the non-execution of another User Story on another Kanban Board. The proposed invention uses Kanban Boards and Kanban Cards as a mechanism to provide a visual representation of work execution progress at an Epic, User Story, and Feature levels.

US 20070168918 A1 titled “Software development Planning and Management system” discloses a software development planning and management system includes at least one storage of information associating, sub-process of an encompassing software development job to be completed and a timeline of sub-process completion, programmer personnel resources, software development requirements and software faults. The repository is accessed by a user interface to provide data representing at least one display picture indicating a status of sub-task completion, including the status of sub-task software generation and test. A resource processor also uses the repository in determining programmer personnel resources required for completion of a plurality of sub-tasks.

The above prior art covers the procedures and processes used or adopted in the implementation of the Agile Software development method. The present invention uses concepts from within Agile Software development methodology, such as Iterative or Incremental Delivery, Sprints, Burn-up or Burn-down chart, etc., to execute work in the proposed Freelancing platform.

U.S. Pat. No. 8,566,779 B2 titled “Visually prioritizing information in an agile system” discloses an apparatus and method to prioritize tasks in a software development environment having drag-and-drop functionality to prioritize tasks displayed in the window of a browser application executing on a user system. In one embodiment, using information stored in a workload database object a prioritizer screen is fabricated at a server and transmitted to the user system over a network using inter-process communications.

The above prior art defines a mechanism to prioritize work items in the Product Backlog in an Agile development system so that the Sprint team can pull off the top prioritized items into the Sprint Backlog for any given sprint. The mechanism also provides a visual depiction of the prioritized Product Backlog.

### BRIEF SUMMARY OF THE INVENTION

This summary is provided to introduce a selection of concepts in a simplified manner. These concepts may be further described in the detailed description of the invention. This summary is neither intended to identify key or essential inventive concepts of the subject matter nor to determine the scope of the invention.

Any typical Organization may have a variety of work items that may need to be executed as part of the Organizational work streams, and these work items may be categorized in multiple ways like Strategic (Long-term vision, objectives, and/or execution) vs. Tactical (Shorter-term execution, operational in nature), low complexity work or relatively small work items (which may be executed by single resources) vs. more complex or relatively large work items (work that may need teams to work in collaboration to complete in a timely manner), repeatable or operational tasks (non-unique work activities) vs. Projects (combination of multiple tasks with unique work scope or duration or context) vs. Project Portfolios (Strategic objectives achieved through a series of projects and tasks), etc.

The scope of this invention is focused on the projectized, “more complex” type of work, as well as Project Portfolios that may include logical sets of projects and/or operational tasks. “Project success objectives” of jobs, projects and Project Portfolios may be defined upfront, so as to enable the design of a set of steps or actions to help achieve the documented project success objectives. The project success objectives may be defined against the Stakeholder groups which includes Customers, Project and Program Managers, Freelancers, and Freelance Companies. The “success potential” of jobs, projects, and Project Portfolios may be qualified from the following dimensions, Customer-owned factors, Project Manager-owned factors, and Freelancer-owned or Freelance Company-owned factors.

In one embodiment of the invention, a system for Online Freelancing is disclosed for enhancing success potential of large jobs, projects and project portfolios within all specified Freelance work domains. Examples of Freelance work domains may include, Desktop IT Application development, Mobile Application development, Quality Assurance and Testing, Administrative support (including virtual assistants, office administration support, etc.), creative writing, graphic design, audio or video content development, financials and accounting, translation services, Customer service agents, etc.

An embodiment of the proposed Online Freelancing system may include Freelance Project Management being implemented using Agile or Scrum or Sprints methodology, which is introduced to enable iterative and incremental requirements gathering and work execution approaches into jobs execution and outcomes delivery to Customers, making jobs execution more structured and modular, and thus more trackable. Thus, Customers may publish their jobs or projects and Project Portfolios in a structured manner by breaking down Project Portfolios into component jobs or projects, breaking down jobs or projects into job requirement groups, breaking down job requirement groups into job requirements, and mapping each job requirement to acceptance criteria, Thus, enabling upward or downward traceability across job components (job requirement groups and or job requirements) within projects, and enabling upward or downward or lateral traceability across jobs within Project Portfolios.

An embodiment of the proposed Online Freelancing system may support the visual representation of project execution status, implemented using Kanban methodology and the like, providing a single, consistent view of job execution status and outlook to all job Stakeholders.

An embodiment of the proposed Online Freelancing system may enable all job Stakeholders such as Customers, Project Managers, and Freelancers, to collaborate on jobs, using functionalities such as Instant Messenger, Whiteboard, Screen sharing, File transfer, concurrent file update, and the like.

An embodiment of the proposed Online Freelancing system may further enhance collaboration across job Stakeholders by enabling the scheduling and conduction of virtual stand-up meetings between the various job Stakeholders at appropriate periodicity, to enable improved Contract execution team communications, job monitoring, and control, and job Governance as needed between the various job Stakeholders.

The proposed Online Freelancing system may enable different User categories, such as Customers, Project Managers, Freelancers, Freelance Companies, etc., to register for membership on the system, submit the requisite information, and submit any payments as appropriate to the membership category and level of membership on the system.

The proposed Online Freelancing system may enable different user categories to renew their memberships on a periodic basis, with the periodicity being defined at the system level.

The proposed Online Freelancing system may enable users to cancel their memberships at any point in time.

The proposed Online Freelancing system may enable different user categories to upgrade their membership type, at any point in time, by submitting the required payments into the system.

The proposed Online Freelancing system may enable different user categories to downgrade their membership type, at any point of time.

The proposed Online Freelancing system may provide functionality for Project Managers to respond to Customer jobs by creating Virtual Teams of Freelancers to work on developing job proposals to be submitted to the Customer.

The proposed Online Freelancing system may provide functionality for Freelancers invited by Project Managers, to submit job component proposals to the Project Managers.

The proposed Online Freelancing system may provide functionality for Freelancers and Project Managers to identify and qualify risks against the Customer-published jobs or job requirements.

The proposed Online Freelancing system may provide functionality for Freelancers and Project Managers to identify and qualify dependencies on the Customer-published jobs or job requirements.

The proposed Online Freelancing system may provide functionality for Project Managers to integrate the various job component proposals received from various Virtual Team member Freelancers, review the integrated job proposal with the Virtual Team of Freelancers, develop a consolidated cost proposal, and then submit the integrated job-and-cost proposal to the Customer.

The proposed Online Freelancing system may provide functionality for Customers to view all job proposals (received from various Project Managers competing on the job) in a prioritized manner, using a job proposal prioritization slider that is defined by the Customer, and award the job to the Project Manager that has authored the “most acceptable” job proposal.

The proposed Online Freelancing system may provide functionality for the awarded Project Manager to develop a job Contract and submit to the Customer for review and signature.

The proposed Online Freelancing system may provide functionality for the awarded Project Manager to develop sub-Contracts for each Virtual Team member Freelancer and submit to each respective Virtual Team member Freelancer for review and signature.

The proposed Online Freelancing system may provide functionality for the Customer to review the job Contract, request changes, and approve the Contract after the negotiations on the scope, solution, price, schedule, roles and responsibilities, terms and conditions, etc. are completed.

The proposed Online Freelancing system may provide functionality for the Virtual Team member Freelancer to review the delivered sub-Contract and approve the Contract after the negotiations on the scope, solution, price, schedule, roles and responsibilities, terms and conditions, etc. are completed.

The proposed Online Freelancing system may provide functionality to the Contract execution team led by the Project Manager to break down the job into Epics, User Stories, and Features, and define acceptance criteria mapped to each User Story, thus enabling downstream or upstream traceability from the job to acceptance criteria. Further, to develop a Contract product backlog of all User Stories.

The proposed Online Freelancing system may provide functionality to the Contract execution team to work with the Customer to qualify each User Story based on various factors such as criticality, deployment urgency, usage levels, complexity, size, etc.

The proposed Online Freelancing system may provide functionality to the Contract execution team to identify and qualify dependencies across the various defined User Stories, thus enabling lateral traceability across Epics within a job, as well as upstream or downstream traceability across User Stories within or across Epics in a given job.

The proposed Online Freelancing system may provide functionality to the Contract Project Manager to develop a Critical Path Diagram for a job, taking as inputs the dependencies documented across Epics and User Stories within the job, as well as User Story size and deployment urgency, etc.

The proposed Online Freelancing system may provide functionality to the Contract execution team to prioritize the various User Stories based on their dependencies as well as the various qualification criteria and define a prioritized list of User Stories broken up into delivery Sprints, thus enabling the creation and submission of a Contract Release Plan.

The proposed Online Freelancing system may provide functionality to the Customer to review the Contract Product Backlog and the Contract Release Plan, and to revert with review comments or to approve these artefacts.

The proposed Online Freelancing system may provide functionality to the Contract execution team led by the Project Manager to define Kanban Boards mapped to each Epic or logical group of User Stories, define Kanban Cards mapped to each Feature under each User Story, assign each User Story to a single Virtual Team member Freelancer, define the planned schedule for execution of each Kanban Card or Feature, and set the status of each Kanban card to “Yet to start”. Thus, enabling visual representation and oversight of work progress through the execution of each Sprint in a release, and across the entire release.

The proposed Online Freelancing system may provide functionality for Freelancers and Project Manager to identify, qualify, and document risks against the job, Epics, or User Stories on an ongoing basis.

The proposed Online Freelancing system may provide functionality for Freelancers and Project Manager to identify, qualify, and document issues against the job, Epics, or User Stories on an ongoing basis.

The proposed Online Freelancing system may provide functionality to the Contract execution team member Freelancer to update the appropriate Kanban Card as work is performed against the corresponding Feature.

The proposed Online Freelancing system may provide functionality to the Contract Project Manager to schedule daily (or other periodic frequency) virtual stand-up meetings to assess progress on job execution and take corrective actions as needed. The Contract Project Manager would have the ability to extract various Contract execution reports and perform appropriate analysis of the project execution status and outlook using these reports. The proposed system may also provide functionality to conduct virtual stand-up meetings along with other Contract execution team members, and document any action items in the Actions Register.

The proposed Online Freelancing system may provide functionality to the Contract Project Manager to schedule virtual stand-up meetings to report progress to the Customer on a periodic basis. The Contract Project Manager would have the ability to extract various Contract Governance reports and perform appropriate analysis of the Project Execution status and outlook using these reports. The proposed system may also provide functionality to conduct Virtual Stand-up meetings along with other Contract Governance Team members, and document any action items in the Actions Register.

The proposed Online Freelancing system may provide functionality to the Contract Project Manager to extract Contract Financial Reconciliation report on a periodic basis and use this artefact to ensure Contract Financial Health.

The proposed Online Freelancing system may provide functionality to the Contract execution team Freelancer to deliver completed User Story artefacts to the Contract Project Manager.

The proposed Online Freelancing system may provide functionality to the Contract Project Manager to review delivered User Story artefacts and return to the author Freelancer in case of any changes needed.

The proposed Online Freelancing system may provide functionality to the Contract Project Manager to integrate User Story artefacts as needed and deliver to the Customer when ready.

The proposed Online Freelancing system may provide functionality to the Customer to test or review or validate delivered User Story artefacts and raise delivered defects in case of any defects found.

The proposed Online Freelancing system may provide functionality to the Customer to raise change requests in case of any changes needed against earlier agreed job requirements. Such change requests may undergo further impact analysis, estimation, etc., by the Contract execution team, and the resulting impact analysis and cost estimate may be subject to review and approval by the Customer before the change request is processed into the Contract Product Backlog and Contract Release Plan.

The proposed Online Freelancing system may provide functionality to the Customer to formally accept delivered User Story artefacts.

The proposed Online Freelancing system may provide functionality to the Contract Project Manager to update the Contract Product Backlog on a periodic basis, including any delivered defects and change requests raised by the Customer.

The proposed Online Freelancing system may provide functionality to the Contract Project Manager to update the Contract Release Plan on a periodic basis and submit to the Customer for review and approval.

The proposed Online Freelancing system may provide functionality to Contract execution team member Freelancers to raise invoices to the Contract Project Manager, at the end of each Delivery Sprint.

The proposed Online Freelancing system may provide functionality to Contract Project Manager to raise invoices to the Customer, at the end of each Delivery Sprint.

The system may provide functionality to the Customer to make payments to the Contract Project Manager against the Delivery Sprint invoices raised.

The proposed Online Freelancing system may provide functionality to the Contract Project Manager to make payments to the Contract execution team member Freelancers against the Delivery Sprint invoices raised.

The proposed Online Freelancing system may provide functionality for financial reliability analysis to be performed against Customers for the timeliness and completeness of payments against Contract Project Manager invoices, at the end of each Delivery Sprint. This action shall be executed by the system without any manual intervention.

The proposed Online Freelancing system may provide functionality for financial reliability analysis to be performed against Contract Project Manager for the timeliness and completeness of payments against Contract Execution Team member Freelancer invoices, at the end of each Delivery Sprint. This action shall be executed by the system without any manual intervention.

The proposed Online Freelancing system may provide functionality to Customers to provide Contract leadership assessments to Contract Project Managers, at the end of each Delivery Sprint.

The proposed Online Freelancing system may provide functionality to Contract execution team member Freelancers to provide Contract leadership assessments to Contract Project Managers, at the end of each Delivery Sprint.

The proposed Online Freelancing system may provide functionality to Contract Project Managers to provide performance assessments to Contract execution team member Freelancers, at the end of each Delivery Sprint.

The proposed Online Freelancing system may provide functionality to Customers to define Project Portfolios and identify logical groups of jobs or projects that are part of Customer Project Portfolios, typically seeking to achieve the Customer's strategic objectives mapped to specific Customer Project Portfolios. The Customer may be provided the ability to assign Project Portfolio Managers to each Project Portfolio. The Customers may be provided the ability to identify and qualify dependencies on projects in Project Portfolios, so as to give the ability to plan for projects sequencing and thus achieve Portfolio objectives in a more efficient manner. The Customer single point of contacts (SPOCs) and Project Portfolio Managers may have the capability to provide Management oversight of the overall Customer Project Portfolios as well as the projects in the Customer Project Portfolios.

The proposed Online Freelancing system may provide functionality to Freelance Companies to define Freelance Company Project Portfolios, by identifying jobs or projects that are published by specific Customers, and thus form part of specific Freelance Project Portfolios. The Freelance Company SPOCs may be provided the ability to assign Project Portfolio Managers to each such Freelance Company Project Portfolios. The Freelance Company SPOCs and Project Portfolio Managers may be provided the ability to identify and qualify dependencies on projects in Project Portfolios. The Freelance Company SPOCs and Project Portfolio Managers may have the capability to provide Management oversight of the overall Freelance Company Project Portfolio as well as the projects in the Freelance Company Project Portfolio.

The proposed Online Freelancing system may provide functionality to Customers and Freelance Companies to extract the several Project Portfolio Management reports to aid in the Management of their Project Portfolios.

To further clarify advantages and features of the present invention, a more particular description of the invention will follow by reference to specific embodiments thereof, which are illustrated in the appended Figures. It is to be appreciated that these Figures depict only typical embodiments of the invention and are therefore not to be considered limiting in scope. The invention will be described and explained with additional specificity and detail with the appended Figures.

### BRIEF DESCRIPTION OF THE DRAWINGS

The invention will be described and explained with additional specificity and detail with the accompanying Figures

FIG. 1-1 depicts an embodiment of “Project Success” objectives for Customers.

FIG. 1-2 depicts an embodiment of “Project Success” objectives for Project Managers.

FIG. 1-3 depicts an embodiment of “Project Success” objectives for Freelancers.

FIG. 1-4 depicts an embodiment of “Project Success” objectives for Freelance Companies.

FIG. 1-5 depicts the different dimensions of “Project Success Potential”.

FIG. 1-5A depicts an embodiment of Customer-driven factors that impact Project Success potential.

All documented factors except purely Customer-internal aspects such as work items prioritization and sequencing, Organizational Resource Management, Supplier Management, etc., shall be supported by the inventive Online Freelancing system.

FIG. 1-5B depicts an embodiment of Project Manager-driven factors that impact Project Success potential. All documented factors shall be supported by the Inventive Online Freelancing system.

FIG. 1-5C depicts an embodiment of Freelancer-driven factors that impact Project Success potential. All documented factors shall be supported by the inventive Online Freelancing system.

FIG. 2 is a depiction of the inventive system and its components.

FIG. 3 depicts an embodiment of a system diagram for the proposed Online Freelancing system.

FIG. 4 depicts an exemplary embodiment of the jobs breakdown hierarchy on the proposed Online Freelancing system, breaking down jobs into job requirement groups, job requirements, and acceptance criteria.

FIG. 4-1 depicts an exemplary embodiment of the jobs breakdown map to job requirement groups and job requirements mapped to Epics, User Stories and acceptance criteria, along with the qualification of the various elements, as well as relationships identified between various elements, on the proposed Online Freelancing system.

FIG. 4-2 depicts an exemplary embodiment of a multi-level Contract as implemented on the proposed Online Freelancing system.

FIG. 4-3 depicts an exemplary embodiment of a simple Virtual Team as implemented on the proposed Online Freelancing system.

FIG. 4-4 depicts an exemplary embodiment of a more complex Virtual Team as implemented on the proposed Online Freelancing system.

FIG. 5 depicts an embodiment of the Contract breakdown hierarchy on the proposed Online Freelancing system.

FIG. 6 depicts an embodiment of the hierarchy of structures and data on the proposed Online Freelancing system.

FIG. 7 depicts an embodiment of a user category-wise view of the proposed Online Freelancing system.

FIG. 7-1 depicts an embodiment of the various membership-related, project-related, and Project Portfolio Management-related high-level functionalities supported on the Customers network on the proposed Online Freelancing system.

FIG. 7-2A and FIG. 7-2B together depict an embodiment of the various high-level functionalities supported on the Project Managers network on the proposed Online Freelancing system.

FIG. 7-3 depicts an embodiment of the various high-level functionalities supported on the Freelancers network on the proposed Online Freelancing system.

FIG. 7-4 depicts an embodiment of the various high-level functionalities supported on the Freelance Companies network on the proposed Online Freelancing system.

FIG. 7-5 depicts an embodiment of the various high-level enabling system functionalities supported on the proposed Online Freelancing system.

FIG. 8 depicts an embodiment of the high-level Freelance project process flow on the proposed Online Freelancing system.

FIG. 9 depicts an embodiment of the Freelance project pre-Contract award flow on the proposed Online Freelancing system.

FIG. 10 depicts an exemplary embodiment of a job requirements definition template in the proposed Online Freelancing system.

FIG. 10-1, FIG. 10-2, FIG. 10-3, and FIG. 10-4 jointly depict qualifying attributes for the job requirements definition template illustrated in FIG. 10.

FIG. 11-1 depicts an exemplary embodiment of the job proposal development and prioritization approach within the proposed Online Freelancing system.

FIG. 11-2 depicts an embodiment of the approach for performing job proposal prioritization using the “job proposal prioritization Slider” on the proposed Online Freelancing system.

FIG. 12 depicts an exemplary embodiment of a Contract risks log template.

FIG. 12-1 depicts an exemplary embodiment of a risks heat map.

FIG. 12-2 depicts an exemplary embodiment of risk heat map items positioning guide.

FIG. 12-3 depicts an exemplary embodiment of risk heat map bubble sizing guide.

FIG. 13 depicts an exemplary embodiment of the “Project Managers work Portfolio scores match to Customer job” function on the proposed Online Freelancing system. This function may be used to determine the order of extent of a match of a Customer job to a list of Project Managers, thus enabling the system to quantifiably ascertain which Project Manager is most suited to manage a given Customer job.

FIG. 13A depicts an embodiment of the approach implemented on the proposed Online Freelancing system to match the most suitable Project Managers to a given job.

FIG. 13-1A, FIG. 13-1B, and FIG. 13-1C jointly depict an exemplary embodiment of the “Project Manager's work Portfolio match to Customer job template”, wherein a given Project Manager's work Portfolio is matched against a Customer job on specific attributes, and a score is derived that indicates the extent of match of the given Project Manager's work Portfolio to the Customer's current job.

FIG. 13-2 contains an exemplary embodiment of the various settings used in the “Project Manager Portfolio match to Customer job template”.

FIG. 14 depicts an embodiment of the approach implemented on the proposed Online Freelancing system to match the most suitable Freelancers to a given job.

FIG. 14A, FIG. 14B, and FIG. 14C jointly depict an exemplary embodiment of the “Freelancers' Team's Portfolio match to Customer job template” function on the proposed Online Freelancing system. This function may be used to determine a given Freelancer team's suitability to a given Customer job.

FIG. 14-1 contains an exemplary embodiment of the various settings used in the “Freelancers' Team's Portfolio match to Customer job template”.

FIG. 15 depicts an embodiment of the Freelance Project Contract Execution planning flow on the proposed Online Freelancing system.

FIG. 16 depicts an embodiment of the Freelance Project Sprint execution flow on the proposed Online Freelancing system.

FIG. 17-1 depicts an embodiment of the Freelance Project Sprint invoicing and payments flow on the proposed Online Freelancing system.

FIG. 17-2 depicts an embodiment of the Freelance Project Sprint Freelancer performance assessment or Project Manager leadership assessment flow on the proposed Online Freelancing system.

FIG. 18 depicts an embodiment of the Freelance Project Contract closure flow on the proposed Online Freelancing system.

FIG. 19 depicts an exemplary embodiment of a Contract Epics list on the proposed Online Freelancing system.

FIG. 20 depicts an exemplary embodiment of a Contract User Stories list on the proposed Online Freelancing system.

FIG. 20-1 depicts an exemplary embodiment of a dependency log to capture internal and external dependencies for job proposals and Contracts.

FIG. 21 depicts an exemplary embodiment of a Contract Product Backlog on the proposed Online Freelancing system.

FIG. 22 depicts an exemplary embodiment of a Critical Path Diagram of job requirements groups and job requirements delivery sequencing within the overall job execution, on the proposed Online Freelancing system.

FIG. 23 depicts an exemplary embodiment of a Contract Release Plan on the proposed Online Freelancing system. The same template may also be adopted as an exemplary embodiment of a Contract Release Plan vs. status report.

FIG. 24 depicts an exemplary embodiment of a Contract acceptance criteria definition template on the proposed Online Freelancing system.

FIG. 25 depicts an exemplary embodiment of a Kanban Board layout on the proposed Online Freelancing system.

FIG. 26 depicts an exemplary embodiment of a Kanban Card layout on the proposed Online Freelancing system.

FIG. 27 depicts an exemplary embodiment of a Contract issues log template on the proposed Online Freelancing system.

FIG. 27-1 depicts an exemplary embodiment of an issues heat map.

FIG. 27-2 depicts an exemplary embodiment of an issue heat map items positioning guide.

FIG. 28 depicts an exemplary embodiment of a Contract delivered defects log template on the proposed Online Freelancing system.

FIG. 28-1 depicts an exemplary embodiment of a Freelancer-wise delivery quality summary report, used by the Project Manager to assess performance quality of each Freelancer within a Contract execution team.

FIG. 28-2 depicts an exemplary embodiment of a Sprint-wise delivery quality summary report, used by the Project Manager to assess performance quality for each Sprint within a Contract Release Plan.

FIG. 29 depicts an exemplary embodiment of a project dashboard, used by Project Managers and Customers on the proposed Online Freelancing system.

FIG. 29-1 depicts an exemplary embodiment of a Sprint Burn-up or Burn-down chart on the proposed Online Freelancing system, using Story points as the basis to calculate Burn-up or Burn-down.

FIG. 29-2 depicts an exemplary embodiment of a Sprint Burn-up or Burn-down chart on the proposed Online Freelancing system, using User Stories and Delivered Defects count as the basis to calculate Burn-up or Burn-down.

FIG. 29-3A, FIG. 29-3B, and FIG. 29-3C jointly depict an exemplary embodiment of the Sprint Burn-up or Burn-down data collection template on the proposed Online Freelancing system.

FIG. 30-1 depicts an exemplary embodiment of a Contract Financial Reconciliation transaction report on the proposed Online Freelancing system. This report captures a Contract Sprint-wise list of all invoices and their payment statuses.

FIG. 30-2A, FIG. 30-2B, and FIG. 30-2C jointly depict an exemplary embodiment of a Contract Financial Reconciliation report on the proposed Online Freelancing system. This report captures a Contract Sprint-wise reconciliation of incoming and outgoing payments between Customers, Project Managers, and Freelancers.

FIG. 31 depicts an exemplary embodiment of the Project Manager leadership assessment calculator on the proposed Online Freelancing system. It further makes references to the following Figures.

FIG. 31-1A, FIG. 31-1B, and FIG. 31-1C jointly depict an exemplary embodiment of Project Manager Contract leadership assessment score calculator.

FIG. 31-2 depicts an exemplary embodiment of Project Manager Project Management certifications score calculator.

FIG. 31-3 depicts an exemplary embodiment of Project Manager Project Management experience score calculator.

FIG. 31-4 depicts an exemplary embodiment of Project Manager Project Management skills score calculator.

FIG. 31-5 depicts an exemplary embodiment of the various settings used on the Project Management leadership score calculator.

FIG. 32 depicts an exemplary embodiment of the Freelancer profile score calculator on the proposed Online Freelancing system. It further makes references to the following.

FIG. 32-1A, FIG. 32-1B, and FIG. 32-1C taken jointly depict an exemplary embodiment of the Freelancer Performance assessment score calculator.

FIG. 32-2 depicts an exemplary embodiment of the Freelancer skills score calculator.

FIG. 32-3 depicts an exemplary embodiment of the Freelancer Portfolio score calculator.

FIG. 32-4 depicts an exemplary embodiment of the various settings used on the Freelancer profile score calculator.

FIG. 32-5 depicts an exemplary embodiment of the Freelancer job execution continuity score calculator.

FIG. 33 depicts an exemplary embodiment of the Project Manager financial reliability assessment calculator on the proposed Online Freelancing system. It further makes references to the following Figures.

FIG. 33-1 depicts an exemplary embodiment of the detailed Project Manager financial reliability assessment calculator.

FIG. 33-2 depicts an exemplary embodiment of the various settings used on the Project Manager financial reliability assessment calculator.

FIG. 34 depicts an exemplary embodiment of a Customer financial reliability calculator on the proposed Online Freelancing system.

FIG. 34-1 depicts an exemplary embodiment of a detailed Customer financial reliability calculator.

FIG. 34-2 depicts an exemplary embodiment of all settings on the Customer financial reliability calculator.

FIG. 34-3 depicts an embodiment of an approach to identify the most “likeable” Customers on the proposed Online Freelancing system.

FIG. 35 depicts an exemplary embodiment of Customer Project Portfolios within a Customer projects environment, on the proposed Online Freelancing system.

FIG. 36 depicts an embodiment of the Freelance Project Portfolio Management Process flow on the proposed Online Freelancing system.

FIG. 37 depicts an embodiment of the different elements in a Customer Project Portfolio on the proposed Online Freelancing system.

FIG. 38 depicts an exemplary embodiment of the GANTT view of a Customer Project Portfolio on the proposed Online Freelancing system.

FIG. 39 depicts an exemplary embodiment of a Project Portfolio Strategic Objectives achievement tracker on the proposed Online Freelancing system.

FIG. 40 depicts an exemplary embodiment of a Project Portfolio Management Dashboard on the proposed Online Freelancing system and includes various charts each of which depict key Project Portfolio Metrics.

FIG. 41 depicts an exemplary embodiment of a Customer Project Portfolio Financial Transactions report on the proposed Online Freelancing system.

FIG. 42 depicts an exemplary embodiment of a Project Portfolio Financial Summary on the proposed Online Freelancing system.

FIG. 43 depicts an exemplary embodiment of Freelance Company Project Portfolios mapped to different Customers' projects environments, on the proposed Online Freelancing system.

FIG. 44 depicts an embodiment of the different elements in a Freelance Company Project Portfolio on the proposed Online Freelancing system.

Further, those skilled in the art will appreciate that elements in the Figures are illustrated for simplicity and may not have necessarily been drawn to scale. Furthermore, in terms of the construction of the device, one or more components of the device may have been represented in the Figures by conventional symbols, and the Figures may show only those specific details that are pertinent to understanding the embodiments of the present invention so as not to obscure the Figures with details that will be readily apparent to those skilled in the art having the benefit of the description herein.

### DETAILED DESCRIPTION OF PREFERRED EMBODIMENTS

For the purpose of promoting an understanding of the principles of the invention, reference will now be made to the embodiment illustrated in the Figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present invention will be described below in detail with reference to the accompanying Figures.

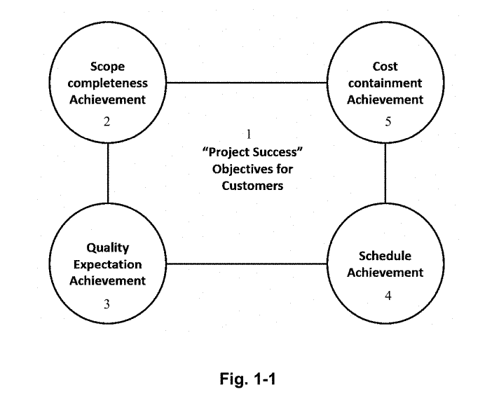

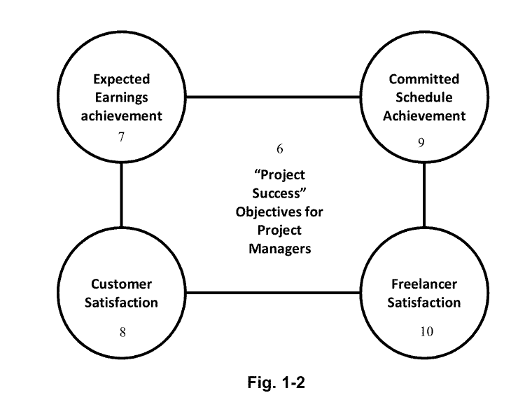

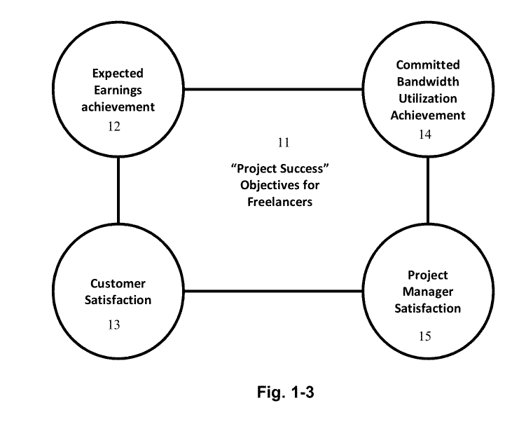

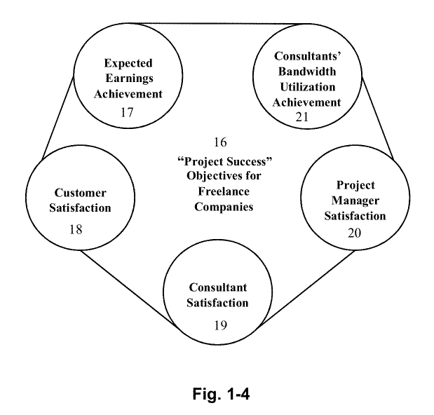

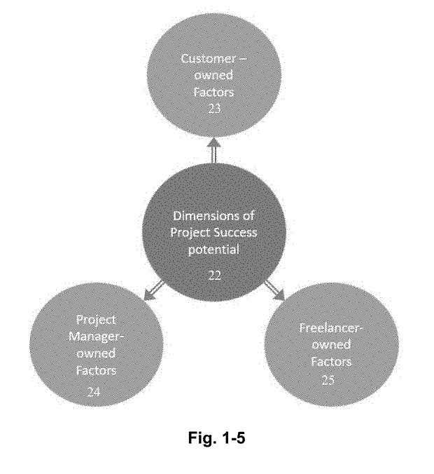

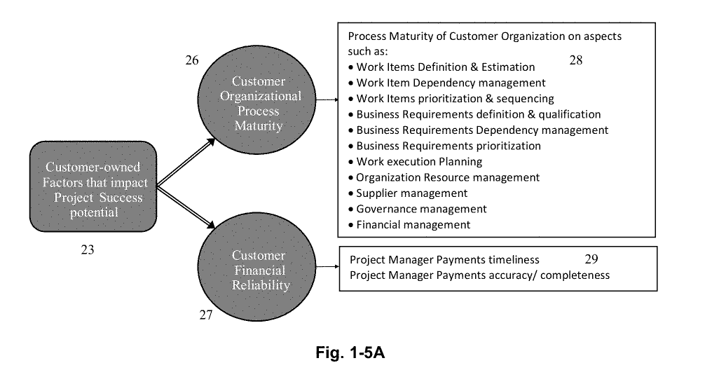

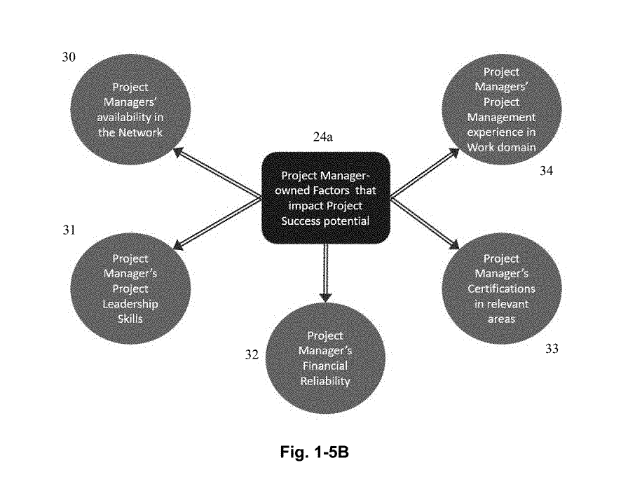

FIG. 1-1 depicts the key “project success objectives” for Customers 1 which includes scope completeness achievement 2, quality expectation achievement 3, schedule achievement 4, and cost containment achievement 5, in the proposed Online Freelancing system. The scope completeness achievement 2 is such that a job or project may be considered successful from a Customer's perspective only if the entire scope, as identified by the Customer in the job requirements, has been delivered to the Customer as part of the job or project deliverables. The quality expectation achievement 3 is such that a job or project may be considered successful from a Customer's perspective only if the job or project deliverables have been created with appropriate quality as set down by the Customer as part of the job requirements. The schedule achievement 4 is such that a job or project may be considered successful from a Customer's perspective only if the job or project deliverables have been delivered to the Customer by or ahead of the stated schedule as agreed in the Customer Contract. The cost containment achievement 5 is such that a job or project may be considered successful from a Customer's perspective only if the job or project deliverables have been delivered to the Customer within the budget as agreed with the Customer in the Customer Contract.

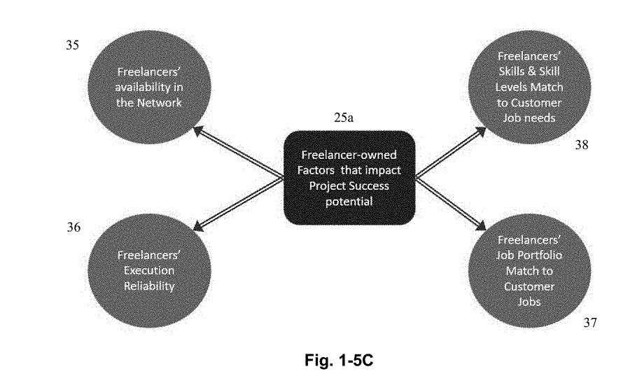

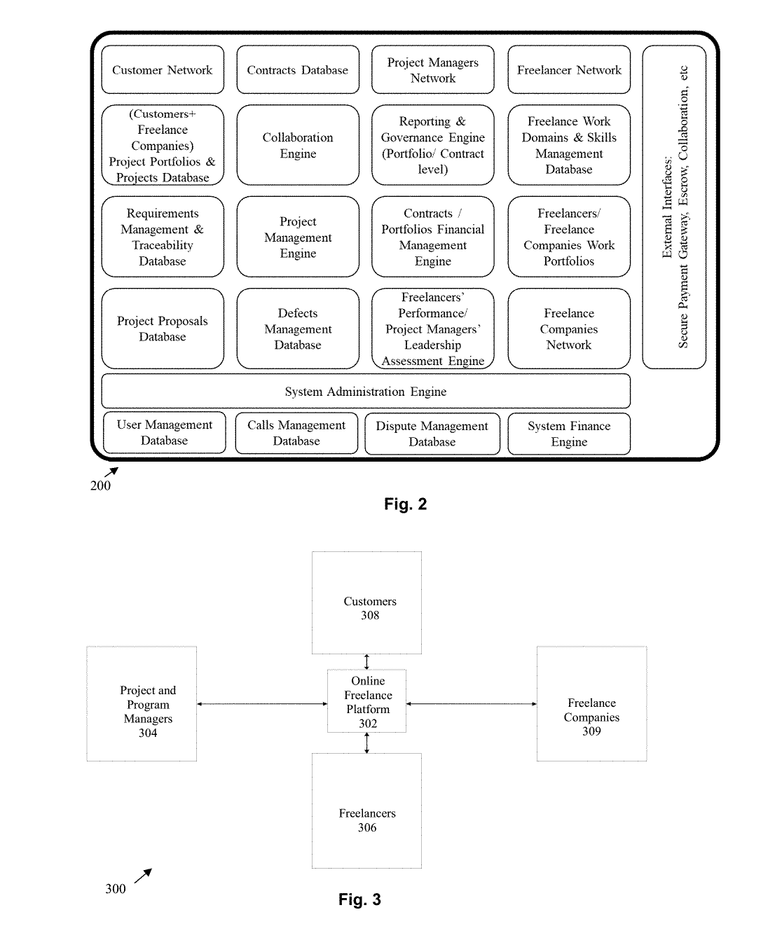

FIG. 1-2 depicts the key “project success objectives” for Project Managers 6 in the proposed Online Freelancing system, which are expected earnings achievement 7, Customer satisfaction 8, committed schedule achievement 9, and Freelancer satisfaction 10. A job or project may be considered successful from a Project Manager's perspective only if it yields the expected earnings for the Project Manager which is the expected earnings achievement 7. The committed schedule achievement 9 is when a job or project is successful from a Project Manager's perspective only if it is completed by or ahead of the Contractually agreed job schedule, so as to free up the Project Manager's bandwidth after the job is completed. The Customer satisfaction 8 is such that a job or project may be considered successful from a Project Manager's perspective only if it yields appropriately positive Customer satisfaction, leading to good Project Management feedback from the Customer to the Project Manager, and thus further leading to an improved new business potential for the Project Manager. The Freelancer Satisfaction 10 from a Project Manager's perspective is when a job or project considered successful only if it yields appropriately positive Freelancer satisfaction from all the engaged Freelancer Virtual Team members, thus leading to good Project Management feedback from the Freelancer to the Project Manager, and thus further leading to an improved new business potential for the Project Manager.

FIG. 1-3 depicts the key “project success objectives” for Freelancers 11 in the proposed Online Freelancing system that comprises expected earnings achievement 12, Customer satisfaction 13, committed bandwidth utilization achievement 14, and Project Manager satisfaction 15. The expected earnings achievement 12 is when a job or project considered successful from a Freelancer's perspective only if it yields revenue or earnings as planned at the time of initial engagement on the job. The committed bandwidth utilization achievement 14 is such that a job or project may be considered successful from a Freelancer's perspective only it utilizes an appropriate portion of the Freelancer's bandwidth on the given job, leaving his or her remaining bandwidth free to be allocated to other jobs or any other activities as appropriate. The Customer satisfaction 13 is such that a job or project may be considered successful from a Freelancer's perspective only if it yields appropriately positive Customer satisfaction, leading to improved new business potential for the Freelancer. The Project Manager satisfaction 15 is such that a job or project may be considered successful from a Freelancer's perspective only if it yields appropriately positive Project Manager satisfaction, leading to good performance assessment feedback from the Project Manager to the Freelancer, and thus further leading to an improved new business potential for the Freelancer.

FIG. 1-4 depicts the key “project success objectives” for Freelance Companies 16 which includes expected earnings achievement 17, Customer satisfaction 18, consultant satisfaction 19, Project Manager satisfaction 20 and consultants' bandwidth utilization achievement 21 in the proposed Online Freelancing system. The expected earnings achievement 17 is such that a job or project may be considered successful from a Freelance Companies' perspective only it yields revenue or earnings as planned at the time of initial engagement on the job.

The consultants' bandwidth utilization achievement 21 is such that a job or project may be considered successful from a Freelance Companies' perspective only it utilizes an appropriate portion of the group of Freelance Consultants' bandwidths on the given job, leaving their remaining bandwidth free to be allocated to other jobs or any other activities as appropriate.

The Customer satisfaction 18 in a job or project may be considered successful from a Freelance Companies' perspective only if it yields appropriately positive Customer satisfaction, leading to an improved new business potential for the Freelance Company.

The Project Manager satisfaction 20 in a job or project may be considered successful from a Freelance Companies' perspective only if it yields appropriately positive Project Manager satisfaction, leading to good performance assessment feedback from the Project Manager to the Freelance Company, and thus further leading to an improved new business potential for the Freelance Company.

The consultant satisfaction 19 is such that a job or project may be considered successful from a Freelance Companies' perspective only if it yields positive consultants' satisfaction, thus leading to improved productivity on the part of the consultants, as well as leading to potential for improved retention of the consultants on the Freelance Company.

FIG. 1-5 depicts the key “Dimensions of Project success potential” 22 which includes Customer-owned factors 23, Project Manager-owned factors 24, and Freelancer-owned factors 25 in the proposed Online Freelancing system, and the following dimensions are further illustrated. The Customer-owned factors 23 are owned by and may be controlled or influenced only by Customers, as illustrated in FIG. 1-5A. The two categories of Customer-owned factors 23a are Customer Organizational Process maturity 26 and Customer's financial reliability 27. The Customer Organizational Process maturity 26 may be measured by the process maturity of the Customer's Organization on aspects 28 such as organizational work stream work items definition and estimation, Organizational work stream work items Dependency Management, Organizational work stream work items prioritization and sequencing, Organizational work stream work items business requirements definition and qualification, Organizational work stream work items business requirements Dependency Management, Organizational work stream work items business requirements prioritization, Organizational work stream work items execution planning, Supplier Management, Organizational work stream work items Governance Management, Organizational work stream work items, Financial Management, etc.

The Customer's financial reliability 27 indicates the propensity and capability of the Customer Organization to settle submitted invoices (from Freelancers and/or Project Managers) in a timely and accurate manner 29, as indicated by historical data demonstrating timeliness of payment of Project Manager or Freelancer invoices, historical data demonstrating accuracy or completeness of payment of Project Manager or Freelancer invoices, etc. The Project Manager-owned factors 24 are owned by and may be controlled or influenced only by Project Managers, as illustrated in FIG. 1-5B. The key Project Manager-owned factors may be availability of Project Managers in the Project Managers' network 30 in the Online Freelancing system, with appropriate exposure, experience and skills in the relevant Freelance work domain, Project Managers' Project Management experience in the relevant Freelance work domain 34, Project Managers' Project leadership skills 31 in areas such as Project Planning, Project Scope Management, Project risk Management, Project Monitoring and Control, Project Team building, Project Communications, Project Stakeholder Management, Project Financial Management, Contract Management, etc., Project Managers' certifications in relevant skill or experience areas 33 such as Project Management, risk Management, Financial Management, etc., Project Managers' financial reliability 34 referred as historical propensity and capability of a Project Manager to settle submitted invoices (from Freelancers and or Project Managers) in a timely and accurate manner, as indicated by historical data demonstrating timeliness of payment of Project Manager or Freelancer invoices, historical data demonstrating accuracy or completeness of payment of Project Manager or Freelancer invoices, etc. The Freelancer-owned factors 25 are those owned by and may be controlled or influenced only by Freelancers or Freelance Companies, as illustrated in FIG. 1-5C.

The key Freelancer-owned factors may be availability of Freelancers or Freelance Companies in the Freelancers' network 35 in the Online Freelancing system, with appropriate exposure, experience and skills in the relevant Freelance work domain, Freelancers' skills and skill levels match to Customer job needs 38, Freelancers' work Portfolio match to Customer jobs 37, Freelancers' work portfolio match to Customer jobs such that historical data which indicates the level of comparability of prior work experience of Freelancers in the Freelance work domains and skill areas where a Customer job is impacting, Freelancers' Execution Reliability 36 which is a historical data that indicates the level of reliability and performance of a Freelancer on prior jobs, etc.

FIG. 2 illustrates an Online Freelancing system 200, which may include a variety of system components such as Freelancers network, Freelance Companies network, Customers network, Project Managers network, projects and Project Portfolios database, requirements database, job proposals database, Contracts database, Freelance work domains and skills database, collaboration engine, external interfaces such as Secure Payment Gateway, etc.

FIG. 3 is a system diagram of the proposed Online Freelancing system 300, which includes an Online Freelance platform 302, Project and Program Managers 304 (henceforth termed as Project Managers), Freelancers 306, Customers 308, and Freelance Companies 309. The Online Freelance Platform 302 forms the hub of the proposed Online Freelancing system and connects the other major elements. The Customers 308 may publish a job on the proposed Online Freelancing system 300. The Project Managers 304 may review, analyse, and estimate the job, and determine the tentative number of Freelancers 306 who may be required to perform the work within the specified job timeline. He or she may then search for, invite and engage the required number of Freelancers with the appropriate skills and skill levels in the appropriate Freelance work domain, and once the job is awarded, execute the work as planned. The Project Managers 304 may also search for, invite and engage the Freelance Companies 309, which may have on its rolls an appropriate number of Freelancers that are required for the job. The Project Manager 304 may also engage a combination of Freelance Companies 309 and Freelancers 306 as required by the published job.

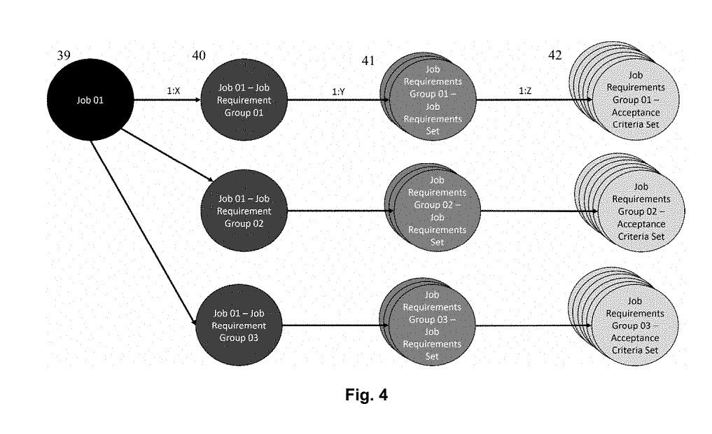

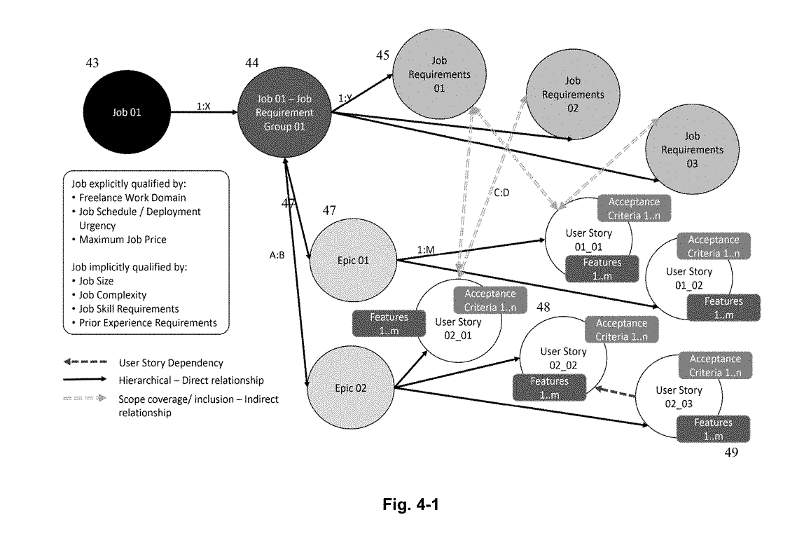

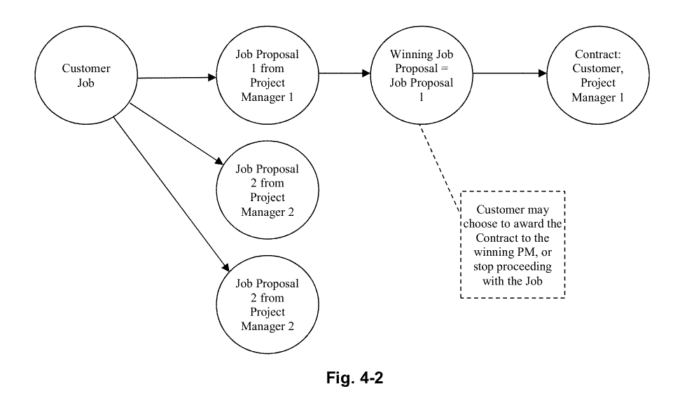

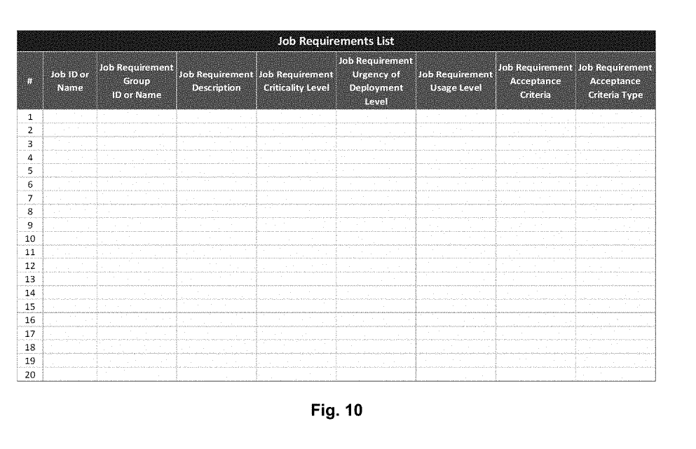

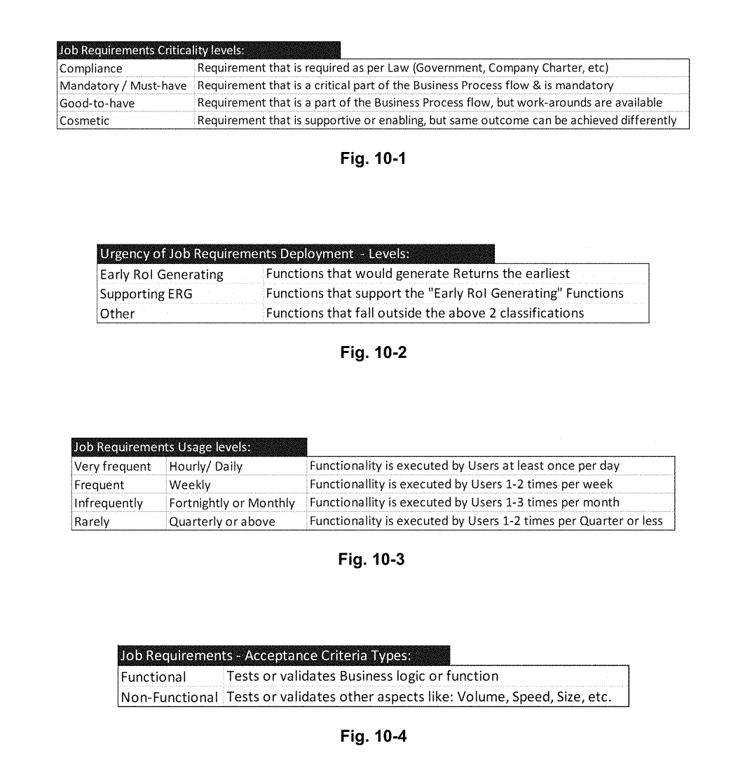

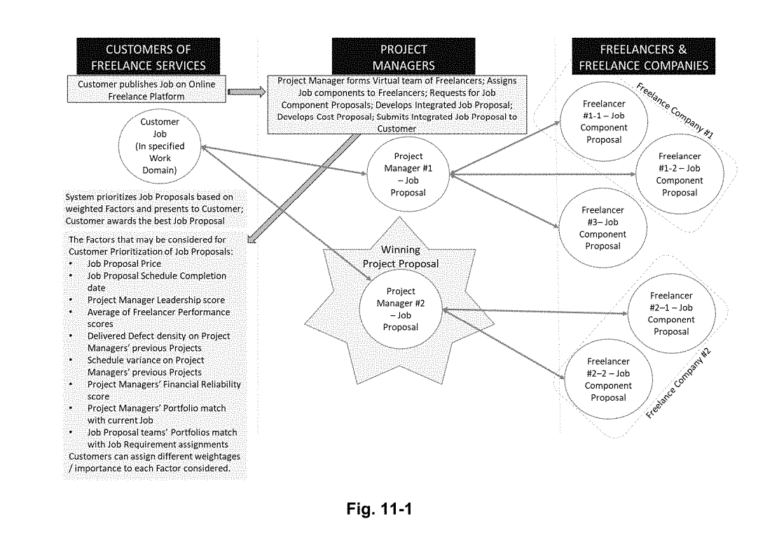

When Customers publish jobs, the proposed Online Freelancing system 300 may enforce a structure-driven decomposition of the job into job requirements groups, job requirements, and job requirements acceptance criteria, as documented in the exemplary diagrams in FIG. 4 and FIG. 4-1. The structure imposed for job definition may use exemplary embodiments as depicted in FIG. 10, supported by qualifying attributes as depicted in FIG. 10-1, FIG. 10-2, FIG. 10-3, and FIG. 10-4.

FIG. 10 is an exemplary embodiment of a job requirements definition template, wherein a job requirement group is a logical set of job requirements that forms a logical set of functions within the scope of the Customer job. Here, the logical grouping is focused on the business functionality aspect. For example, “Corporate Accounts” may be identified as a job requirement group when developing a Bank Accounting system. Job requirement groups are defined by the Customer as part of job publishing. A job requirement is a specific function or objective in the scope of the Customer job. For example, “Add a new Account” may be a valid job requirement within a job requirement group called “Corporate Accounts”. Job requirements are defined by the Customer as part of job publishing. A job requirement acceptance criterion is the set of steps that may be used to test or validate the successful achievement of results or outcome of a job requirement. Job acceptance criteria are defined by the Customer as part of job publishing. For example, “New Corporate account added” may be a valid acceptance criterion in the earlier scenario. Job requirements may be qualified using the following attributes, as illustrated in the job requirements definition template in FIG. 10.

Job requirement criticality level indicates the level of criticality of each job requirement to the job or the Customer. Some possible values may include, compliance that refers to a job requirement or function required to be implemented by the law of the land, mandatory or must-have like a job requirement or function required as must-have component of the business process being implemented, Good-to-have as a job requirement or function may be part of the business process flow being implemented, but a workaround exists that may be used to replace the specific job requirement or function, cosmetic that refers to a job requirement or function may be of a supportive or enabling nature, and the net outcomes may be achieved using other means. The urgency of job deployment indicates the expectation on a timeline for deployment of each specified job requirement. Some possible values may include, early Returns on Investment (RoI) generating in which the specific job requirement or function may be required in order for the deployed business Process to work, or, the specific job requirement or function may start generating RoI in a very short order of time. Supporting Early RoI Generating (ERG) which is the specific job requirement or function may be required as a support or enabler to an “Early RoI Generating” function. Other is a job requirement or function that belongs to neither categories as described above.

Job requirement usage level indicates how frequently a function as specified in each job requirement is used by the Customer. Some possible values may include Very Frequent, Frequent, Infrequently, and Rarely. Very Frequent is the functionality used by end users on an hourly or daily basis. Frequent is the functionality used by end users on a weekly basis. Infrequently is the functionality used by end users on a fortnightly or monthly basis. Rarely is the functionality is used by end users on a quarterly or less frequent basis. Job requirement acceptance criteria types indicate the type of testing or validation or review performed against the job requirement to ensure its successful achievement by the job execution team. Some possible values are functional that implies to tests or validates a business logic or functionality, non-functional are tests or validates other aspects of a job requirement or function like volume or capacity, speed of operation, throughput, duration of operation without breaks, etc.

FIG. 4 is an exemplary embodiment of the decomposition of a job 39 into job requirements groups 40, job requirement groups 40 into job requirements 41, and job requirements 41 are validated or tested using defined job requirement acceptance criteria 42. There may be a one-to-many (1:X) relationship between a job 39 and corresponding job requirement groups 40. There may be a one-to-many (1:Y) relationship between a job requirement group 40 and corresponding job requirements 41. There may be a one-to-many (1:Z) relationship between a job requirement 41 and corresponding job requirement acceptance criteria 42.

FIG. 4-1 is an exemplary embodiment of a decomposed job with the various definition elements as well as implementation elements, relationships and qualifications identified. A job 43 is decomposed to define its definition elements as follows, job 43 is progressively elaborated to define job requirement groups 44. The job requirement groups 44 are progressively elaborated to define job requirements 45. The job requirements 45 are validated or qualified using acceptance criteria 46. After a Contract is signed against a given job, the job is decomposed to define its implementation elements as follows, the job is progressively elaborated to define Epics 47, said Epics 47 are progressively elaborated to define User Stories 48 and said User Stories 48 are progressively elaborated to define Features 49. Finally, the User Stories 48 are validated and/or qualified using User Story acceptance criteria 46. An Epic form 47 is a logical building block of the Customer job's planned outcomes or results and is comprised of a logical group of User Stories. An Epic is defined by the Contract Execution Team that works with the Customer.

FIG. 4-2 depicts an exemplary embodiment of a multi-level Contract in which the top-level executed between the Customer and the awarded Project Manager, and the subsequent level between the awarded Project Manager and the Freelancers or members of the Virtual Project Team engaged by the Project Manager.

FIG. 4-3 depicts an exemplary embodiment of a simple Virtual Team that includes the Customer publishing the job, the awarded Project Manager, and the Freelancer members of the Project Team.

FIG. 4-4 depicts an exemplary embodiment of a more complex Virtual Team that includes the Customer publishing the job, the awarded Program Manager, next level Project Managers engaged by the awarded Program Manager, and the Freelancer members of the Project Teams under each engaged Project Manager.

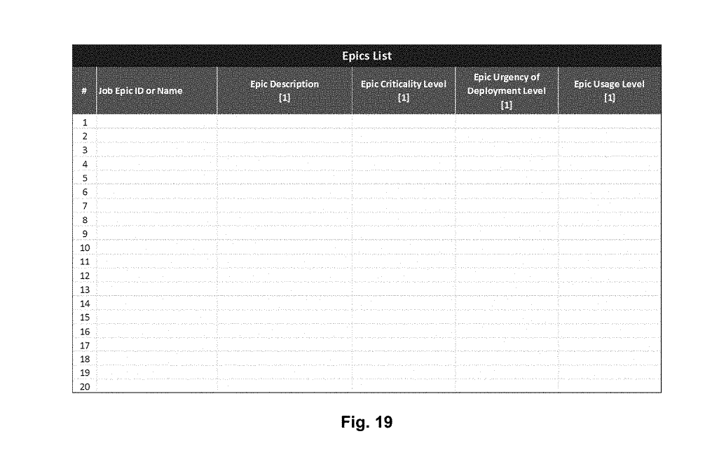

FIG. 19 depicts an exemplary embodiment of a Contract Epics list. The key information documented here is, Epic name, Epic description. The Epic is also qualified at this time, on the following aspects, Epic criticality level that refers to compliance, mandatory or must-have, Good-to-have, and cosmetic, Epic urgency of deployment level which is early RoI generating, Supporting early RoI generation, other, etc. (where RoI=Return on Investment), and Epic usage level like Very Frequent (For example, hourly or daily), Frequent (For example, weekly), Infrequently (For example, fortnightly or monthly), Rarely (For example, quarterly or greater), etc. A User Story is a set of steps intended to achieve a specific function which is a component or element of a Customer job. User Stories are developed by the Project Manager and Freelancers working with the Customer to validate the User Stories. A User Story is typically assigned to a specific Freelancer within a Contract Execution Team and may be executed within the allocated schedule as documented in the Contract Release Plan.

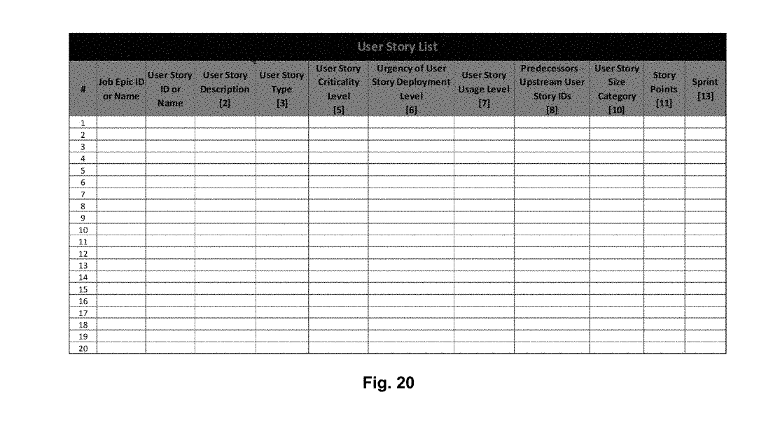

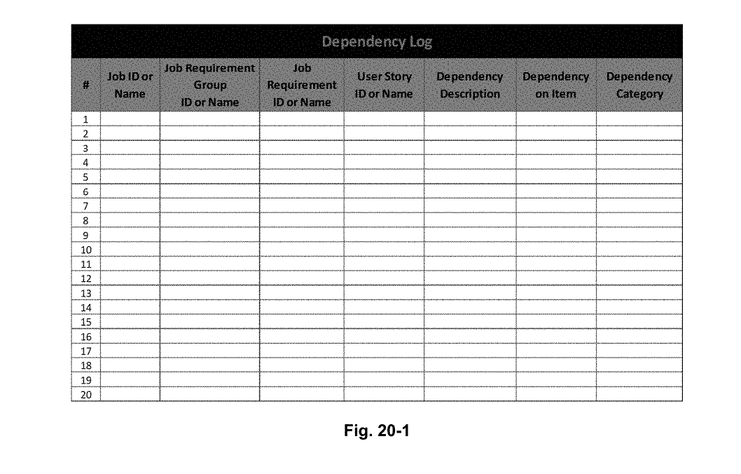

FIG. 20 depicts an exemplary embodiment of a Contract User Stories list. The key information documented here may include Epic ID or name, User Story ID or name, User Story description. The User Stories defined may be qualified on the basis of the following attributes, User Story type (functional, Non-functional, etc.), User Story criticality level that indicates the level of criticality of each User Story to the job or the Customer. Some possible values may include compliance, mandatory or must-have, good-to-have and cosmetic. Compliance is a User Story or function required to be implemented by the law of the land. A User Story or function may be required as a must-have component of the business process being implemented. Good-to-have is a User Story or function may be part of the business process flow being implemented, but a workaround exists that may be used to replace the specific User Story or function. Cosmetic is a User Story or function may be of a supportive or enabling nature, and the net outcomes may be achieved using other means. The urgency of User Story deployment indicates the expectation on a timeline for deployment of each User Story. Some possible values may include Early RoI Generating, supporting ERG and other. Early RoI Generating is the specific User Story or function may be required in order for the deployed business process to work, or, the specific User Story or function may start generating Returns on Investment in a very short order of time. Supporting ERG is the specific User Story or function may be required as a support or enabler to an “Early RoI Generating” function. Other refers to a User Story or function that belongs to neither categories as described above.

User Story usage level indicates how frequently a function as specified in each User Story is used by the Customer. Some possible values may include very frequent which is the functionality is used by end users on an hourly or daily basis, Frequent referring to the functionality is used by end users on a weekly basis, infrequently is the functionality is used by end users on a Fortnightly or monthly basis, rarely is the functionality is used by end users on a quarterly or less frequent basis.

User Story size category and Story points for which the T-Shirt sizing model may be used to define standard sizes to be used for sizing of User Stories in a relative manner. It is to be noted that T-Shirt sizing is only a guideline and may need to be adjusted for different Freelance work domains and skillsets. T-Shirt sizing standard may be defined on the basis of Story points, efforts in hours, etc., For T-Shirt sizes based on Story Points is such that 100 Story points imply very large, large is 75 Story points, medium is 50 Story points, small is 25 Story points, and very small is 10 Story points. The T-Shirt sizes based on person-hours efforts is such that very large is 40-person-hours, large is 30-person-hours, medium is 20-person-hours, small is 10-person-hours, very small is 4-person-hours.

A Feature is the smallest atomic-level component under a User Story, and a User Story may consist of one or more Features. A Feature typically is the smallest component that can be built independently by a Freelancer. Further, a Feature may consume less than a Sprint duration (typically one or two weeks' duration, as defined in the Contract Release Plan). Thus, Epics, User Stories, and Features are defined to quantitatively achieve transparency of job execution progress in a Contract. Job definition elements and job implementation elements may have defined relationships as illustrated. It may be possible that an Epic map directly to or equates with a job requirement group, or not. The difference may lie in the implementation aspects in which a job requirement group is focused more on business function, irrespective of any technological considerations or system considerations. For example, “Corporate Accounts” may be a valid job requirement group, although corresponding Epics may choose to be defined keeping the business function and system interface aspects in mind, such that “Large Corporates” may have their own individual interfaces developed by the Corporate and adopted by the Customer, and “Small Companies” may leverage a common interfacing as developed by the Customer and adopted for use by the Company.

Similarly, it may be possible that a User Story maps directly to or equates with a job requirement, or not. There may be a 1:X (one-to-many) relationship between a job and corresponding job requirement groups. There may be a 1:Y (one-to-many) relationship between a job requirement group and corresponding job requirements. There may be an A:B (many-to-many) relationship between job requirement groups and corresponding Epics. There may be a 1:M (one-to-many) relationship between an Epic and corresponding User Stories. There may be a 1:N (one-to-many) relationship between a User Story and corresponding acceptance criteria. There may further be a C:D (many-to-many) relationship between job requirements and corresponding User Stories.

A job may be explicitly qualified (visible to Customers while publishing the job) using the attributes such as Freelance work domain, job schedule, and deployment urgency, maximum job price, etc. The Freelance work domain is the categorization of Freelance work, such as IT application development, translation services, creative writing, etc. Job schedule and deployment urgency refers to the timeframe in which the Customer needs the job outputs. The maximum job price is the Customer's affordability for executing the job.

A job may further be implicitly (inside the proposed Online Freelancing system, and not input by the Customer while publishing the job) qualified using the attributes that includes job size, complexity, and risks anticipated while executing the job, skill requirements to execute the job, and prior experience needed. Job size indicates the size of the job, typically in terms of a number of job requirements, User Stories, Story points, etc. The complexity and risks anticipated while executing the job refers to what complexities are anticipated during job execution (For example, technology complexity, first-of-a-kind Feature implementation, external interfaces complexity, system integration complexity, security requirements, etc.), and what other risks are foreseen during job execution (For example, schedule adequacy to execute the job without inordinate extent of work compression, business process implementation challenges, funding availability, business user bandwidth availability, etc.). The skill requirements to execute the job are the skills and skill levels needed for the Project Manager and Freelancers to execute the job efficiently in a predictable manner. The prior experience needed refers to previous job execution experiences which the Contract Execution Team (Project Manager and Freelancers) need to have, in order to anticipate issues and risks effectively, and complete the job in an efficient manner, etc.

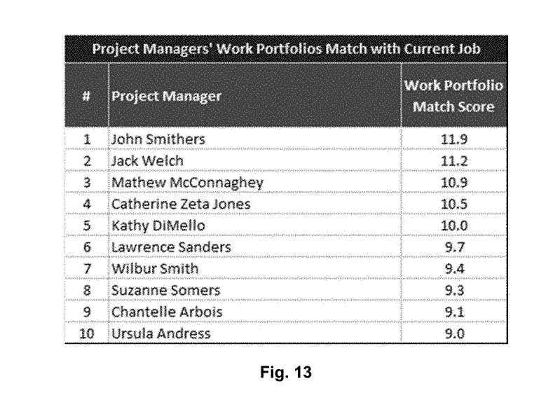

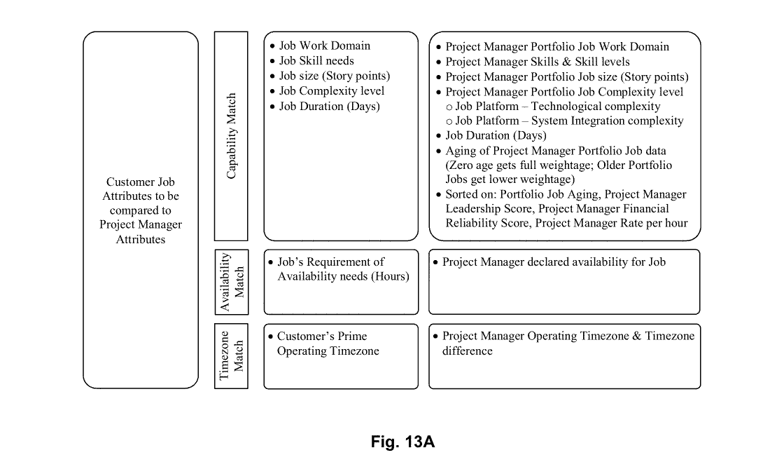

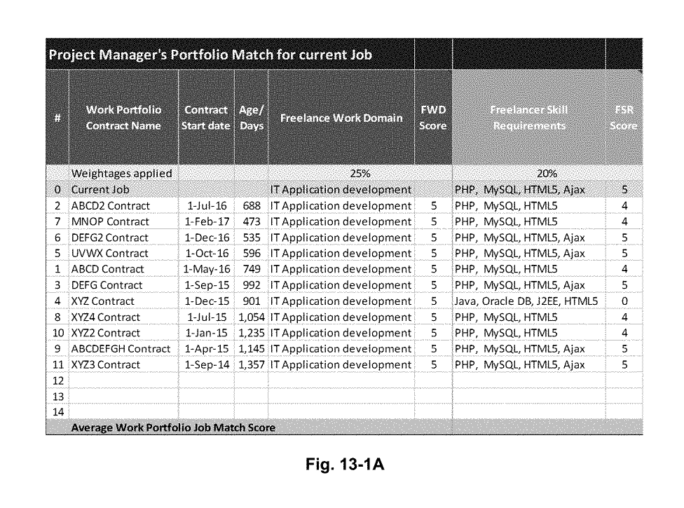

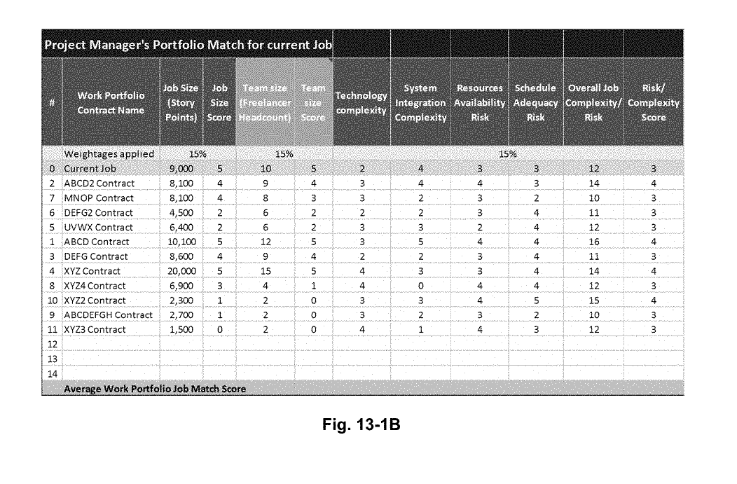

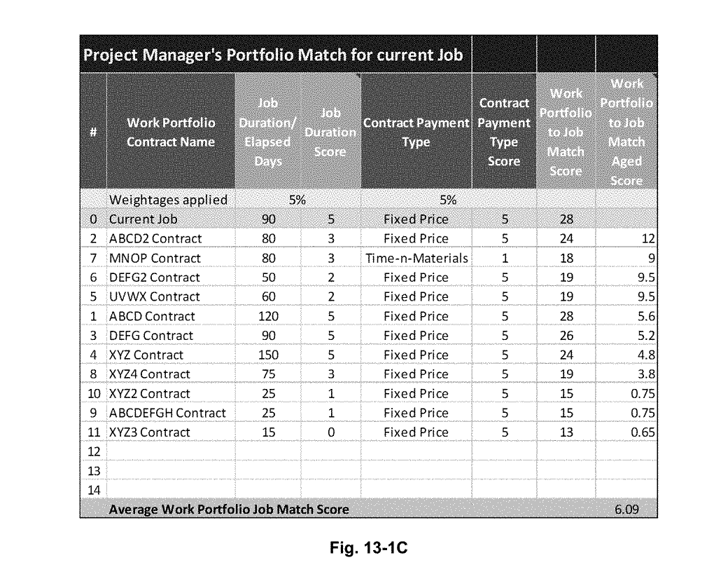

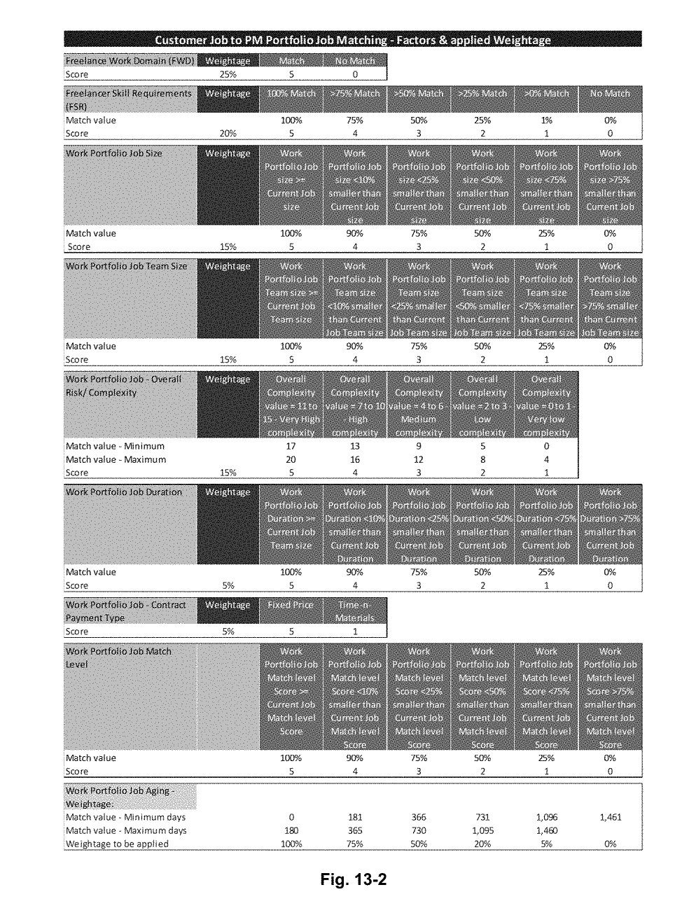

FIG. 13A depicts an embodiment of the approach used to identify Project Managers who may be most suited to execute a given Customer job and is driven primarily by three aspects of matching Project Managers to a job such as capability, bandwidth availability, and time zone match. The capability match may be further decomposed into attributes like Freelance Work domain, skills and skill levels, job size, job complexity, job duration, and the like.

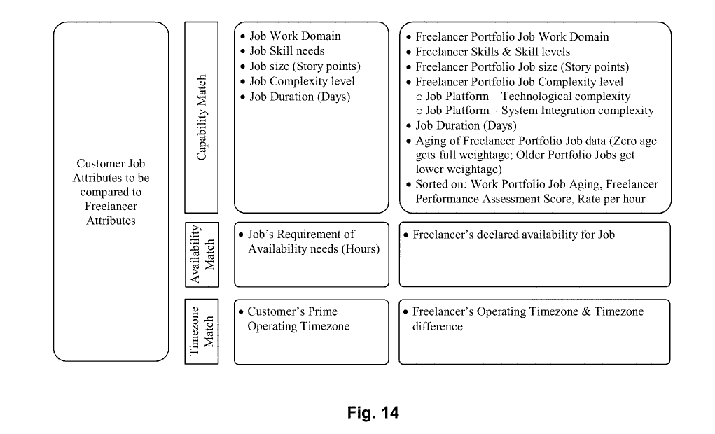

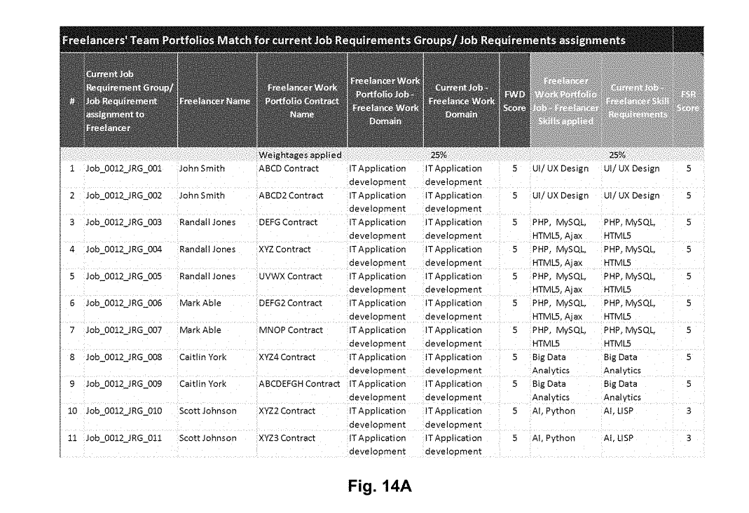

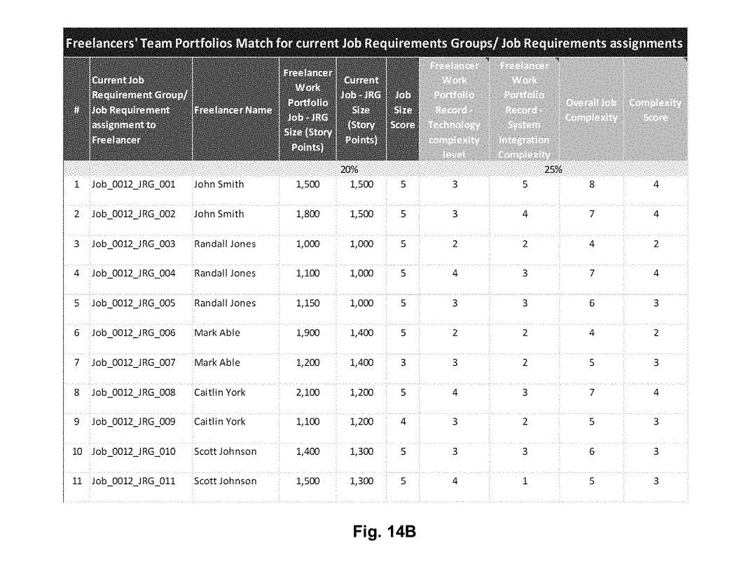

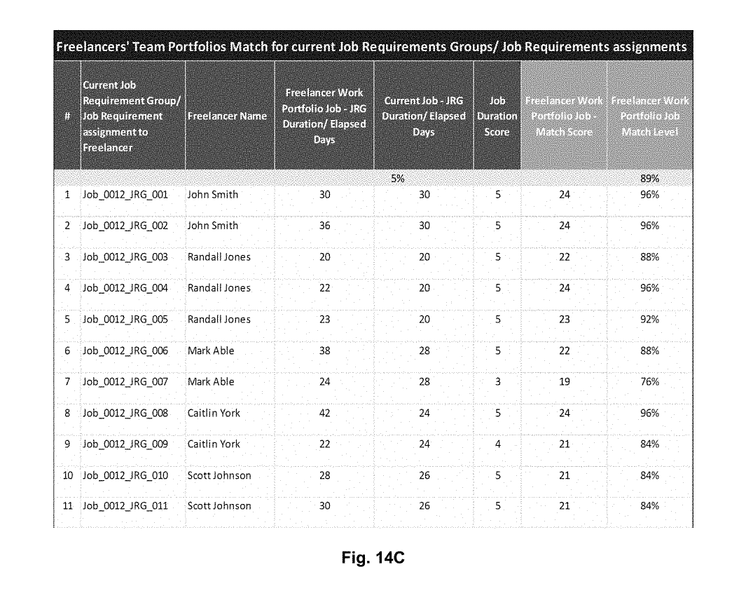

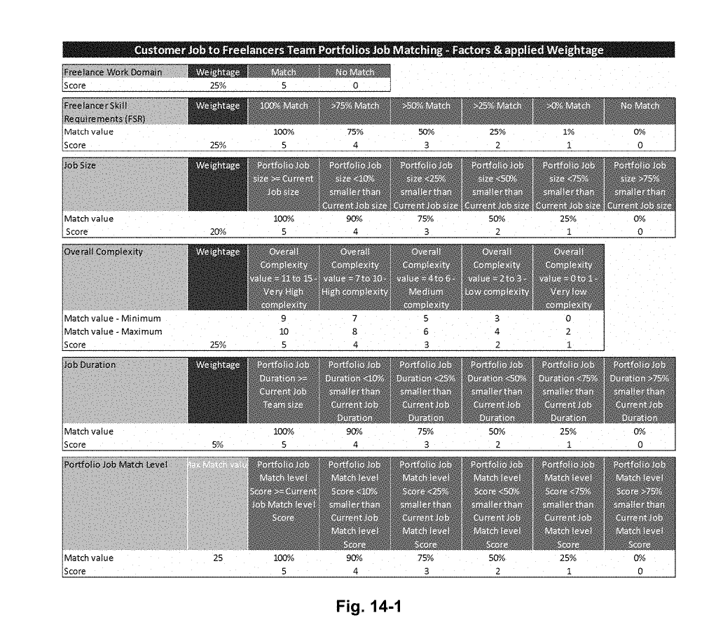

FIG. 14 depicts an embodiment of the approach used to identify Freelancers who may be most suited to execute a given Customer job and is driven by three aspects of matching Project Managers to a job such as capability, bandwidth availability, and time zone match. The capability match may be further decomposed into attributes like Freelance Work domain, Skills and Skill levels, job size, job complexity, job duration, and the like.

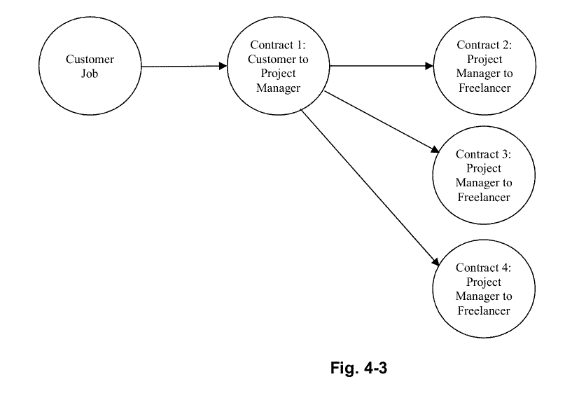

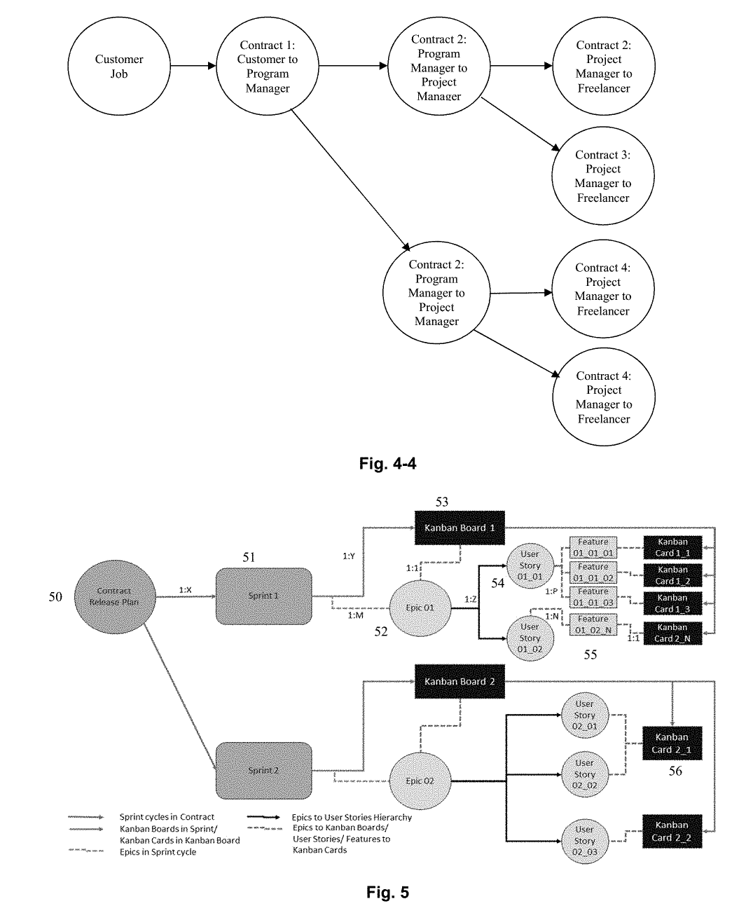

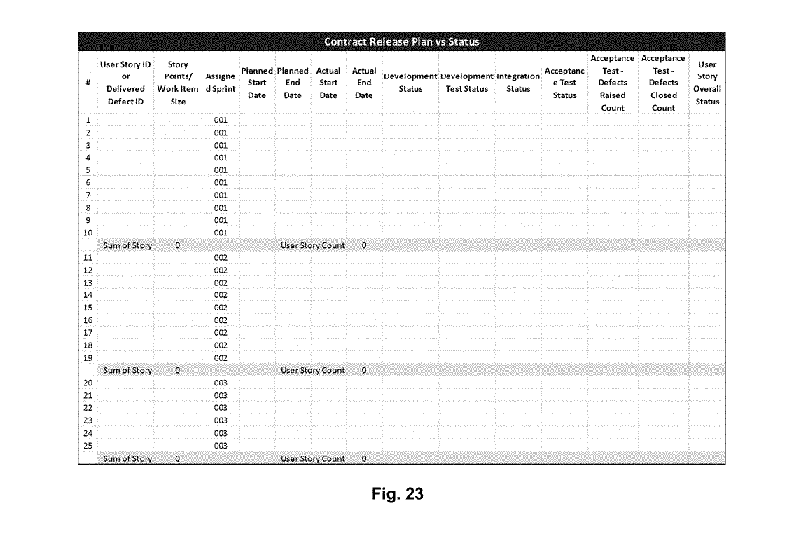

FIG. 5 illustrates an exemplary embodiment of a Contract breakdown hierarchy within the proposed Online Freelancing system. The execution of a Contract will be defined or planned using a Contract Release Plan 50. FIG. 23 depicts an exemplary embodiment of a Contract Release Plan, and may have multiple Sprints defined, each with its own components such as Sprint schedule, with the published timeline for that Sprint 51 typically running one to two weeks in duration, sizing of each Sprint 51 as calculated from the summing up of individual User Stories 54 within the Sprint 51, list of User Stories or delivered defect IDs assigned to each Sprint. Status of development of the User Story 54, state of development testing of the User Story, status of integration of the User Story with other appropriate components that have been developed as part of the same Sprint, to build Customer Sprint Deliverables, status of acceptance testing or validation of the User Story, number of delivered defects pertaining to the particular User Story, which have been raised as part of acceptance testing or validation, number of delivered defects pertaining to the specific User Story, which have been successfully closed, overall status of completion of the User Story, etc.

A Contract Release Plan 50 may have a 1:X (one-to-many) relationship with Sprints in the Contract Release Plan. A Sprint 51 may have a 1:Y (one-to-many) relationship with Epics in the Sprint. An Epic 52 may have a 1:Z (one-to-many) relationship with User Stories in the Epic. A Sprint 51 may have a 1:M (one-to-many) relationship with Kanban Boards in the Sprint. An Epic 52 may have a 1:1 (one-to-one) relationship with a specific Kanban Board 53 in the Sprint. A Kanban Board 53 may have a 1:N (one-to-many) relationship with corresponding Kanban Cards 56 in that Sprint. A Kanban Card 56 may have a 1:P (one-to-many) relationship with corresponding User Stories.

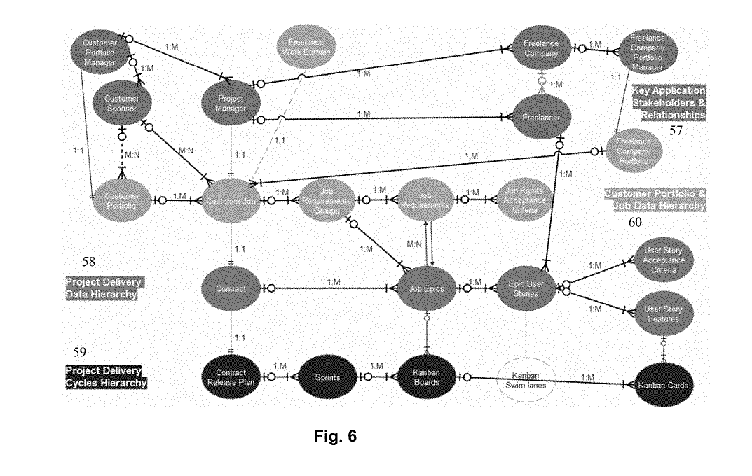

FIG. 6 illustrates the hierarchy of structures and data within the proposed Online Freelancing system. There are four separate levels of hierarchy documented in the Figure such as key application Stakeholders and relationships 57 which captures various User roles within the system, and their relationships. The category-wise application Stakeholders are Customer, Freelancer, Freelance Company, and Project Manager. The Customer publishes and awards jobs in the system in return for an agreed remuneration. This User category may include the following roles, Customer Sponsor who owns Customer projects from a business and funding perspective, Customer Portfolio Manager holds the responsibility of managing and governing Customer Portfolios, their scope achievement, their strategic objectives result, timeliness of completion, budgetary allocation vs. spends, etc., Customer Single point of contact (SPOC) is a role responsible for Customer roles' Memberships Management, publish jobs on behalf of the Customer Sponsor, definition of Customer Portfolios, perform assignment of Customer Portfolio Manager to Customer Project Portfolios, perform role of Customer Sponsor's agent for Project Governance, etc., Freelancer is a Role or User Category qualified by capabilities and/or responsibilities which includes skills in specific Freelance work domains, freelancer skills may be self-certified at specified skill levels as permitted by the proposed Online Freelancing system, and has published a Portfolio of prior work and details both on this Online Freelancing system, and outside it.

The following capabilities and/or responsibilities qualify the Freelance Company, a formal grouping of Consultants, or a registered Company that employs a group of Consultants. Here, Consultants are similar to Freelancers except that they are not “independent workers”, and are associated with a specific Freelance Company, a Freelance Company may typically provide services in specified Freelance work domains, consolidate all projects executed for a specific Customer into a Freelance Company Project Portfolio.

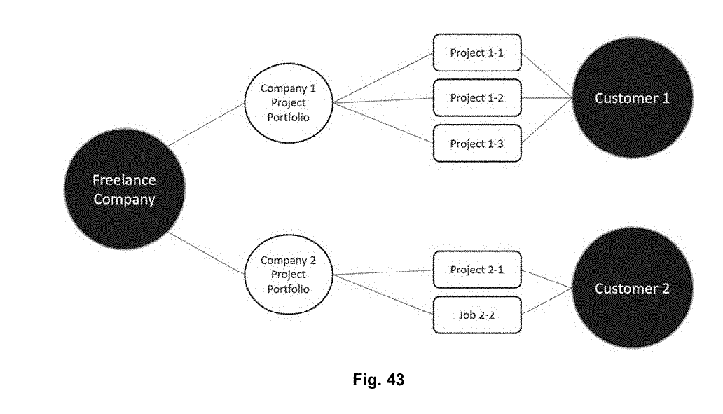

FIG. 43 provides an exemplary embodiment of a Freelance Company Project Portfolio. A Freelance Company include the roles such as Freelance Company SPOC, Consultant, and Freelance Company Portfolio Manager. The Freelance Company SPOC is the role responsible for user memberships Management, receipt, and processing of Virtual Team invitations, a definition of Freelance Company Project Portfolios, assignment of Freelance Company Portfolio Managers, etc. The Consultant or a Freelance Company Consultant may hold skills in specific Freelance work domains, consultant skills may be self-certified at specified skill levels as permitted by the proposed Online Freelancing system and has published a Portfolio of prior work and details both on this Online Freelancing system, and outside it, Freelance Company Portfolio Manager's may be responsible for Efficient Management and Governance of an assigned Freelance Company Project Portfolio.

The Project Manager's role or User Category may be qualified by the capabilities and/or responsibilities such as hold skills in Project planning, business analysis, Project monitoring and control, Project Governance with Senior Management, Project Financial planning, Team coordination, etc., and may hold skills in specified Freelance work domains, Project Management skills may be self-certified at specified skill levels as permitted by the proposed Online Freelancing system, publish his or her Project Management-related Certifications on the proposed Online Freelancing system, publish a Portfolio of prior work and details both on this Online Freelancing system, and outside it, engage a group of Freelancers or Freelance Company Consultants to respond to Customer job announcements and to execute services as per agreements on Customer Contracts, etc.

A Freelance Company may include Project Managers working on its behalf. In this case, a Freelance Company can submit bids against Customer jobs directly from the Freelance Company, leveraging the Consultants under the Freelance Company to be part of the Job Proposal team.

The Customer Portfolio and job data hierarchy 60 is a hierarchy of data from Customer Portfolio through Customer jobs, job requirement groups, job requirements to job acceptance criteria. This may include Customer Project Portfolio, Customer job, job requirement groups, job requirements, job requirements, and job requirements acceptance criteria. Customer Project Portfolio which is a logical group of Customer jobs or projects that may map to a specific Customer Strategic objective.

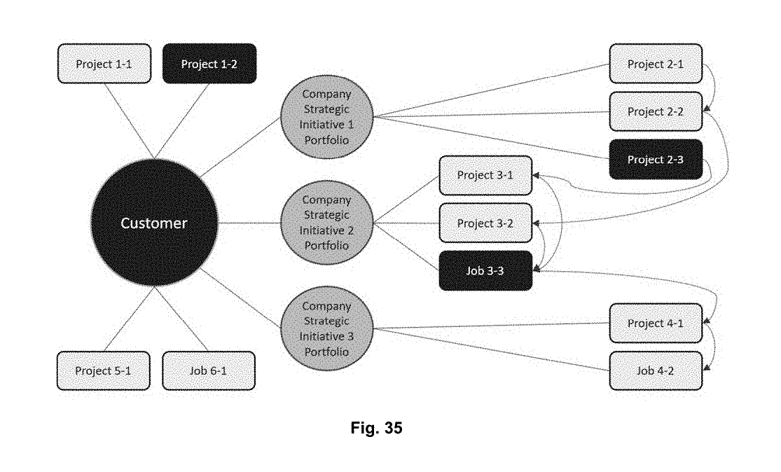

FIG. 35 provides an exemplary embodiment of a Customer Project Portfolio. Customer job is a unique work item that is qualified by a specified Scope, duration, cost, job context, etc., as published by the Customer SPOC. Each job may be decomposed into one or more job requirement groups, each of which may be a logical grouping of requirements. Job requirements is a specific set of activities or functions within a Customer job. Each job requirement group may be decomposed into one or more job requirements. Job requirements acceptance criteria are when each job requirement may be mapped to one or more acceptance criteria that are used to validate or certify the completion status of a given job requirement. The project delivery data hierarchy 58 are structures that are used in Management of project execution which includes Contract, Job Epics, Epic User Stories, User Story acceptance criteria, and User Story Features. A Contract is a formal engagement between two parties in the proposed Online Freelancing system. A Contract may map to a Customer job, may be signed by a Customer and the Project Manager that a Customer job is awarded to (in which case this is termed a Customer Contract), or be executed between a Project Manager and a Freelancer (in which case this is typically termed a Freelancer Sub-Contract).

A Job Epic is a logical grouping of functions or actions in the proposed Online Freelancing system. A Customer Contract may be decomposed into one or more Job Epics. A job requirement group may have a one-to-one or one-to-many relationship with a Job Epic. A Job Epic may have a many-to-many relationship with a job requirement. An Epic User Story is a logical function or action as defined in the Customer job and is typically assigned to a single Freelancer during job execution. A User Story may have a many-to-many relationship with a job requirement. The User Story acceptance criteria are each User Story mapped to one or more acceptance criteria that is used to validate or certify the completion status of a given User Story.

Each User Story may be decomposed into one or more User Story Features that are defined for Epic User Story execution tracking and reporting. The project delivery cycles hierarchy 59 is a Delivery Process Management framework that includes Contract Release Plan, Sprints, Kanban Boards, Kanban Swimlanes (virtual), and Kanban Cards. The Contract Release Plan maps to a Customer Contract depicts the manner in which the Contract may be decomposed and executed in a structured way, adopting principles from Agile Project Management methodology. Each Contract may be executed in one or more Sprints. Each Sprint may typically be one or two weeks long in duration, for ease of tracking and Management. Each Job Epic may be mapped to one or more Kanban Boards, depending on the number of User Stories that the Epic contains.

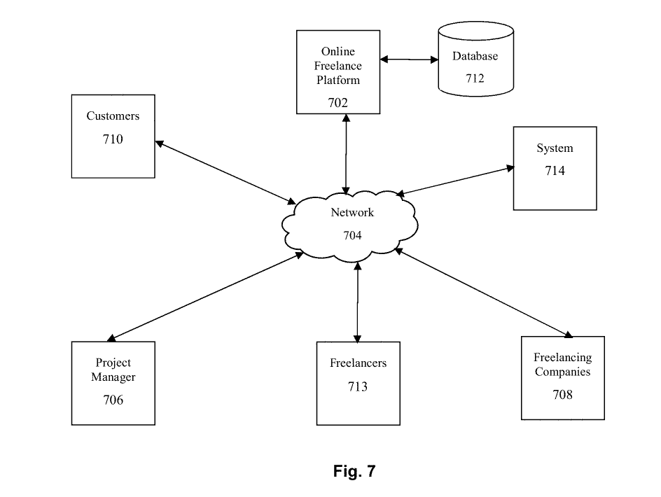

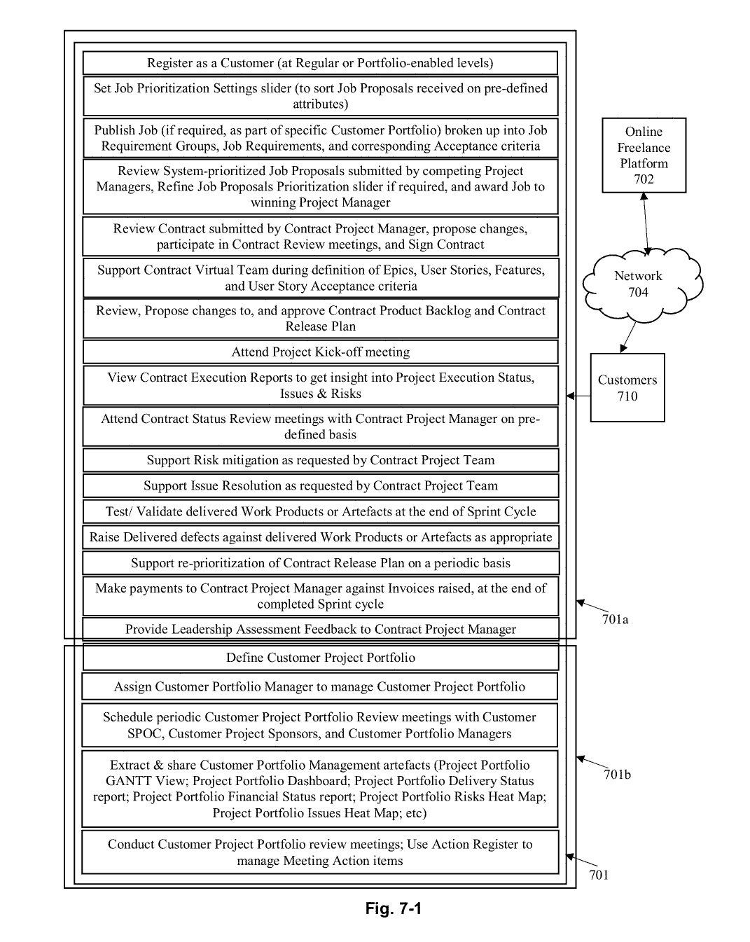

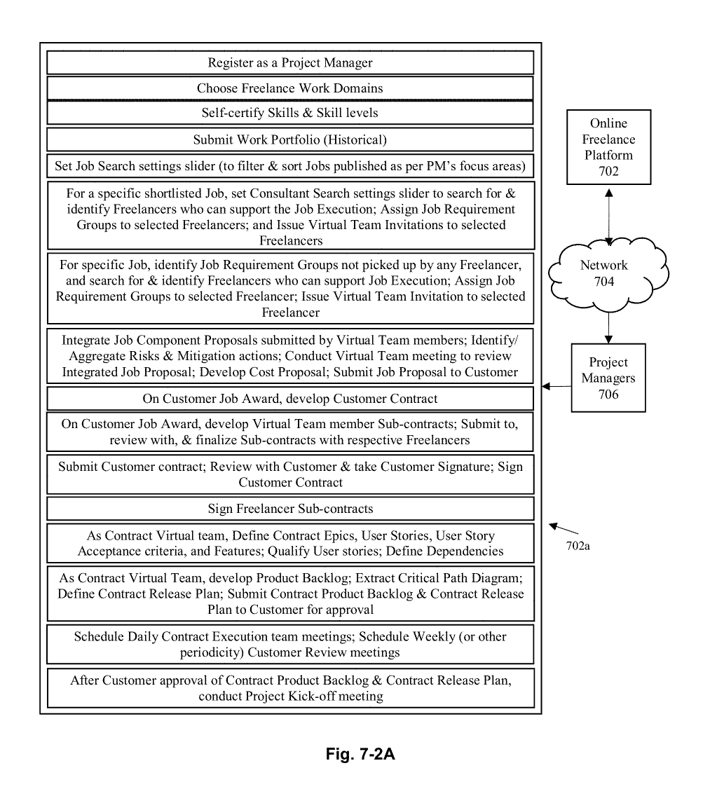

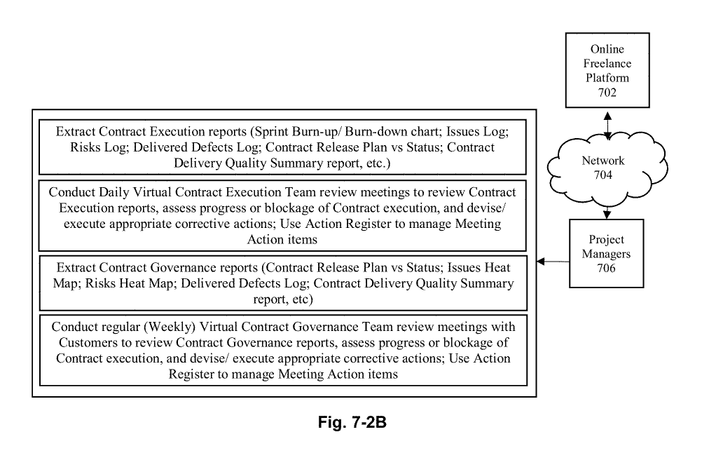

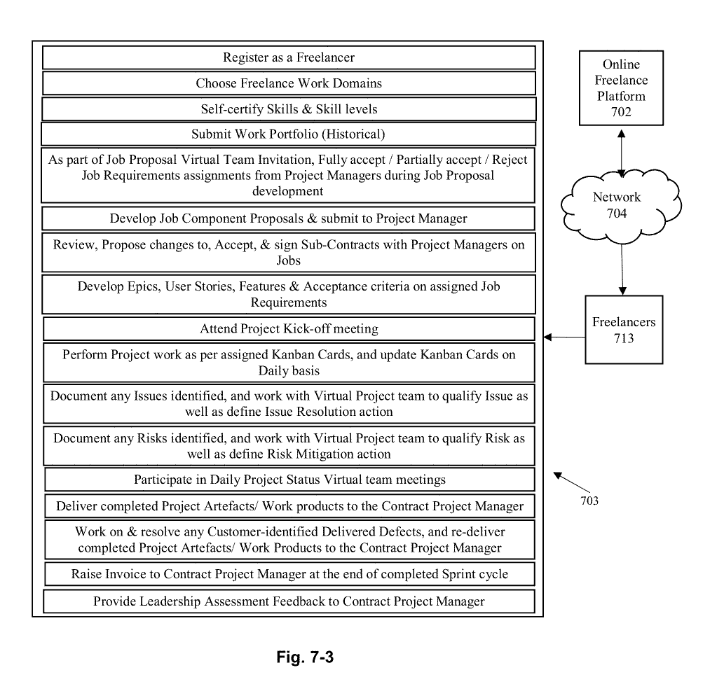

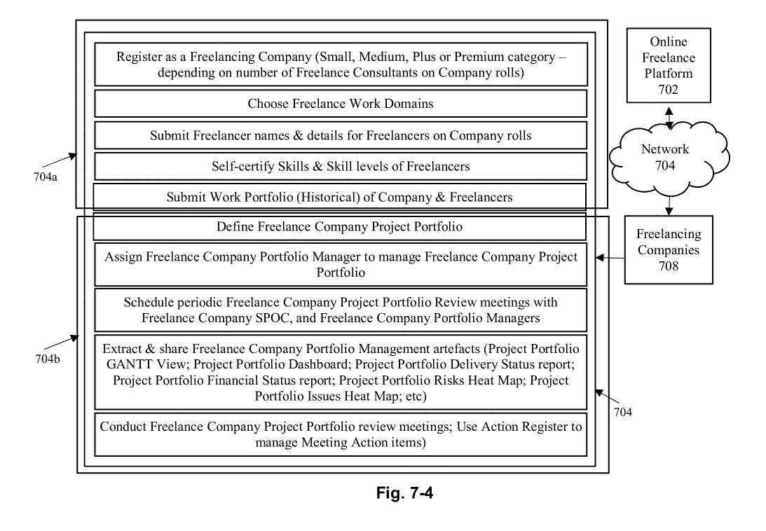

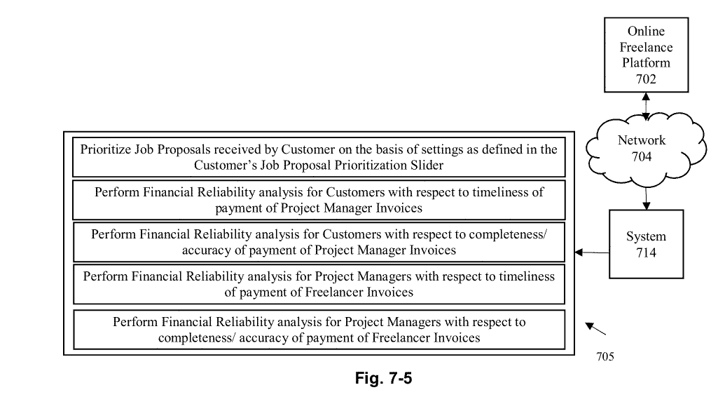

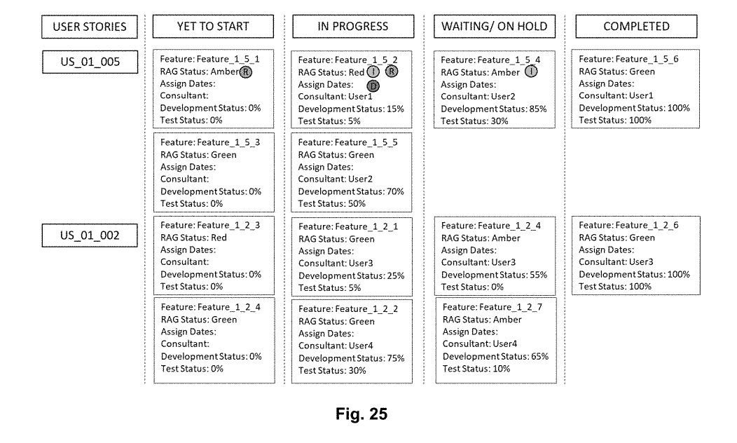

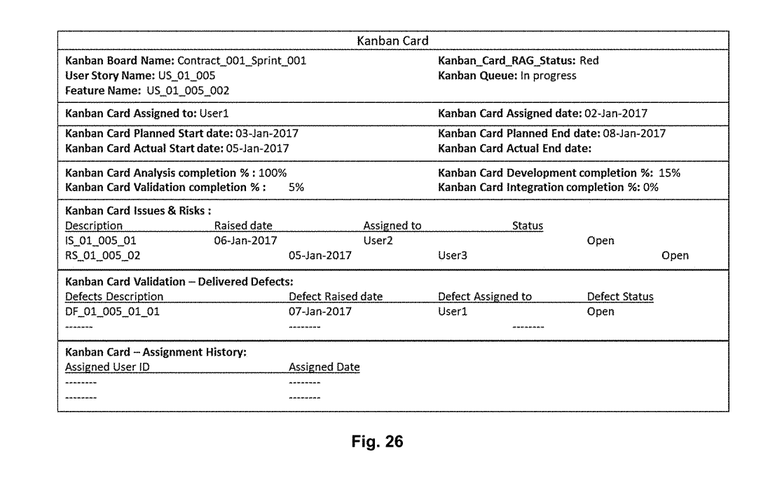

FIG. 25 provides an exemplary embodiment of a Kanban Board. A Kanban Swim-lane is a virtual representation of a User Story corresponding to the Epic that is associated with a Kanban Board. Each User Story is decomposed into Features, and each Feature in a User Story may be mapped to a Kanban Card. FIG. 26 provides an exemplary embodiment of a Kanban Card. In an embodiment of the invention as depicted in FIG. 7, the Online Freelance platform 702 is connected to an Online database 712, as well as a network 704 which in turn connects the following high-level elements, Customers 710, Project Managers 706, Freelancers 713, Freelancing Companies 708, and a system 714.

Customer functionalities supported by the Online Freelancing Platform 702 is illustrated in the embodiment in FIG. 7-1. Said functionalities comprises ability to register as a Customer (Regular membership or Portfolio-enabled membership), ability to upgrade or downgrade membership, ability to renew membership, ability to cancel membership, ability to document jobs decomposed into job requirement groups and further down to job requirements specified in appropriate detail so as to enable tracking, document acceptance criteria, mapped to each job requirement defined as ability to identify dependencies across job requirements and across jobs, so as to enable appropriate sequencing of work execution, ability to define the sensitivity of data that is submitted as part of jobs and job proposals, ability to set up capability to demand an NDA (non-disclosure agreement) from all Project Managers and Freelancers who seek access to the job and corresponding job requirements, acceptance criteria, dependencies, etc. Further, ability to qualify job requirements on the basis of criticality level which allow Customers to define the importance or impact of a job requirement to a job or project, urgency of deployment to allow Customers to document the urgency of deployment of a specific requirement within a job or project, dependencies which allow Customers to sequence requirements on the basis of different types of dependencies, such as business process internal dependency, external interface dependency, technology availability or usability dependency, resource availability dependency, funding availability dependency, etc., further, a usage level to allow the qualification of a job requirement on the basis of usage pattern of the functionality associated with a job requirement, ranging from very high usage to very low usage, and complexity to allow Freelancers to assess complexity of implementation of a job requirement, in terms of technology complexity, integration complexity, resource availability risk, schedule adequacy risk, etc.

Also, ability to publish the job on the platform, with the specified job requirements groups, job requirements, acceptance criteria, job requirements qualification attributes, and job requirements dependencies, etc., ability to set up the “Job Proposals Prioritization Settings Slider”, to prioritize delivered job proposals on the basis of factors such as job proposal price, job proposal Schedule, Project Manager fitment to job, Contract Execution Team fitment to job, proposal adequacy, etc, ability to change “Job Proposals Prioritization Settings slider” after receiving all job proposals submitted against a given job, ability to review the prioritized job proposals list and shortlist the most suitable job proposal for Contracting, ability to finalize a job proposal that may or may not be the top-listed job proposal in the system-prioritized list and award the specific job to the appropriate winning Project Manager, ability to review and update the Contract document submitted by the Project Manager for the winning job proposal, ability to sign Contract with the Project Manager for the winning job proposal, work with the Contract Execution Team to support the definition of Job Epics, User Stories, User Story acceptance criteria, User Story Features, etc. work with the Contract Execution Team to support the qualification of User Stories based on attributes such as complexity, criticality, urgency of deployment, dependencies, etc., work with the Contract Execution Team to support the sequencing of User Stories to develop the right Contract Release Plan, ability to review and approve the Contract Product Backlog and Contract Release Plan after its delivery by the Project Manager.

Further, search for and invite the “most suitable” Project Managers to a given job, leveraging the approach as embodied in FIG. 13A. Additionally, actively participate in and influence Contract Governance meetings. Ability to validate or test the delivered work products or Sprint Artefacts, ability to raise delivered defects in the Defect Management system, and track defects to closure, ability to request for changes to previously agreed functionality, to be managed by the Project Manager via change requests, work with Project Managers to review and decide on cost estimates for newly added change requests and review re-prioritized Contract Release Plans, ability to make payments to the Contract Project Manager against invoices submitted by the Project Manager, typically at the end of each Sprint. Assess the leadership performance of Project Managers on an agreed basis, usually at the end of each Sprint, etc. Define a Customer Project Portfolio. Assign a Customer Portfolio Manager to a Customer Project Portfolio. Schedule periodic Customer Project Portfolio review meetings with Customer SPOC, Customer Project Sponsors, Customer Portfolio Managers, etc. Extract and share Customer Portfolio Management artefacts, such as Project Portfolio GANTT View, Project Portfolio Dashboard, Project Portfolio Delivery status report, Project Portfolio Financial status report, Project Portfolio financial summary, Project Portfolio risks heat map, Project Portfolio issues heat map, etc. Conduct Customer Project Portfolio review meetings and use action register to manage meeting action items, etc.

Further, the Project Manager functionalities supported by the platform 200 are illustrated in FIG. 7-2A and FIG. 7-2B, including ability to register as Project Manager, renew membership and cancel membership, ability to set up “Job Search settings slider”, to prioritize jobs filtered by factors such as, Freelancer work domain, skills category, etc., and sorted on factors such as Customer financial reliability score, job requirements count, etc, ability to search for jobs in specific Freelance work domains.

Ability to set up “Consultant Search settings slider”, to prioritize consultants displayed, as embodied in FIG. 14 filtered by “Freelance work domain”, etc., and sorted on factors such as Freelancer Profile score, Freelancer average rate per hour, etc. Ability to search for and engage Freelancers with specific skills, to work on specific jobs. Ability to develop integrated job proposals, using as input job component proposals from Freelancers. Conduct integrated job proposal reviews with participation from all proposal team member Freelancers. Ability to develop a cost proposal to augment the integrated job proposal. Ability to submit unified job proposal and cost proposal to the Customer. Ability to build Customer Contract and submit to the Customer once the Customer has awarded job to the Project Manager. Ability to review and update Customer Contract based on feedback from the Customer. Ability to sign the Customer Contract, after the Customer has signed the Customer Contract. Ability to develop and submit Sub-Contracts for the proposal team member Freelancers. Ability to review and update Freelancer Sub-Contracts based on feedback from Freelancers. Ability to sign the Freelancer Sub-Contracts, after the respective Freelancers have signed their relevant Freelancer Sub-Contracts.

Lead the development of Job Epics, User Stories, User Story acceptance criteria, and User Story Features. Lead the qualification of User Stories based on attributes such as complexity, criticality, the urgency of deployment, size, dependencies, etc. Lead the sequencing of User Stories to develop the right Contract Release Plan. Lead the development of the Contract Product Backlog and Contract Release Plan and its submission to the Customer. Ability to define Kanban boards and Kanban cards based on standard templates. Ability to map Kanban Boards to Job Epics, and map Kanban Cards to User Story Features, etc. Ability to schedule and conduct a project kick-off meeting with participation from Customer(s) and all impacted Freelancers. Lead work execution kick-off on a signed Contract. Ability to document any issue identified and work with the Contract execution team to qualify the problem and to define appropriate issue resolution actions. Ability to record any risk identified, and work with the Contract execution team to qualify the risk and to establish appropriate risk mitigation actions. Ability to schedule and conduct daily stand-up meetings with the Contract Execution Team to evaluate progress made on job execution and to apply corrective actions as necessary. Ability to receive job artefacts or components from Contract Execution Team, to integrate them appropriately to generate Customer deliverables, and to deliver Customer deliverables to the Customer in a trackable and efficient manner.

Further, ability to monitor, lead the analysis of, assignment of, and tracking to a closure of Customer-identified delivered defects. Ability to include delivered defects in the Contract Product Backlog, and to update the Contract Release Plan to cover the identified delivered defects inappropriate Sprints for execution. Ability to review Customer change requests and associated user stories and cost estimates, to work with the Customer to discuss and agree on new User Story cost estimates, to include new User Stories in the Contract Product Backlog, and to re-prioritize the Contract Release Plan, and create new Kanban boards or cards as appropriate to track the new user stories' execution. Schedule and conduct regular (typically weekly) Contract Governance meetings with Customers and ensure that Customers are aligned with work execution progress or outlook and deliverables status. Ability to raise Customer invoices based on agreements in the Customer Contract, typically at the end of each Sprint. Ability to pay Freelancers' invoices based on agreements in Freelancer Sub-Contracts, typically at the end of each Sprint. Ability to assess the performance of Freelancers in the Contract Execution Team, on an agreed basis, typically at the end of each Sprint, etc.

In one embodiment of the invention as documented in FIG. 7-3, the network of Freelancers 713 may have enabled functions such as ability to register as a Freelancer (base or active member), upgrade or downgrade membership, renew membership, cancel membership, choose preferred Freelance work domains, self-certify their skills and skill levels on the system, submit own Freelance work Portfolio (history) on the system, Accept partially, accept completely, or reject entirely the assignment of job requirement groups as assigned by the Project Manager as part of the Contract Execution Team invitation, submit job component proposal and work estimate to the Project Manager, User Story sizing is performed bottom-up, primarily using the T-shirt sizing model. Also, includes attending Contract kick-off meeting after Contract is signed, ability to pick up assigned Kanban card and commence work on corresponding User Story, document any issue identified and work with the Contract Execution Team to qualify the problem and to define appropriate issue resolution actions, report any risk identified, and work with the Contract Execution Team to qualify the risk and to define appropriate risk mitigation actions, ability deliver job component artefacts or deliverables related to the User Story to the Project Manager when it is ready, update Kanban card on a daily basis after performing work as necessary on the assigned User Story, participate in daily virtual stand-up team meetings, ability to analyse delivered defects associated with User Stories delivered, work with Project Manager to include delivered defects as appropriate in the Product Backlog and to re-prioritize the Contract Release Plan, work on the newly created Kanban cards and provide new artefacts or updated artefacts to the Project Manager, ability to analyse change requests raised by the Customer, develop new User Stories as proper, and develop cost estimates as proper, ability to submit new User Stories and cost estimates to the Project Manager, and work on any newly assigned Kanban cards, ability to raise invoice to Project Manager at the end of each Sprint cycle, as per agreement with the Project Manager, ability to provide leadership assessment ratings to the Project Manager at the end of each Sprint cycle as per agreement with the Project Manager, etc.

Further, Freelance Company functionalities supported by the platform 200 is disclosed. Freelance Companies may have the following functions enabled, as documented in the embodiment depicted in FIG. 7-4. Ability to register as a Freelance Company (at different Membership levels depending on headcount of Freelancers enrolled in the Freelance Company), ability to upgrade or downgrade membership, renew membership, cancel membership, choose preferred Freelance work domains, register on the Freelance Company rolls a set of Freelancers, working in specified Freelance work domains, submit own Freelance Company's work Portfolio history on the system.

Ability to set up and manage a logical set of projects for a given Customer as a Freelance Company Portfolio, to drive improved service delivery to the Customer. Ability to identify a person as a Freelance Company Portfolio Manager, authorized and entrusted to monitor and manage all projects within that Freelance Company Project Portfolio. Ability to schedule and conduct periodic Freelance Company Portfolio Governance meetings, with participation from the appropriate Project Managers and any other interested individuals. Ability to aggregate Freelancers' performance assessment data for all Freelancers in the Freelance Company, etc.

The proposed Online Freelancing system 200 also may include system-driven enabling functions as depicted in the embodiment in FIG. 7-5, such as, prioritize job proposals received by Customer on the basis of settings as defined in the Customer's job proposal Prioritization Slider, perform financial reliability analysis for Customers with respect to timeliness of payment of Project Manager invoices, perform financial reliability analysis for Customers with respect to completeness or accuracy of payment of Project Manager invoices, perform financial reliability analysis for Project Managers with respect to timeliness of payment of Freelancer invoices, and perform financial reliability analysis for Project Managers with respect to completeness or accuracy of payment of Freelancer invoices, etc.

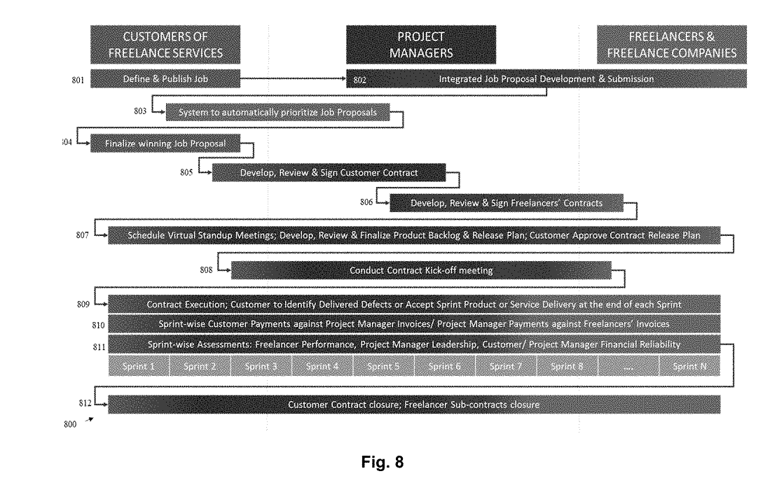

FIG. 8 may depict an embodiment of a high-level workflow 800 for jobs execution in the proposed Online Freelancing system, and contains the high-level elements, workflow component 801, workflow component 802, workflow component 803, workflow component 804, workflow component 805, workflow component 806, workflow component 807, workflow component 808, workflow component 809, workflow component 810, workflow component 811, and workflow component 812. The workflow component 801 covers the process for publishing of a job by a Customer. The workflow component 802 may include the methods from Project Manager engagement of Virtual Freelancers team for job proposal development up to integrated job proposal submission to the Customer. The workflow component 803 may comprise the system-driven process of prioritization of various job proposals submitted by competing Project Managers, and presentation of the list to the Customer in his or her or their preferred prioritization sequence based on the weighted application several factors to the job proposal and the Job Proposal Team characteristics. The workflow component 804 may cover the Customer identifying the most appropriate job proposal and awarding of the job to the corresponding Project Manager. The workflow component 805 may cover the Project Manager process of development of the Customer Contract while being supported by the Customer in the process execution.

The workflow component 806 may cover the Project Manager process of development of Freelancers' Contracts for all Freelancers in the job proposal Virtual Team while being supported by all of the specified Freelancers. The workflows 805 and 806 may run partially in parallel, as the Customer Contract shall be signed only after the Freelancer Sub-Contracts have been finalized, and only after the Customer Contract signature shall the Freelancer sub-Contracts be signed by the respective Freelancers. The workflow component 807 may cover the Project Manager process of scheduling daily Contract execution review virtual stand-up meetings with the Contract Execution Team (Project Manager and Freelancers), of scheduling regular (typically weekly) Contract Governance virtual stand-up meetings with the Contract Governance team (Project Manager and Customer), of developing, studying with and obtaining Customer sign-off for the Contract Product Backlog, of developing, reviewing with and obtaining Customer sign-off for the Contract Release Plan, and setting up of the various Kanban Boards and Kanban Cards associated with the job. The workflow component 808 may include the milestone of conduction of the project kick-off meeting. The workflow component 809 may cover the “real” Contract Execution activities, that is, Sprint-wise execution of the Contract Release Plan by the Project Manager, Freelancers team, and supported by the Customer.

The workflow component 810 may run immediately after each cycle of Sprint execution of the workflow component 809 and covers the process of raising of Customer invoices by the Project Manager, raising of Project Manager invoices by individual Freelancers, payment of Customer invoices by the Customer to the Project Manager, and payment of Project Manager invoices by the Project Manager to the respective Freelancers. The workflow component 811 may run immediately after each cycle of Sprint execution of the workflow component 809 and covers the process of submitting Project Manager leadership assessment feedback by the Customer and Freelancers to the Project Manager, and the process of offering Freelancer Performance assessment feedback by the Project Manager to each Freelancer. The workflow components 809, 810, and 811 may run repeatedly until the end of all Sprints in the Contract Release Plan. The workflow component 812 may cover the Customer Contract closure and the Freelancers' Sub-Contracts closure. At this time, Customers and Freelancers may also provide certain Contract-end feedback to the Project Manager.

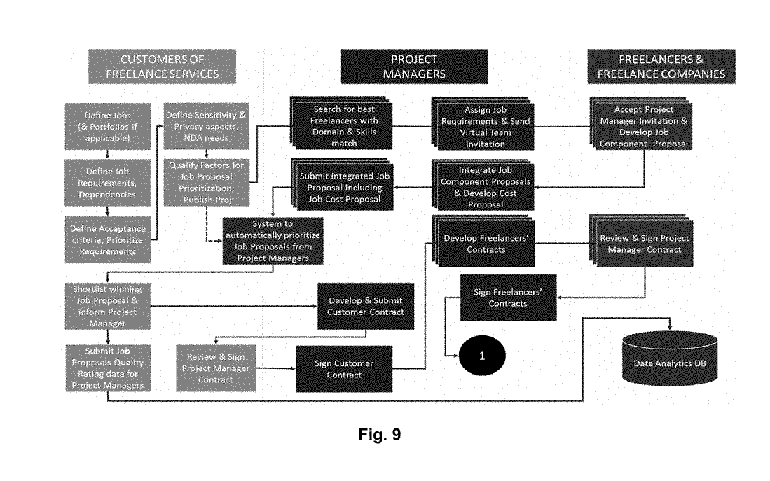

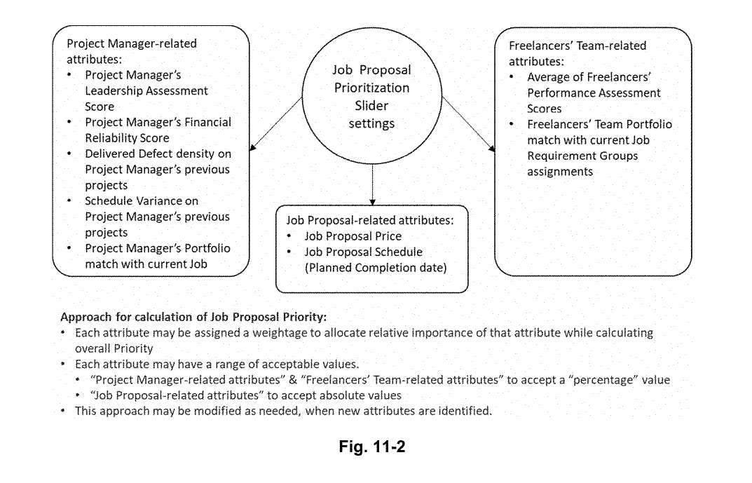

FIG. 9 may depict the embodiment of the Pre-Contract award flow for a freelance project on the proposed Online Freelancing system. This flow corresponds to workflow components 801, 802, 803, 804, 805, 806, and 807 of FIG. 8. The details of the job proposal development activity have been depicted in the embodiment described in FIG. 11-1, and further information about the job proposals prioritization slider components have been depicted in the embodiment in FIG. 11-2. The following activities or functions are executed during the workflow as illustrated in the embodiment in FIG. 9:

1) A Customer may define and publish a job, which may be linked to Customer Project Portfolio, if applicable, the job may be decomposed into job requirement groups. The job requirement groups may be further decomposed into job requirements which may be described and qualified based on attributes such as job requirement type (functional, Non-functional, etc.), job requirement criticality (critical, must-have, good-to-have, value-add, etc.), and job requirement deployment urgency (immediate-term, short-term, medium-term, long-term, etc.). Job requirements may be mapped to acceptance criteria which may be described and qualified based on attributes such as acceptance criteria type (functional, Non-functional), etc., may use the exemplary embodiment depicted in FIG. 10 to define and train job requirements. The template consists of job ID or Name, job requirement group ID or name, job requirement description, job requirement criticality level is the significance of the job requirement to the Customer, job requirement urgency of deployment level indicates the level of Customer's need to deploy the specific function and extract return on investment on the service. Job requirement usage level which shows the frequency and volume of usage of the specific function by the Customer. Job requirement acceptance criteria which consist of the tests or validation steps to confirm that the job requirement has been successfully delivered to the Customer. Job requirement acceptance criteria type that could be of functional or non-functional acceptance types.

The job requirement dependencies may be identified and documented using the exemplary embodiment depicted in FIG. 20-1, and further qualified based on the type of dependency. A possible categorization of dependencies is business process dependency which is generated due to a logical flow of business processes internal to the Customer Organization, external interface dependency created due to a logical flow of data or control from or to interfaces external to the Customer Organization, resource utilization dependency caused by the level of availability of any resource, such as people, infrastructure, etc. level of availability may be, fully available, partially available, not available, etc., Technology dependency is generated by the availability of/or insight into or lack of availability of/or insight into market technological updates, technological platform changes, etc., Funding dependency generated by the availability or lack of availability of funding for executing a given job or project. The job may further be qualified using attributes such as job proposal prioritization factors settings slider, job data sensitivity, Non-Disclosure Agreement (NDA) signature requirement, keep Customer name hidden while publishing job, allow documents download to PC, etc.

2) The Project Managers competing on the job may sign the job NDA if applicable, analyse the job, and gain an understanding of the freelance work domain which is directly documented in the job, tentative size of the job which is calculated by analysing job requirement groups, job requirements, acceptance criteria, dependencies, tentative duration of the job being calculated by examining job requirement groups, job requirements, acceptance criteria, dependencies, when can the job start which is calculated by analysing job requirement groups, job requirements, acceptance criteria, dependencies. When does the job need to be completed which is directly documented in the job, number of Freelancers are necessary to execute and complete the job in a timely fashion, calculated by analysing job requirement groups, job requirements, acceptance criteria, dependencies, and further qualify using overall duration available, from the previous two steps), skills and skill levels needed for the Freelancers, calculated by analysing job requirement groups, job requirements, acceptance criteria, dependencies, and further qualify using overall duration available, from the previous three steps.

Further, affordability as to how much can the Customer afford to pay at maximum and is directly documented in the job but is optional. Search for and shortlist Freelancers meeting the following criteria, for working on the job requirements assignments like freelance work domain, skills needed, skill levels required, matching availability requirements, matching the affordability requirements, etc. Create a map of shortlisted Freelancers to job requirement groups or job requirements as appropriate. Send “job proposal Virtual Team” invitations to each shortlisted Freelancer along with the corresponding job requirement groups or job requirements assignments.

3) Shortlisted Freelancers invited to job proposal Virtual Teams may choose to “fully accept” all job requirements assignments made, “partially accept” some of the job requirements assignments made, and reject others, or “fully reject” all job requirements assignments made. This response may depend on the current workload of the Freelancer, as well as his or her work assignment preferences. For example, if the person has some current priorities and may be able to devote time for the project provided by the Customer, then he or she may select the “fully accept” or “partially accept” option. If the person is not free at all, then he or she may select the “fully reject” option.

4) At this point, the Project Manager may update the map of Freelancers to job requirements assignments with the acceptance status, identify job requirement groups or job requirements continuing in the “rejected assignment” state, search for Freelancers matching the criteria identified earlier, create a map of job requirements to Freelancer acceptances, and use this map to identify what requirements have not been accepted by any Freelancer in the Freelancers' group. If Freelancers have not accepted any of the job requirement assignments in the group, then the Project Manager may search for other Freelancers to bridge the gap and sends invitations to the Freelancers along with job requirement groups or job requirements assignments. This may continue until all job requirements have been accepted for analysis by the Freelancers' group that has been formed by the Project Manager. Form a Virtual Team in the system that will be named the “job proposal Virtual Team” and would include all of the Freelancers who are part of the assignment map above.

5) Each Freelancer in the job proposal Virtual Team may at this time perform the following actions confirm to the Project Manager the acceptance of job requirement groups or job requirements assignments, perform analysis of assigned job requirement groups or job requirements, any risks that are anticipated and the corresponding risks analysis, etc., develop implementation solutions or approaches for the designated job requirement groups or job requirements assigned, independently from the other Freelancers in the team, identify any external and internal dependencies and qualify them as technological dependency, resource availability dependency, internal business process dependency, external interface dependency, funding availability dependency, etc. Additionally, identify risks, qualify the risks identified (on aspects, risk probability, risk impact, risk resolution urgency, etc.), and define risk mitigation actions, develop schedule for solution implementation, including durations for tasks execution, internal and external validation or testing, etc., develop cost case for solution implementation, submit job component proposal to the Project Manager, including implementation solution or approach, risks with risk qualification and risks mitigation plans using the following as templates or guides.

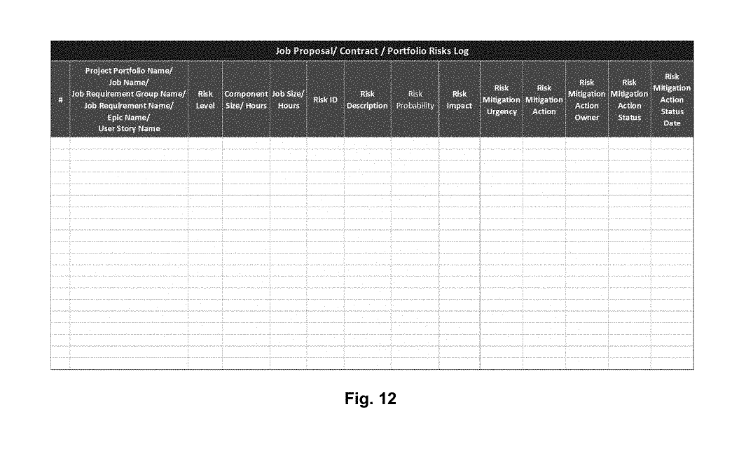

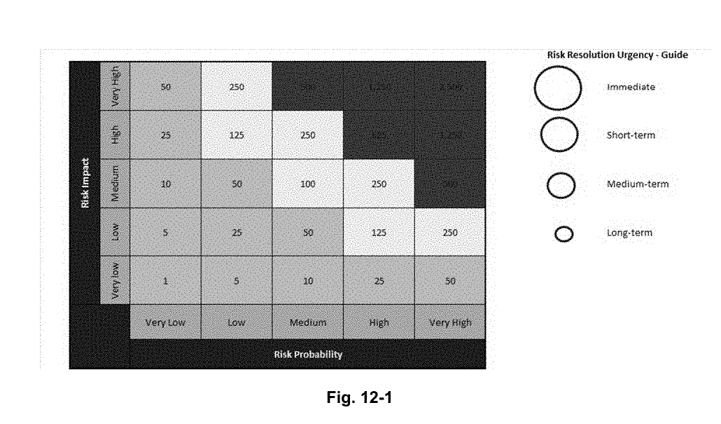

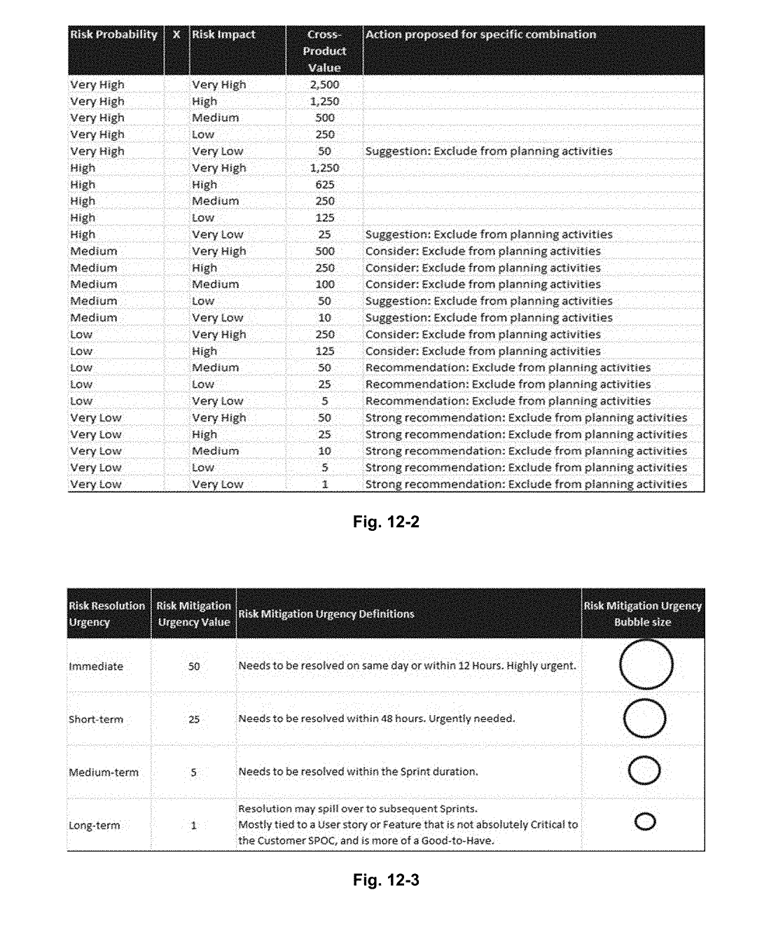

FIG. 12 as an exemplary embodiment for the template for risks log, documenting the inputs such as risk applicable to indicating Name of the relevant “Project Portfolio” or “job” or “job requirement group” or “job requirement” or “Contract Epic” or “User Story”, risk ID which is a system-generated value, risk description that refers to a brief description of the actual risk, risk impact which is the extent of impact of the risk. The scope of impact may cover, job, Sprints, Epics, User Stories, or negligible impact. some possible values may include very high such that the risk may carry the potential to break or impact the entire job or Contract or Contract Release Plan, or multiple Sprints within a Contract Release Plan, etc., high owing to the which carry the potential to break or impact a job requirement group, a Sprint, etc., medium in which the risk may carry the potential to break or impact a job requirement, several User Stories in a Sprint, etc., low risk may carry the potential to break or impact a part of a job requirement, a User Story, etc., and very low risk may carry the potential to break or impact a Feature or a negligible part of a job, etc. risk probability that refers to the extent of the likelihood that the risk event may occur. Some possible values may include,

a) Very High: Almost certain that the risk event would occur. May carry a potential likelihood value between 90% and 99%.

b) High: Highly likely that the risk event would occur. May carry a potential likelihood value between 80% and 89%.

c) Medium: Good likelihood that the risk event would occur. May carry a potential likelihood value between 60% and 79%.

d) Low: Not very likely that the risk event would occur. May carry a potential likelihood value between 40% and 59%.

e) Very Low: Very low likelihood that the risk event would occur. May carry a potential likelihood value of lesser than 40%.

Risk mitigation urgency is the timeframe available to mitigate the risk, before the risk impacts the job or its outcomes. Some possible values are immediate, short-term, medium-term, and long-term. Immediate is if the risk event is not mitigated on the same day or within twelve hours, then the risk event would impact the job and is highly urgent. Short-term is if the risk event is not mitigated within two business days or within forty-eight hours, then the risk event would impact the job and is very urgently needed. If the risk event is not mitigated within the Sprint cycle duration, then the risk event would impact the job which is referred as medium. In Long-term, the mitigation may spill over into multiple Sprints. Mostly tied to a User Story or Feature that is not critical to the job or Sprint and is more of a good-to-have functionality or a cosmetic functionality. Risk mitigation action is an action or actions that may be planned or executed, in order to achieve one or more of the following, eliminate the impact of the risk, reduce the impact of the risk, reduce the probability of the risk, transfer the impact of the risk to another party who is better capable of addressing the impact of the risk, introduce more time before the risk impacts the job or its outcomes, etc.

Risk mitigation action owner is the person (with the role) who would be entrusted with the accountability and responsibility to execute the risk mitigation action. Risk mitigation action status is the status of execution of the risk mitigation action. Risk mitigation action status date is the date on which the latest state of the risk Mitigation action was documented. Qualified internal and external dependencies, Schedule for solution implementation, cost case for solution implementation, etc.

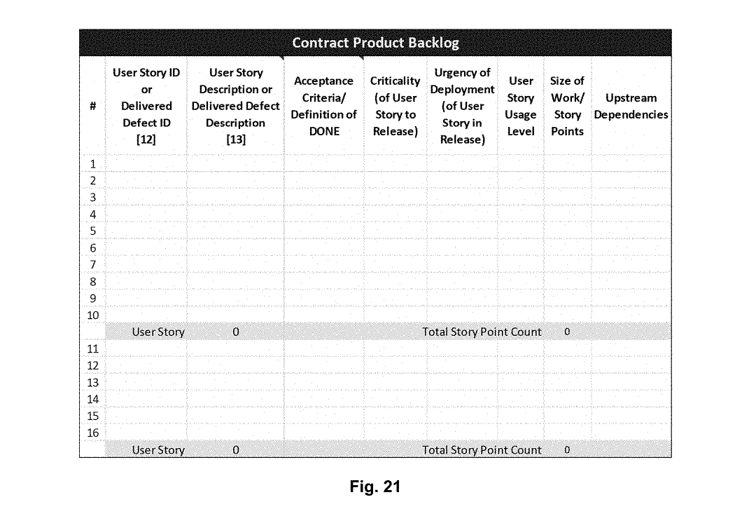

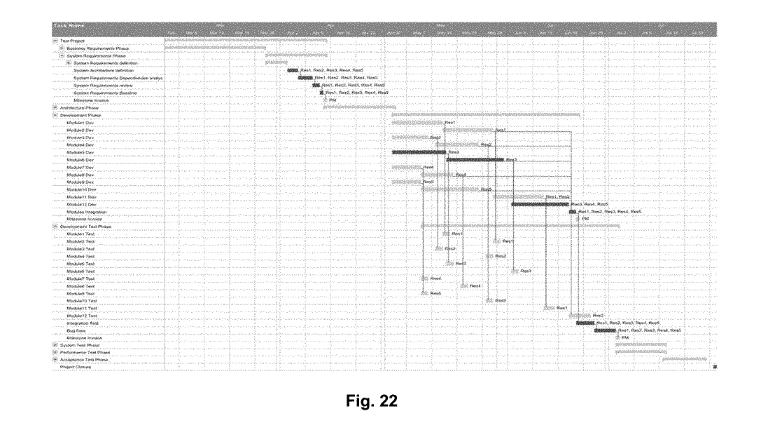

Upon receipt of all job component proposals from the various Freelancer team members, the Project Manager may then aggregate the job component proposals received from all the Freelancers in the group, and develop an integrated job proposal, and then facilitate a job proposal review meeting to review the integrated job proposal, clarify any integration issues, define external dependencies, define the overall schedule of development, etc. The integrated job proposal may include components such as a total solution or approach to implement the full job, which may contain as appropriate like technology architecture and design, components networks and interactions, operations flows and resourcing, etc., solution or approaches to implement each job requirement groups or job requirements within the job, resource assignments to job requirements groups or job requirements, an integrated Schedule estimate to complete the work, which may include sequencing of individual components and possible work assignments, critical path diagram, as documented in the exemplary embodiment in FIG. 22.

A schedule diagram where all tasks or activities in a project have been being documented in an appropriate sequence, based on upstream or downstream dependencies, etc. Any dependencies for the work to be performed, categorized into external interface dependencies, internal business process dependencies, resource dependencies, funding dependencies, technological dependencies, etc. Any risks that are anticipated and corresponding risks analysis on the basis of risk probability, risk impact, risk resolution urgency, etc. The Project Manager may then invite the job proposal Virtual Team to a meeting to review the integrated job proposal as well as the findings from his or her analysis and update the integrated job proposal appropriately to incorporate decisions and recommendations from the job proposal review meeting. The Project Manager may then develop an integrated cost proposal, the access to which may be restricted to the Project Manager and the Customer.

The integrated cost proposal comprises costs from individual job Component proposals as submitted by the Job Proposal Team members, integration-related costs, integration testing or validation related costs, Management overheads, risk contingency, etc. The Project Manager may then submit the integrated job proposal and the cost proposal to the Customer for consideration. The proposed Online Freelancing system may, after all competing job proposals have been received, prioritize all of the job proposals using the “job proposal prioritization slider” as described in FIG. 11-1 and FIG. 11-2, and present the prioritized list of job proposals to the Customer via the proposed Online Freelancing system.

FIG. 11-1 is an embodiment of the process of job proposal development subsequent to a Customer publishing a job, and may include the following major activities:

1) The Customer publishes a job on the proposed Online Freelancing system.

2) The Project Manager leverages the approach embodied in FIG. 14 to search for, identify, and engage a Virtual Team of Freelancers who fit the job's context regarding Freelance work domain, skills, skill levels, and work Portfolio and assigns job requirements to each Freelancer in the team.

3) Freelancers in the team analyse the job and develop job component proposals in response to their respective job requirement assignments and submit to the Project Manager.

4) The Project Manager integrates the job component proposals to develop the integrated job proposal.

5) The Project Manager then generates the corresponding cost proposal.

6) The Project Manager submits the integrated job proposal and cost proposal to the Customer.

The system automatically prioritizes the various job proposals submitted by different Project Managers and presents a prioritized list to the Customer. Some of the significant factors that may be considered by the system to prioritize job proposals, which are job proposal price, job proposal schedule completion date, Project Manager leadership score, average of Freelancer performance scores, delivered defect density on Project Managers' previous projects, schedule variance on Project Managers' previous projects, Project Managers' financial reliability score, Project Managers' Portfolio match with current job, Job Proposal Teams' Portfolios match with job requirement assignments, etc. The Customer chooses the best job proposal and awards the job to the Project Manager who has submitted that job proposal. The Customer may view the list of system-prioritized list of integrated job proposals submitted by competing Project Managers, using the “job proposal prioritization settings slider” as described in FIG. 11-2, and which primarily works by comparing job proposals and competing Job Proposal Teams based on several factors. Customers may assign different weights or importance to each element. The various factors considered may include average defect density on the Project Manager's previous projects, schedule variance on the Project Manager's previous projects, Project Manager's leadership score, average of Freelancer profile scores across all Freelancers or Freelance Company Consultants in a Job Proposal Team, Project Manager's financial reliability score, Project Manager's Portfolio match with current job, Job Proposal Team's Portfolio match with current job requirement group assignments, job proposal cost and job proposal execution schedule.

Average defect density on the Project Manager's previous projects:

1) Average Defect Density=Average of Sprint Delivered Defect Density across all jobs or all Sprints in jobs delivered.

$$2 ) Defect Density = \frac{Σ Delivered Defect Count \times Defect Severity}{Σ Sprint User Stories size in Story points}$$

Schedule variance on the Project Manager's previous projects:

1) Average Schedule variance=Average of Schedule variance across all jobs or all Sprints in jobs delivered.

$$2 ) Schedule variance = \frac{Actual Sprint duration excluding Change Requests}{Planned Sprint duration excluding Change Requests}$$

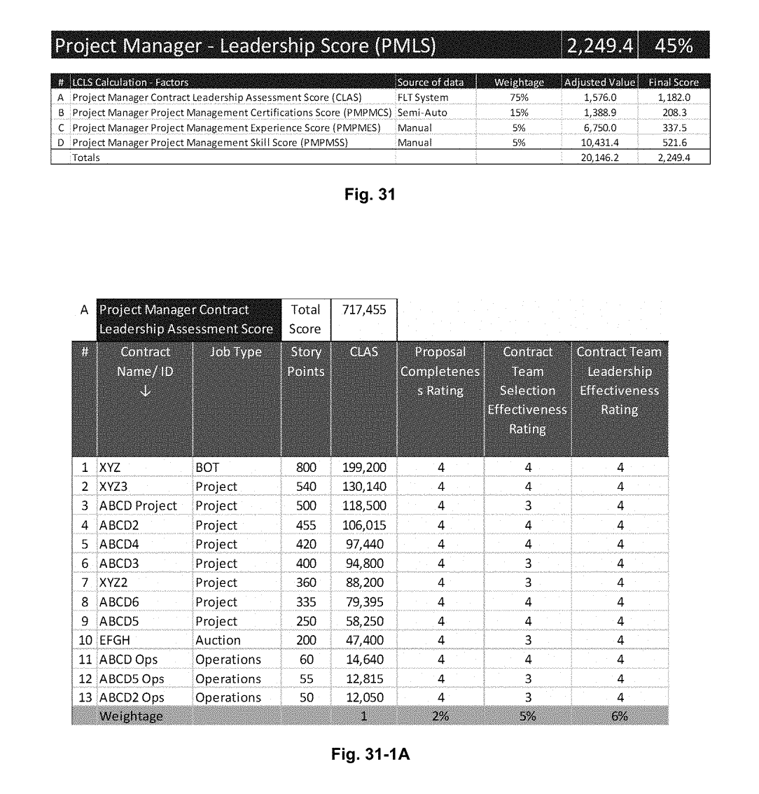

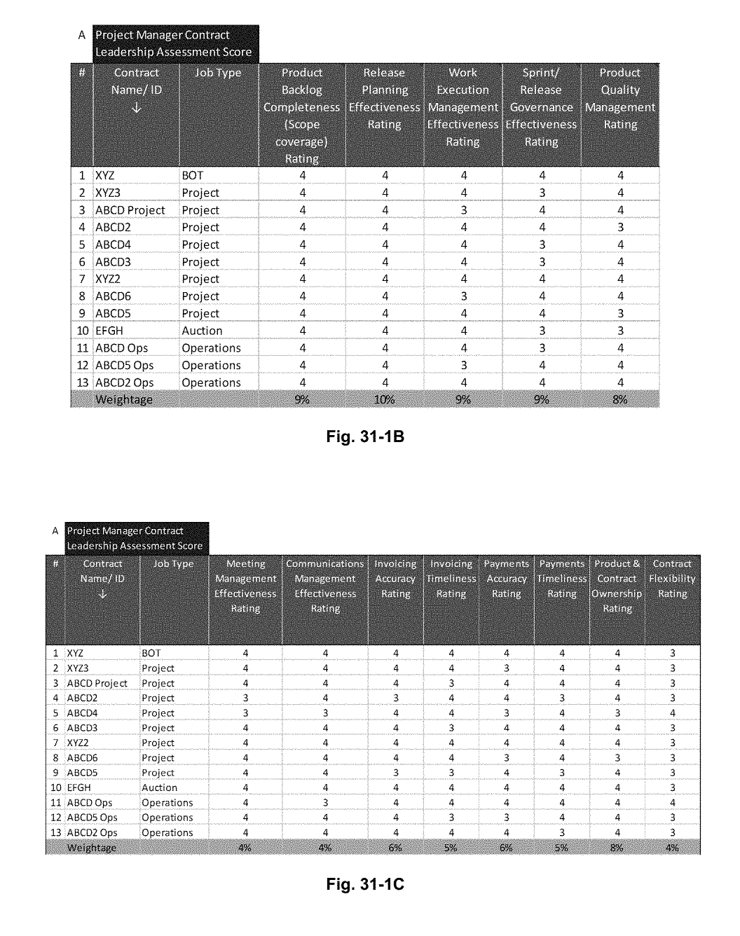

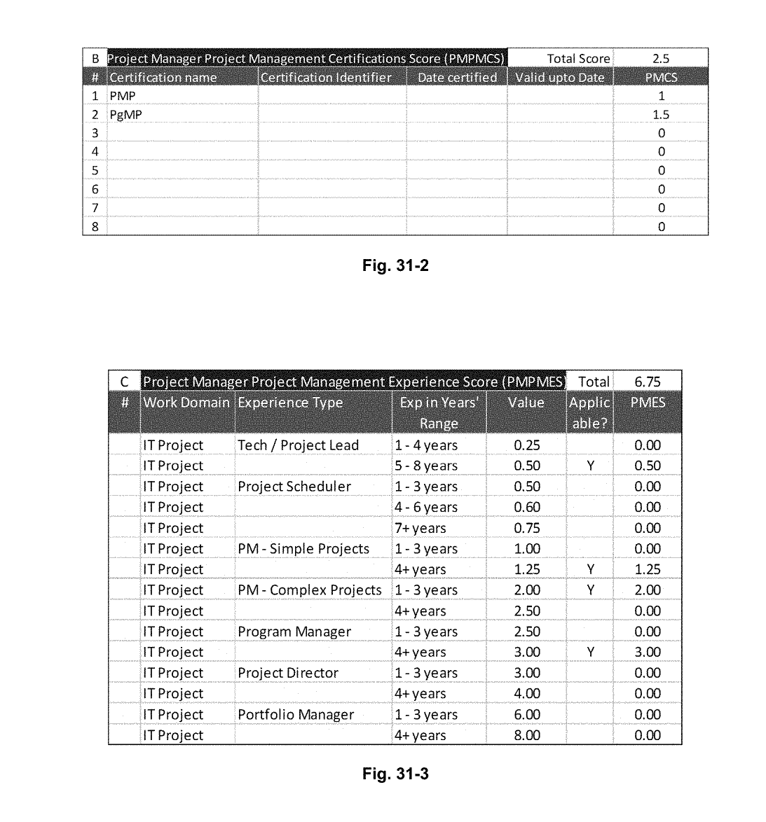

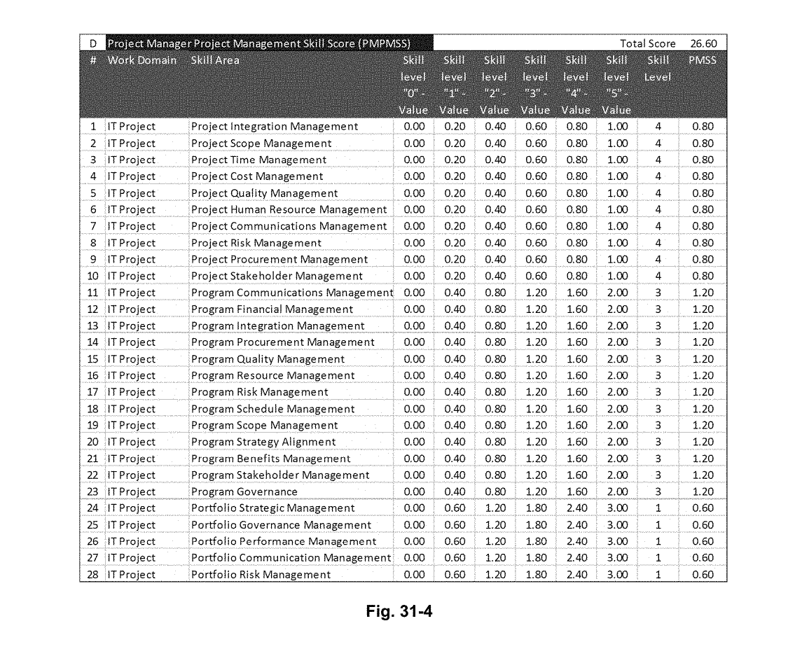

Project Manager leadership score is an indicator of the Project Manager's capabilities on the job in the Project Management skill area within the proposed Online Freelancing system. FIG. 31, FIG. 31-1A, FIG. 31-1B and FIG. 31-1C taken jointly, FIG. 31-2, FIG. 31-3, FIG. 31-4, and FIG. 31-5 may be used to calculate a Project Manager's Project Management leadership score in the proposed Online Freelancing system. FIG. 31 depicts an exemplary embodiment of the Project Manager leadership score calculator on the proposed Online Freelancing system, and may use four factors to arrive at the Project Manager leadership score such as Project Manager Contract leadership assessment score, Project Manager Project Management certifications score, Project Manager Project Management experience score, and Project Manager Project Management skills score.

FIG. 31-1 depicts an exemplary embodiment of a tool which may be used to calculate Project Manager detailed Contract leadership score. The Project Manager detailed Contract leadership score is calculated by the proposed Online Freelancing system, by multiplying scores related to the components job proposal completeness rating, Contract Team selection effectiveness rating, Contract Team leadership effectiveness rating, Product Backlog completeness (Scope Coverage) rating, release planning effectiveness rating, work Execution Management effectiveness rating, Sprint or release Governance effectiveness rating, Product Quality Management rating, Meeting Management effectiveness rating, Communication Management effectiveness rating, invoicing accuracy rating, payments accuracy rating, payments timeliness rating, product and Contract ownership rating, Contract flexibility rating, and project type weightage factor.

Job proposal completeness rating indicates the quality of job proposals submitted by Project Managers in response to a Customer job. This rating is submitted by the Customer against job proposals submitted, and this value is not shared with the respective Project Managers who have submitted the job proposals. It is measured by examining job proposal coverage on aspects such as coverage of job requirements as stated by the Customer, job proposal solutions or approaches mapping to job requirements, job requirements and solutions dependencies identification, job requirements and solutions risks identification, Job Proposal Team mapping to job requirements execution skills needed, etc.

The Contract Team selection effectiveness rating indicates the Project Manager's diligence in searching for, identifying, and engaging the right group of Freelancers with the right freelance work domain expertise, required skills and skill levels, and required work Portfolio experience to be part of the Contract Execution team, and to execute a given Contract in the manner most satisfactory to the Customer. The Contract Team selection effectiveness rating is submitted by the Customer at the end of each Contract.

The Contract Team leadership effectiveness rating indicates the Project Manager's ability and interest in driving alignment of a Contract Execution Team on a specific Contract into a collaborative, cohesive, and unified team, using team forming or norming or storming or performing techniques. Key factors or contextual elements that impact team formation includes cultural aspects tied to a country of origin, geographical location, religion, etc., education, prior work experience and working culture in previous organizations, language, operating time zone, etc. Essential techniques used to drive team formation may include Contract Execution Team vision setting, Contract Execution Team responsibility or accountability or consulting or information (RACI) Matrix definition, Contract Execution Team's team charter definition, etc.

The Product Backlog completeness (scope coverage) rating denotes the Project Manager's diligence demonstrated on developing a complete Product Backlog for a specific Contract that addresses all the required components as explicitly stated in the job as well as other necessary components that are to be implicitly understood given the right insight into the Freelance work domain, skill areas, etc. The release planning effectiveness rating specifies the Project Manager's diligence demonstrated on developing a comprehensive Contract Release Plan for a specific Contract, considering job-related attributes such as Epics, User Stories, User Story dependencies, and other qualifications which includes User Story criticality, User Story deployment urgency, User Story usage level, User Story size or complexity, etc., as well as Contract Execution Team-related attributes such as Freelancer Team availability planning, Freelancer Team capacity planning, Customer Team availability planning, etc.

The work Execution Management effectiveness rating indicates the Project Manager's perceived effectiveness in managing work execution from the Contract Execution team's perspective on a specific Contract. In order to drive effectiveness, the Project Manager may leverage the following techniques, drive daily updates of Kanban Boards and Kanban Cards in line with job execution, download available Contract execution reports, such as Sprint Burn-up or Burn-down chart, issues log, risks log, delivered defects log, etc., conduct virtual stand-up meetings with the Contract Execution team, use actions register to document and track meeting action items to closure, etc.

The Sprint or Release Governance effectiveness rating indicates the Project Manager's effectiveness in planning and performing Governance of Contract release and Contract Sprints, both from a Customer perspective as well as from a Contract Execution Team perspective on a specific Contract. The Project Manager may also plan for and execute appropriate corrective actions, such as deep-dive analysis, re-plans, etc., to recover Contracts that are moving away from the plan. The product Quality Management rating indicates the Project Manager's ability to drive quality of the products delivered to the Customer, measured by the ratio of delivered defects per Story Point. Meeting Management effectiveness rating indicates the Project Manager's effectiveness on a specific Contract in planning, scheduling and conducting Customer and or Freelancer meetings, as well as following up on and tracking to the closure of actions due that have been raised during the meetings. The Communication Management effectiveness rating indicates the Project Manager's effectiveness on a specific Contract in planning and performing Contract communications from the following perspectives communications scope or content planning, frequency of interactions, depth of planned coverage of communications, tailored to various Stakeholders and their needs and expectations, delivering to plan on the scope or content and schedule, etc.

The invoicing accuracy rating indicates the Project Manager's diligence on a specific Contract in raising Customer Sprint invoices that are consistently accurate throughout the life of the Contract. The payments accuracy rating indicates the Project Manager's diligence on a specific Contract in making payments against Freelancer Sprint invoices that are consistently accurate throughout the life of the Contract. The payments timeliness rating indicates the Project Manager's diligence on a specific Contract in making payments against Freelancer Sprint invoices that are consistently meet the “invoice payment turnaround time” metric, throughout the life of the Contract. The “invoice payment turnaround time” metric may be defined as part of the Customer Contract. The Product and Contract ownership rating specifies the Project Manager's perceived (from Customer's perspective) breadth and depth of interest, involvement, and Customer engagement on a specific Contract on developing services, deliverables, or outcomes for the Customer, covering aspects such as,

1) Does the Project Manager lead and drive the Contract execution team on a given Contract to gain insights into both stated or explicit and unstated or implicit requirements?

2) Does the Project Manager lead and drive the Contract execution team on a given Contract to think of the Customer's organizational and market context, so as to define the most complete solutions possible?

3) Does the Project Manager lead and drive the Contract execution team on a given Contract to actively collaborate with and engage the Customer team, and validate assumptions, approaches, solutions, etc., to achieve expected job outcomes in the most productive and efficient manner?

The Contract flexibility rating indicates the Project Manager's perceived (from Customer's perspective) flexibility on a specific Contract, in accommodating changes to stated job requirements, and containing impacts to the Contract terms and conditions, Contract costs, Contract schedules, etc. to a reasonable level. The project type weighting factor are scores corresponding to different Contract types applicable to the specific Contract such as Build-Operate-Transfer (BOT), project, and operations. The Project Manager Project Management certifications score is a score that provides insight into the relative acceptability of various Project Management certifications that a Project Manager may hold.

FIG. 31-2 is an exemplary embodiment of a tool which may be used to calculate the Project Manager's Project Management certifications score. It may use the Project Management certifications data that is manually submitted by the Project Manager as input. Project Manager Project Management experience score is a score that provides insight into the Project Management experience that a Project Manager holds.

FIG. 31-3 is an exemplary embodiment of a tool which may be used to calculate Project Manager's Project Management experience score. It may use the Project Management experience data that is manually submitted by the Project Manager as input. Project Manager Project Management skills score is a score that provides insight into the Project Management skills that a Project Manager has acquired by attending various training programmes, as well as by executing multiple work tasks or projects.

FIG. 31-4 is an exemplary embodiment of a tool which may be used to calculate Project Manager's Project Management skills score. It may use the Project Management skills data that is manually submitted by the Project Manager as input. FIG. 31-5 is an exemplary embodiment of a group of settings that may be used in tools embodied in FIG. 31, FIG. 31-1, FIG. 31-2, FIG. 31-3, and FIG. 31-4, to support the various calculations.

Average of Freelancer profile scores across all Freelancers or Freelance Company Consultants in a Job Proposal Team.

$$1 ) Average Freelancer Profile score = \frac{\sum ( Freelancer Profile score )}{Count of Freelancers in proposal team}$$

Freelancer performance assessment score indicates the relative level of performance, capabilities, and effectiveness of a Freelancer on the proposed Online Freelancing system. The Freelancer profile score is calculated using the input values Freelancer performance assessment score, Freelancer skills score, and Freelancer Portfolio score.

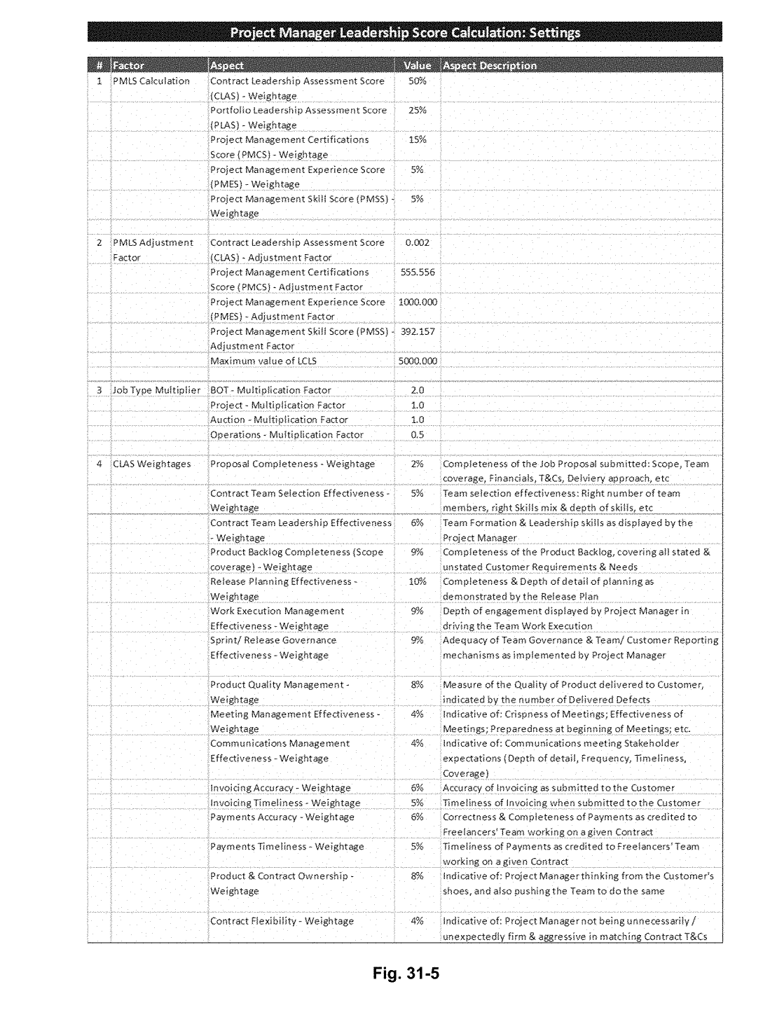

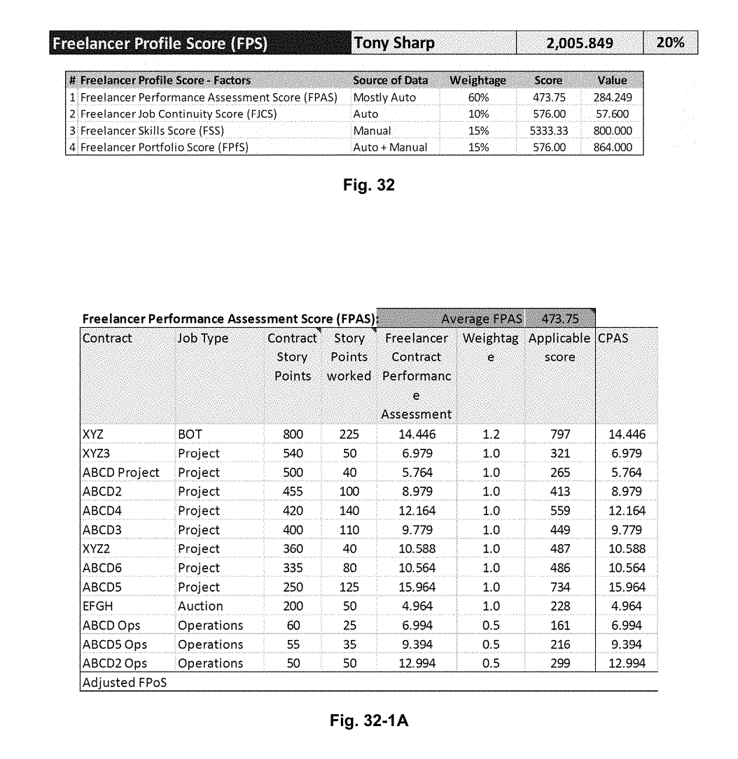

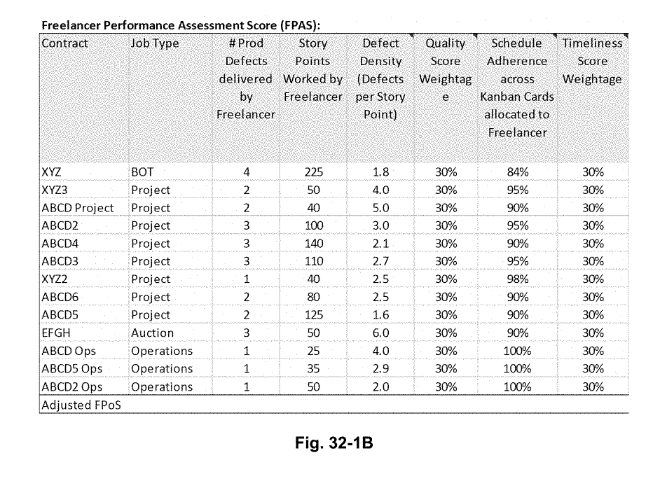

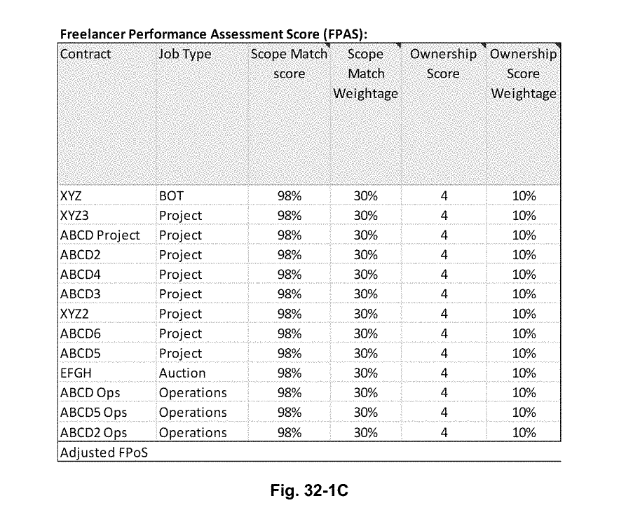

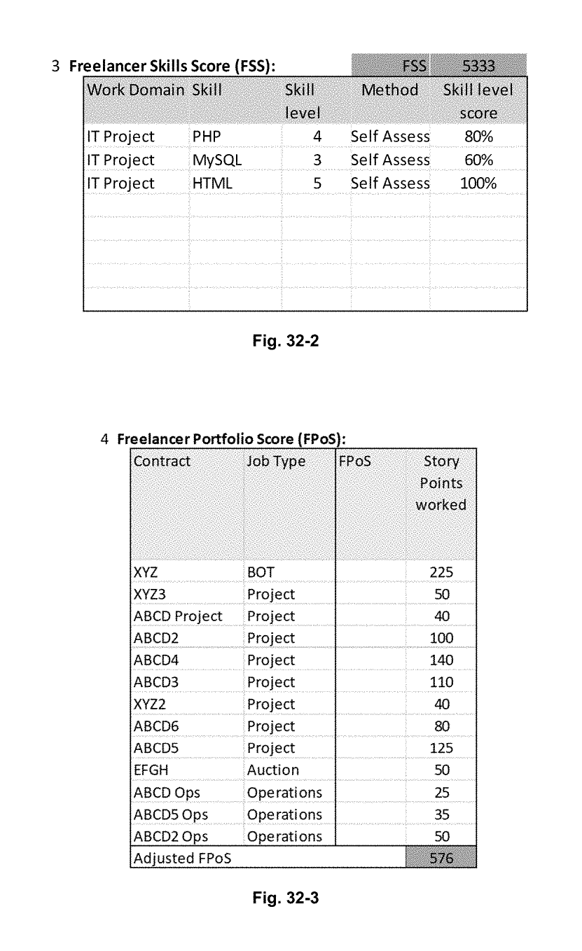

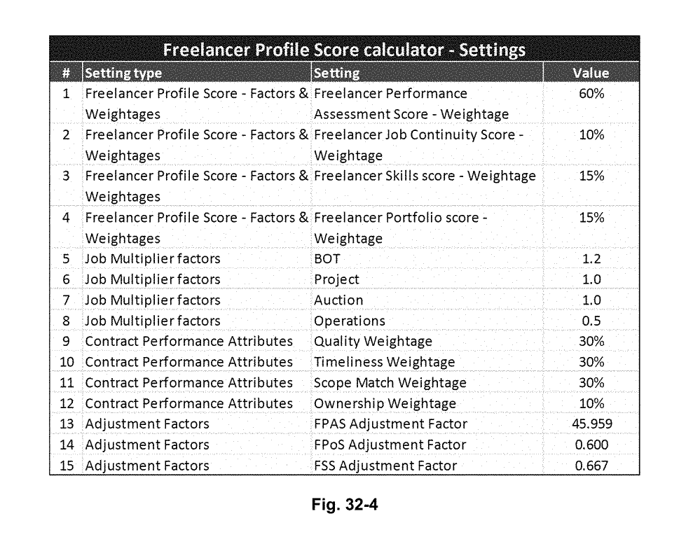

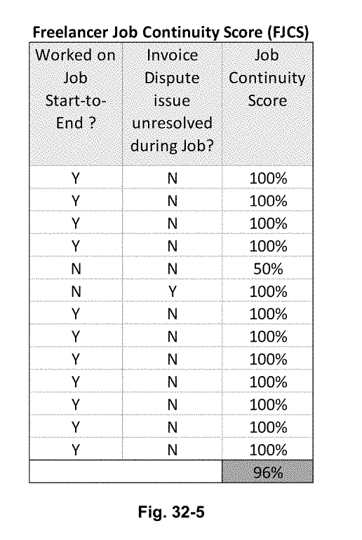

FIG. 32 is an exemplary embodiment of a tool which may be used to calculate Freelancer Performance assessment score.

FIG. 32-1A, FIG. 32-1B, and FIG. 32-1C taken jointly is an exemplary embodiment of a tool which may be used to calculate Freelancer Contract performance assessment score and indicates the Freelancer's performance on a specific Contract. Freelancer Contract performance scores across all worked jobs is aggregated and averaged to calculate the overall Freelancer performance assessment score for the Freelancer. This score is calculated using the following factors as inputs:

1) Number of delivered defects delivered by Freelancer.

2) Number of Story Points worked on by the Freelancer=Sum of Story points for the User Stories assigned to the Freelancer.

$$3 ) Defect density = \frac{Number of delivered defects}{Sum of Freelancer Story Points worked}$$

4) Quality score weightage=Weightage applied to defect density score while calculating Freelancer performance assessment score.

5) Schedule adherence=Adherence to Kanban Card plan dates across all User Stories assigned to Freelancer.

6) Timeliness score weightage=Weightage applied to schedule adherence score while calculating Freelancer performance assessment score.

7) Scope match score=Scoring for actual scope delivered vis-à-vis scope assigned to Freelancer. Measured by acceptance criteria met vs. acceptance criteria defined.

8) Scope match weightage=Weightage applied to scope match score while calculating Freelancer performance assessment score.

9) Ownership score=Manual score provided by Project Manager to Freelancer, to assess the level of perceived interest and capability displayed by Freelancer in identifying and addressing the Customer's stated and unstated needs while working on assigned User Stories in a Contract.

10) Ownership score weightage=Weightage applied to ownership score while calculating Freelancer performance assessment score.

The Freelancer skills score indicates the overall skill ownership of a Freelancer. FIG. 32-2 is an exemplary embodiment of a tool which may be used to calculate Freelancer skills score. It assesses a skill level score for each skill and skill level that the Freelancer possesses and aggregates these scores to calculate an overall Freelancer skills score. Freelancer Portfolio score quantifies the overall work Portfolio of a Freelancer, by quantifying and aggregating work experience related scores for the Freelancer.

FIG. 32-3 depicts an exemplary embodiment of a tool which may be used to calculate Freelancer Portfolio score.

FIG. 32-4 is an exemplary embodiment of a guide that is used as settings on the Freelancer profile score calculator tool.

FIG. 32-5 depicts an exemplary embodiment of a tool which may be used to calculate the propensity of a Freelancer to take a contracted job to its logical completion.

Project Manager's financial reliability score indicates the reliability of a Project Manager in paying Freelance Team members in an accurate and timely fashion. It is calculated by assessing the variance on schedule variance of payments against invoices, and accuracy of payments against invoices.

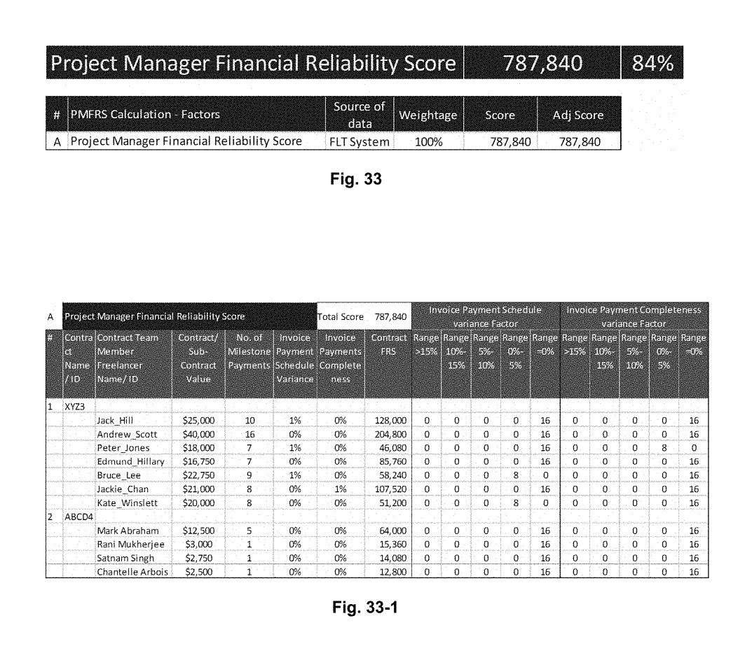

FIG. 33 depicts an exemplary embodiment of a Project Manager financial reliability calculator and uses the formula encapsulated in FIG. 33-1 to calculate the financial reliability score.

FIG. 33-1 depicts an exemplary embodiment of a detailed Project Manager financial reliability calculator. Project Manager financial reliability is measured from two perspectives, Schedule variance of Freelancer invoice payments, and completeness or accuracy of Freelancer invoice payments.

$$1 ) Schedule variance of Freelancer Sprint invoice payments = \frac{( Actual invoice payment date - invoice submission date )}{( Planned invoice payment date - invoice submission date )}$$

Where actual invoice payment date is date on which Project Manager has made a payment against a specific Freelancer invoice, invoice submission date is the date on which Freelancer has submitted the invoice to the Project Manager, and planned invoice payment date is the date on which the Project Manager is mandated by Contract to pay a specific invoice. Typically, within “x” days after “invoice submission date”, where “x” is defined in the Freelancer sub-Contract.

$$1 ) Payment accuracy or completeness of Sprint invoice payments = \frac{( Sprint Payment submitted - Sprint invoice amount )}{Sprint invoice amount}$$

Where Sprint invoice amount is the amount stated in the Freelancer's Sprint invoice submitted to the Project Manager, and Sprint Payment submitted is the amount of payment submitted by the Project Manager against a Freelancer invoice.

FIG. 33-2 depicts an exemplary embodiment of all settings on the Project Manager financial reliability calculator. Project Manager's Portfolio match with the current job. The Project Manager's Portfolio is examined critically to ensure that it matches the Customer job characteristics to a reasonable extent. Job characteristics considered for matching during this exercise are Freelance work domain, skill requirements for Project Manager and Freelancers, job size (typically calculated in Story Points, User Stories count, etc.), team size (maximum count of Freelancers excluding Project Manager), job complexity (in terms of technology complexity, system integration complexity, resource availability risk, schedule adequacy risk, etc.), job duration (in elapsed days), Contract Type (fixed price, time and materials, etc.), and the like.

The Project Managers Work Portfolios matching to Customer job may be performed using the exemplary embodiment as documented in FIG. 13. The exemplary embodiment in FIG. 13 compares the extent of matching of each Project Manager's work Portfolio to the given Customer job, comparing the average work Portfolio match score for each Project Manager, and identifying the top score as the entry for the most suitable Project Manager to manage a given Customer job. The output from this embodiment is a list of Project Managers, and their work Portfolio match scores to the current Customer job. Further matching of Project Managers to Customer job may be performed leveraging the embodiment in FIG. 13A.

Calculation of work Portfolio match score is based on FIG. 13-1A, FIG. 13-1B, and FIG. 13-1C jointly, which is an exemplary embodiment of the “Project Manager work Portfolio match for current job” template. This template works by analysing each work item record in the Project Manager's work portfolio, using the following factors for comparison, Freelance work domain, Freelancer skill requirements, job size, team size, job risk or complexity level, Contract payment type, etc. It further uses the age of the job, calculated using the number of days passed after Contract start date, to apply a weightage to the work Portfolio record score, to derive a weighted work Portfolio record score. The average of the top ten scores is used to derive an average work Portfolio match score for the specific Project Manager.

FIG. 13-2 is an exemplary embodiment of the various settings used in the Project Manager Portfolio match to Customer job template. Job Proposal Team's Portfolio match with current job requirement group assignments where the Freelancers' team members' Portfolios are examined critically to ensure that their job requirements or job requirement groups assignments match the Customer job characteristics to a good extent. Job characteristics considered for matching during this exercise are Freelance work domain, skill requirements for Freelancers, job size (typically calculated in Story Points, User Stories count, etc.), job complexity (in terms of technical complexity, system integration complexity, etc.), job duration (in elapsed days), etc.

The Freelancers' team Portfolios matching to Customer job may be performed using the exemplary embodiment as documented jointly in FIG. 14A, FIG. 14B, and FIG. 14C. This template works by comparing a certain set of attributes for each job requirement group in the published Customer job to the corresponding attributes for a work Portfolio record for the Freelancer that the job requirement group is assigned to. The attributes used in the comparison are Freelance work domain, skill requirements, job requirement group size, job complexity level, job duration, etc. The output of this template is a set of Portfolio job match scores, with a Portfolio job match score derived for each job requirement group to the work Portfolio of the Freelancer who has been allocated to a specific job requirement group. The average value of the set of all Portfolio job match scores may be used as the Freelancer Team's work Portfolio match score for the given Customer job.

FIG. 14-1 is an exemplary embodiment of the various settings used in the Freelancers' team Portfolios match to Customer job template.

The Customer may examine in detail each individual integrated job proposal and the corresponding Job Proposal Team, to compare and identify the best possible fit for the Customer's needs and the job's demands. If the Customer prefers to refine the settings on the “job proposals prioritization slider”, he or she may perform this, and then view an updated list of system-prioritized list of integrated job proposals submitted by competing Project Managers. The Customer may then finalize and award the job to the Project Manager who has submitted the winning job proposal. The Customer may also provide job proposal quality ratings for all the job proposals submitted, to the respective Project Managers. This data, however, may be directly submitted into the proposed Online Freelancing system, and may not be visible to or accessible by any of the Project Managers. This data may be used by the proposed Online Freelancing system during Project Manager leadership score calculations, to calculate the “job proposal completeness rating” field for each Project Manager.

The awarded Project Manager at this point perform the actions such as develop Freelancer sub-Contracts for each individual Freelancer in the job proposal Virtual Team, share the Freelancer sub-Contracts with each respective Freelancer for their reviews, conduct sub-Contract review virtual meetings with respective individual Freelancers as needed, develop the Customer Contract, incorporate any relevant review comments from job proposal Virtual Team Freelancers into the Customer Contract as well as into the respective Freelancer sub-Contract, submit the Customer Contract to the Customer for review and signature.

The Customer perform the actions such as review the Customer Contract received from the Project Manager, identify any critical areas of concern, conduct a Contract review virtual meeting with the Project Manager, request the Project Manager to facilitate a Contract solution review virtual meeting with the Project Manager and the job proposal Virtual Team, if required, request the Project Manager for revisions of the Customer Contract, based on findings and outcomes from the Contract review virtual meeting and or the Contract solution review virtual meeting.

The Project Manager may perform the following actions at this time, conduct Contract review virtual meeting on invitation from the Customer, document findings or outcomes and share with meeting attendees, schedule and conduct Contract solution review Virtual meeting with Customer and job proposal Virtual Team, document findings or outcomes and share with meeting attendees, update the Customer Contract appropriately, re-submit to Customer for review, repeat until Customer signature has been received on the Customer Contract, Project Manager to sign the Customer Contract, After the Customer Contract has been signed by the Customer and the Project Manager, issue Freelancer sub-Contracts to the job proposal Virtual Team for their signatures, Project Manager to sign Freelancer Sub-Contracts.

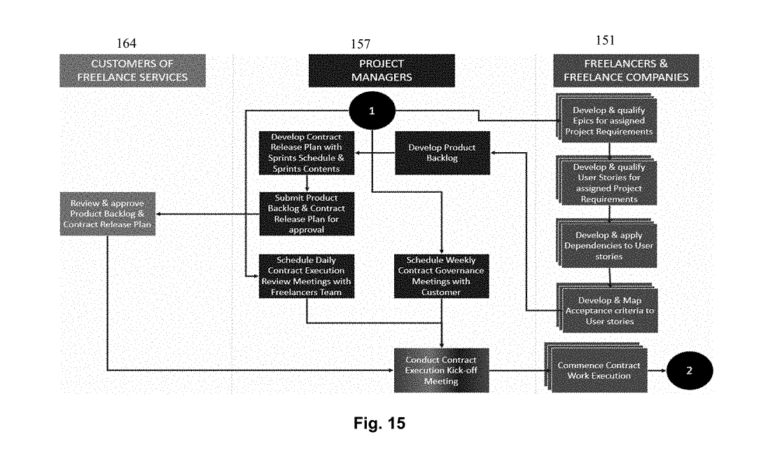

FIG. 15 may depict an embodiment of the Freelance Project Contract Execution Planning flow and corresponds to workflow component 807 in FIG. 8. The significant activities or functions in the Contract execution Planning workflow on the proposed Online Freelancing system are as follows. Freelancers 151 in the job proposal Virtual Team (called the Contract execution team after the Contract signing milestone) may perform the actions like define Epics for the assigned job requirement groups or job requirements and estimate the number of User Stories for each Epic determined 152. The template depicted in the exemplary embodiment in FIG. 19 may be used to document Epics. The key information documented is Epic name and Epic description. The Epic is also qualified at this time, on aspects such as Epic criticality level, Epic urgency of deployment level, Epic usage level, etc. decompose defined Epics into User Stories 153. The key information documented here include Epic ID or name, User Story ID or name, User Story description, size in Story Points. The User Stories defined may be analysed for dependencies, and these dependencies may be qualified 154. The User Stories may also be qualified on the basis of attributes such as User Story type, User Story criticality level, the urgency of User Story deployment level, User Story usage level, User Story size category. Acceptance criteria may be defined against the User Stories 155, based on acceptance criteria defined by the Customer for job requirement groups and job requirements.

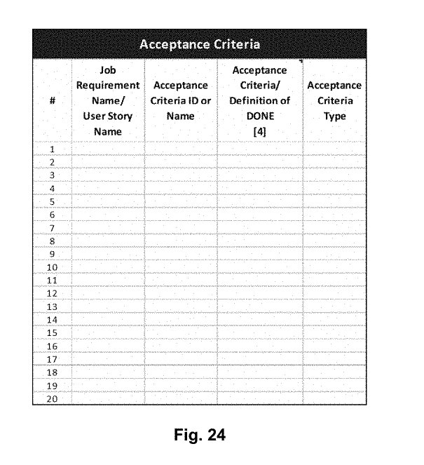

FIG. 24 may be used to depict an exemplary embodiment of a template to document and qualify acceptance criteria. Acceptance criteria list may include the information elements like job requirement name, to test or validate job requirements, in case of Customer job requirements being published as part of a Customer job, User Story name to test or validate User Stories, in case of a Customer Contract being developed as part of Contract execution planning, acceptance criteria ID or name being developed to test or validate a specific job requirement or User Story, acceptance criteria description or definition of DONE which is the description of named acceptance criteria name or ID, acceptance criteria type categorized as functional, non-functional, etc., decomposition of User Stories into Features. The Features may consist of individual atomic-level functions which when combined will form the User Story.

The Project Manager may, at this time, perform the actions such as create the Contract Product Backlog, compiling all Epics and User Stories. FIG. 21 may be used as an exemplary embodiment of a template for the Contract Product Backlog, and may include the information elements like Sprint ID or name which indicates name or identifier of Sprints in the Contract, User Story ID or name that includes name or identifier of the User Stories included in each Sprint, delivered defect ID with identifier of delivered defects involved in each Sprint, acceptance criteria or definition of DONE which is the acceptance criteria, that is, the set of tests or validations that may be used to check the state of completion or achievement of expected outcomes for each documented User Story or delivered defect as specified earlier.

Further, criticality of User Story to the Contract or release, urgency of deployment with the time needed to Return on Investment for each User Story, User Story usage level with the frequency of usage of the functionality identified in each User Story, size of the User Story as captured in Story Points, upstream dependencies that refers to names of User Stories that are upstream dependencies to the specified User Story. Generate Contract critical path diagram using Epics, User Stories, and addictions, sequence Product Backlog based on the critical path diagram, and prioritizing User Stories using User Story criticality, User Story urgency of deployment, User Story usage level, generate maximum Sprint size by adding availability data for each Freelancer during each Sprint cycle, define Sprints by compiling User Stories such that Total Sprint size does not exceed maximum Sprint size, create Contract Release Plan by compiling and sequencing all Sprints. The execution of a Contract shall be implemented in line with the Customer-approved Contract Release Plan. Conduct Contract Execution Team meeting to review Contract Release Plan and refine Contract Release Plan as necessary. Submit Contract Product Backlog and Contract Release Plan to Customer.

At this time, the Customer may perform the activities such as review the Contract Product Backlog and Contract Release Plan, identify any areas of concern. Subsequently, the Project Manager may perform the activities such as incorporate any Customer review comments into the Contract Product Backlog and Contract Release Plan, repeat this step until all Customer review comments have been incorporated. The Customer may, at this time, review and sign off on the Contract Product Backlog and the Contract Release Plan. Subsequently, the Project Manager may set up Kanban Boards for each Epic defined. A Kanban Board is a Board that is displayed on the screen of each User who is authorized to view the Kanban Boards for a given Contract.

FIG. 25 depicts an exemplary embodiment of a Kanban Board. A Kanban Board may contain one Epic per Kanban Board, User Stories in rows where each User Story in the Epic is depicted as a row in the Kanban Board. Each such row is called a “User Story Virtual Swim-lane” or “Swim-lane” in short, and each such Swim-lane contains multiple Kanban Cards in different statuses. A Swim-lane is a virtual representation and is not visible on the Kanban Board. Features as Kanban Cards in which each Feature under a User Story is represented using a Kanban Card.

FIG. 26 depicts an exemplary embodiment of a Kanban Card. A Kanban Card may contain the information fields like User Story name or ID, Feature name or ID, Kanban Card RAG status which is Red or Amber or Green overall status of Feature delivery status. Kanban Card Assignment details consists of User ID assigned to, assigned date, Kanban Card execution plan or actual start and end dates, status of delivery of the associated Feature that has analysis status, development status, development test or validation status, and integration status, related issues and risks, related delivered defects, Kanban Card assignment history, etc.

Kanban Card statuses have columns in which each Kanban Card status is represented as a column in the Kanban Board, and each column corresponds to a specific status of Kanban Cards. The regular columns in a Kanban Board may include yet to start, in progress, on hold and completed. The yet to start is when the work execution had not started yet to start on the Feature corresponding to the respective Kanban Card. The work execution in process on the Feature corresponding to the respective Kanban Card is referred as in progress. The on hold is the work execution on hold on the Feature corresponding to the respective Kanban Card. The work execution has been completed on the Feature corresponding to the respective Kanban Card is called Completed. The Kanban Cards may be assigned to the appropriate Freelancer for execution. All Kanban Cards may initially be parked in the “yet to start” column in the Kanban Board. Daily Contract execution team meetings may be scheduled, inviting the Contract Execution Team (also called the job proposal Virtual Team). Discuss with Customer and agree on frequency and timing of Contract Governance meetings. Contract Governance meetings may be scheduled with Customer at agreed frequency. Project kick-off meetings may be scheduled and conducted with participation from the Customer and the Contract Execution Team. The artefacts may be reviewed during this meeting Contract Release Plan, Contract Kanban Boards and Kanban Cards, Contract Governance meeting schedule, Contract execution team meeting schedule, etc.

FIG. 16 may depict an embodiment of the Freelance Project Sprint Execution flow and corresponds to workflow component 809 in FIG. 8. The following activities may be performed during this workflow. The Project Manager 168 may initiate the Sprint by conducting a Sprint kick-off meeting 172, with participation from the Customer and the Contract Execution team. The agenda of the Sprint kick-off meeting may include User Stories assigned to the current Sprint, from the Contract Release Plan, Contract Kanban Boards for the current Sprint, etc. Freelancers from the Contract Execution team may perform the following activities on a daily basis during the Sprint cycle, till their artefacts have been delivered to the Customer 173 and accepted by the Customer 182 such as pick up Kanban Cards related to the Features and User Stories assigned to each Freelancer 177, perform work as per the objectives documented in the picked-up User Stories and Features. If the Project Manager allocates all or part of any new Customer change requests to a Freelancer for analysis, then perform required impact analysis and develop impact analysis artefact that includes solution approach, changes needed to existing Epics or User Stories, qualification for User Stories, new Epics and User Stories needed, qualification for User Stories, key dependencies and qualification, key risks and qualification, cost estimate, delivery schedule, etc. If any issue is encountered, then the issue may be documented in the issue log.

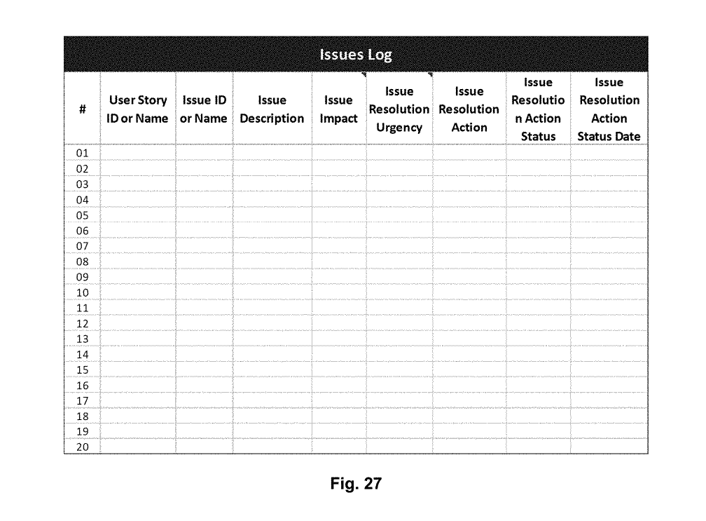

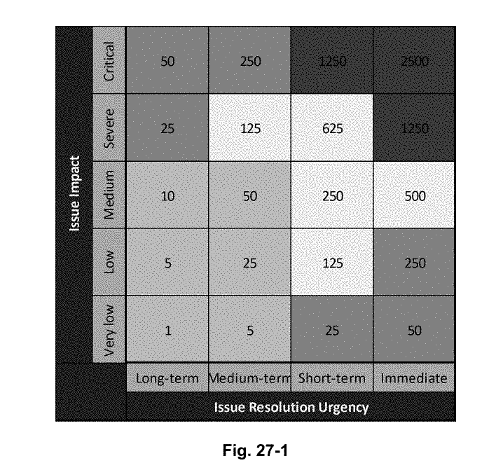

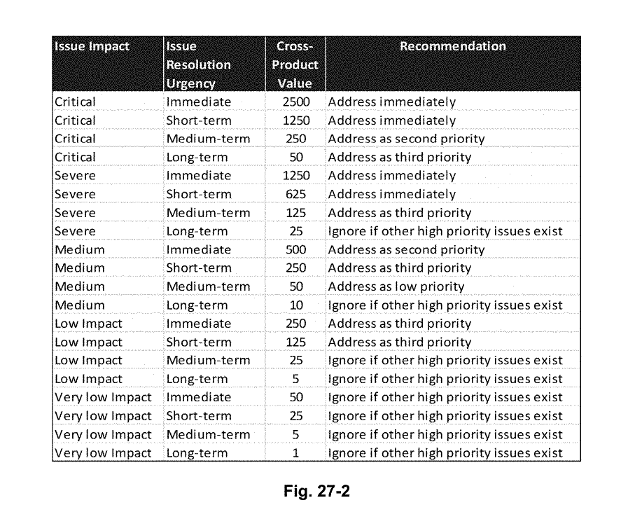

Use FIG. 27 as the exemplary embodiment of a template to document the issue and may include the information elements such as related User Story ID or name, issue ID or name, description, issue impact that indicates the level of influence of the issue. Possible values may include critical, severe, medium, low impact, and very low impact. Critical is when the issue brings the potential to break or impact the entire job, multiple Sprints in the Contract Release Plan, etc. Severe is when the issue carries the potential to break or impact a job requirement group in a job, an entire Sprint, etc. Medium is when the issue carries the potential to break or impact multiple job requirements in a job, multiple User Stories within a Sprint, etc. Low impact is while the issue carries the potential to break or impact a job requirement in a job, a User Story in a Sprint, etc. The very low impact is when the issue carries the potential to introduce a negligible impact on a Feature, etc.

Issue resolution urgency indicates the time available to resolve the issue before the issue impacts the User Story, Sprint or Release. Possible values are immediate, short-term, medium-term, or long-term. The immediate issue should be resolved within a business day, or within twelve hours, etc., so as not to have the issue impact the job. The short-term should be resolved within two business days, or within forty-eight hours, etc., so as not to have the issue impact the job. The medium-term issue should be resolved within the Sprint duration, so as not to have the issue impact the job or Sprint. The long-term issue resolution may spill over to span multiple Sprints, without the issue significantly impacting the job or Sprint.

Issue resolution action is the action to be defined and executed to resolve the impact of the documented issue. Issue resolution action status is the execution status of the issue resolution action and the possible values include yet to be defined, yet to start, in progress, on hold and completed. Issue resolution action status is the date on which the specified action status was achieved. The issue resolution actions are defined, and the issue is updated in the corresponding Kanban Card. If any risk is identified, then document the risk in the risk log and qualify the risk appropriately. The risk mitigation actions are defined and the risk is updated in the corresponding Kanban Card. When a User Story artefact has been developed, the Freelancer may deliver it to the Project Manager for integration if required, and for its subsequent delivery to the Customer. If the Project Manager returns a Sprint artefact to the Freelancer, then the Freelancer may work on the artefact to address any defects identified and re-submit the artefact to the Project Manager.

Review delivered defects raised by the Customer and assigned to the Freelancer by the Project Manager, perform impact analysis, perform work to resolve the defect and deliver updated artefacts as necessary to the Project Manager. Update the status of execution of work performed in the Kanban Card on a daily basis, ahead of the daily Contract Execution Team meeting. The daily Contract Execution Team meeting is attended, open dependencies are identified, raised if any help is needed. Collaborate with Contract Execution Team to address open issues and risks, as well as for the execution of work. The Project Manager may perform the activities during the Sprint cycle, till all Sprint artefacts have been delivered to the Customer and accepted by the Customer such as review Freelancer deliverable artefacts, and identify defects if any, If defects exist, return the artefact to the Freelancer, Integrate User Story artefacts if needed, Deliver User Story deliverables to the Customer for validation or testing and acceptance, If the Customer raises a defect in a User Story deliverable, then add the Delivered defect to the Contract Product Backlog.

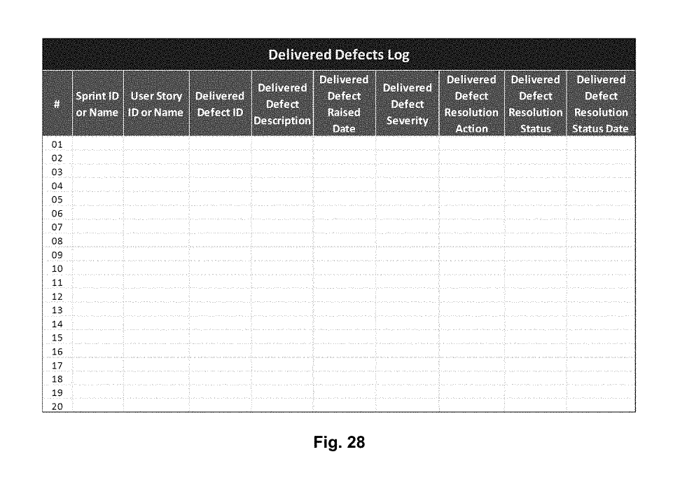

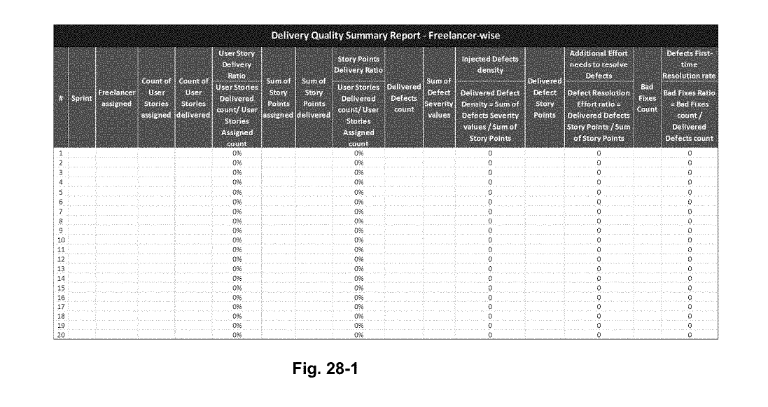

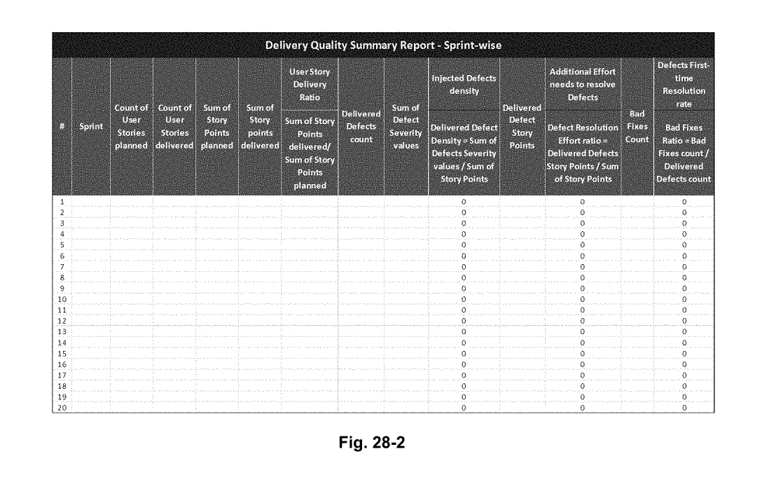

FIG. 28 may be used as an exemplary embodiment of a template to capture delivered defects. A delivered defect within the proposed Online Freelancing system may obtain information such as Sprint ID or Name, User Story ID or name, delivered defect ID—which is a system-generated sequence number, delivered defect description, delivered defect raised date, which is the date on which the defect was raised in the system, etc. Analyse the delivered defect, based on the following factors, delivered defect severity indicating the level of impact on the job artefacts and possible values may include critical, severe, medium, low, and very low impact. The value is crucial if a User Story is missed, breaks a User Story, etc. No workaround exists to bypass the problem and proceed with job functionality achievement. Severe is a missed User Story, breaks a User Story, etc. However, a workaround exists to bypass the problem and proceed with job functionality achievement. Medium is missed multiple features within a User Story. Low is missed single Feature within a User Story. The very low impact is a negligible impact at a Feature level, may be safely ignored.

Appropriate defect resolution action plans are defined, and the information may be documented are delivered defect resolution action which is defined to address the delivered defect, delivered defect resolution action status refers to status of execution of the delivered defect resolution action and delivered defect resolution action status date on which the delivered defect resolution action status was achieved, etc. Add the delivered defect to the Contract Release Plan. Create a Kanban Card to be added to the appropriate User Story Swim-lane, assign Kanban Card to the appropriate Freelancer, set Kanban Card status to “yet to start”. If the Customer raises a change request to an Epic or User Story, then assign the change request to the Freelancer(s) best suited to work on the change request (based on skills, skill levels, and availability or bandwidth). After the Freelancer(s) reverts with the impact analysis, which may include the following information, solution approach, new Epics and User Stories needed, changes needed to existing Epics or User Stories, cost estimate, dependencies, risks, delivery schedule, etc. Deliver the updated change request with the additional information on impact analysis to the Customer for review and approval. After the Customer approves the change request and impacts analysis, add the change request and impact analysis to the Contract Product Backlog, instruct Freelancers to update the impacted Epics and User Stories appropriately, schedule a Contract Execution Team meeting to review the change request and effects analysis if needed, etc. After Freelancers make requisite changes add any updated and new Epics and User Stories to the Contract Product Backlog, re-prioritize Contract Product Backlog, generate updated Contract Release Plan, etc.

Create or update Kanban Cards to be added to the appropriate User Story Swim-lanes. Assign Kanban Cards to the suitable Freelancers. Set Kanban Cards status to “Yet to start”. Generate Contract Execution Team reports Sprint Burn-up or Burn-down chart, issues log, risks Log, delivered defects Log, Contract Release Plan vs. status report, and Contract delivery quality summary report which is Freelancer-wise which are as detailed further.

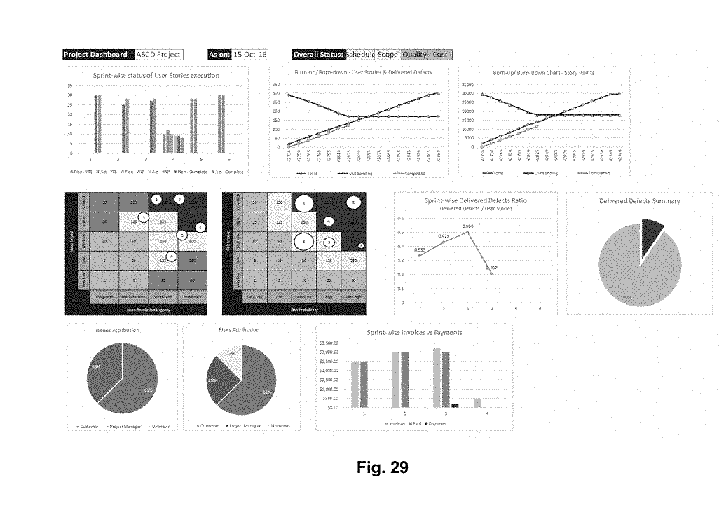

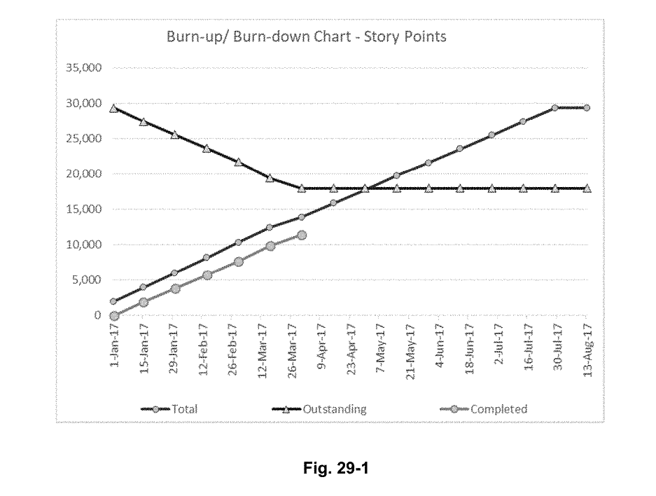

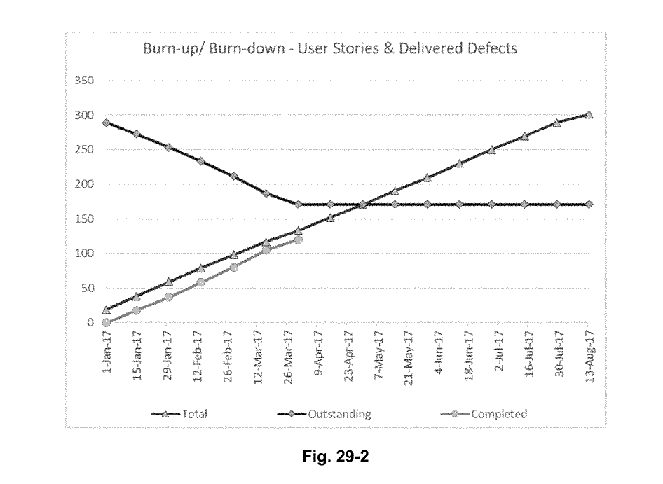

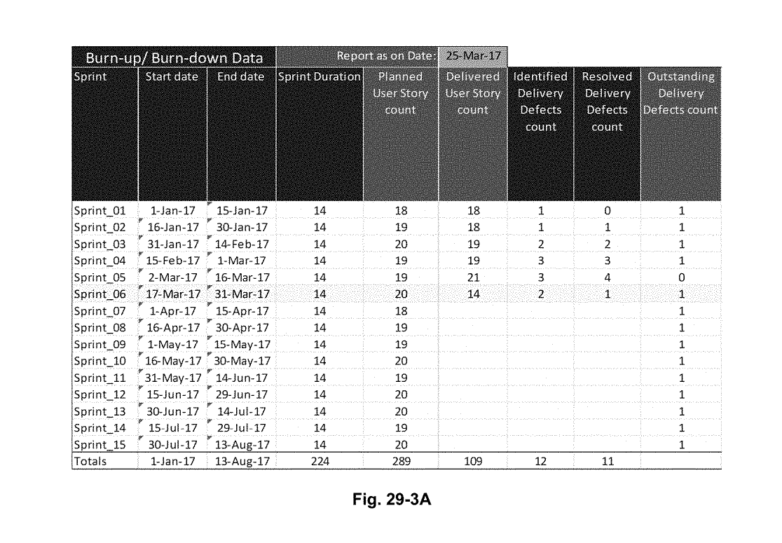

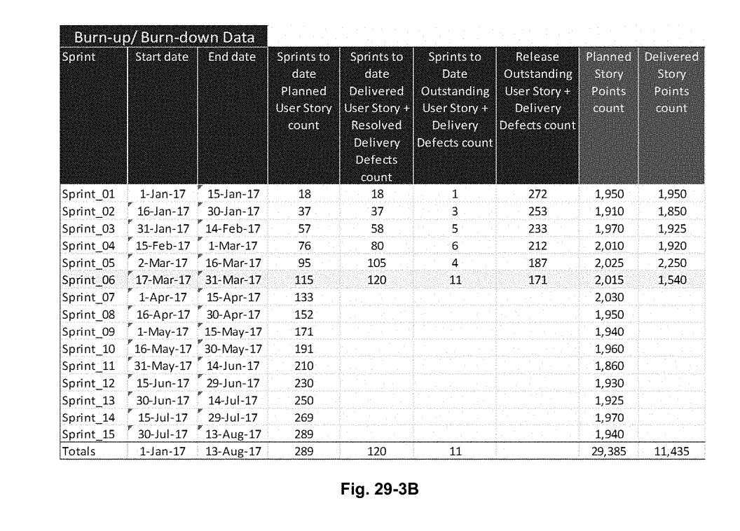

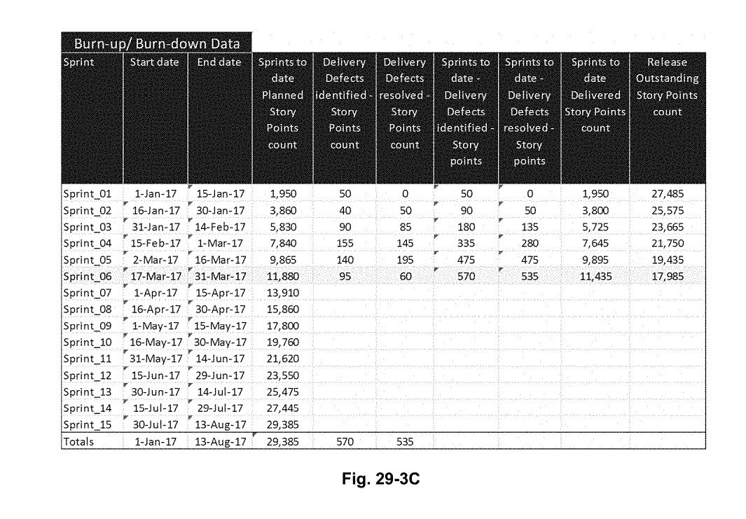

The Sprint Burn-up or Burn-down chart may be used to assess the actual velocity of execution of User Stories as compared to the planned velocity. FIG. 29-1 may be used as an exemplary embodiment of a template for reporting Sprint Burn-up or Burn-down charts depicted based on the progression of Story Points. The chart plots the planned vs. completed vs. outstanding status of completion of work in a given Sprint, where progress is depicted based on Story Points delivered vs. outstanding.

FIG. 29-2 depicts an exemplary embodiment of a template for reporting Sprint Burn-up or Burn-down charts depicted based on the progression of counts of User Stories and Delivered Defects, in the absence of available Story Points data. The chart plots the planned vs. completed vs. outstanding status of completion of work in a given Sprint, where progress is depicted based on User Stories and delivered defects, delivered to the Customer vs. outstanding.

FIG. 29-3A, FIG. 29-3B, and FIG. 29-3C may be used to collect Sprint Burn-up or Burn-down data.

The issues log may be used to document and monitor Issues that have been identified during Contract execution, qualify the issues, define issue resolution actions and track to closure, manage and track issues, their qualification, and status, etc. FIG. 27 may be used as a template for the issues log.

The risks log may be used to document and monitor risks that have been identified ahead of and during Contract execution, qualify the risks, define risk mitigation actions and track to closure, manage and track risks, their qualification, and status, etc. FIG. 12 may be used as an exemplary embodiment for a template for the risks log.

The delivered defects log may be used to track and report delivered defects raised by Customers after they test or validate products or artefacts delivered to them. FIG. 28 may be used as a template for the delivered defects log.

The Contract Release Plan vs. status report may be used to track Sprints in a Contract release. The list of User Stories and delivered defects scheduled in each Sprint. The status of each such work item, etc. FIG. 23 may be used as a template for the Contract Release Plan vs. status report.

The Contract delivery quality summary, a Freelancer-wise report may be used to assess the quality of performance or delivery of each Freelancer within the Contract Execution Team. This assessed quality shall be used by the Project Manager to monitor and guide the delivery and productivity of Freelancers in the team, and thus improve their delivery quality over time. This assessed quality shall also be an automated input into the Sprint-level Freelancer performance assessment exercise, where a part of the performance assessment is submitted automatically by the system.

FIG. 28-1 may be used as the exemplary embodiment of a template to report Contract delivery quality summary on a Freelancer-wise basis, and may include the information elements such as Sprint, Freelancer name, count of User Stories assigned, count of User Stories delivered, User Story delivery ratio, sum of Story Points assigned, sum of Story Points delivered, Story Points delivery ratio, delivered defects count, sum of delivered defect severity values (indicates total delivered defect severity value by Freelancer in Sprint), sum of delivered defect severity values (indicates total delivered defect severity value by Freelancer in Sprint), delivered defect Story Points are Story Points related to delivered defects injected by Freelancer in Sprint, bad fixes count, bad fixes ratio, etc. The bad fixes count is a number of defects which were resolved and resubmitted, only to be returned by the Customer as failed after next round of acceptance test or validation cycle.

$$1 ) User Story Deliver ratio = \frac{User Stories Delivered}{User Stories Assigned}$$

$$2 \text{)} Story Points Delivery ratio = \frac{Story Point Delivered}{Story Points Assigned}$$

$$3 \text{)} Injected Defects Density = \frac{Sum of Defect Severity Values}{Sum of Story Points}$$

$$4 \text{)} Defect Resolution Effort Ratio = \frac{Delivered Defect Story Points}{Sum of Story Points}$$

$$5 \text{)} Bad Fixes Ratio = \frac{Bad Fixes Count}{Delivered Defects Count} .$$

The Contract Execution Team reports are analysed, in order to identify due and overdue Kanban Cards, identify open issues, identify open dependencies, identify open risks, identify delayed delivered defects, identify persisting Freelancer performance issues, identify persisting Freelancer quality issues, etc. Conduct daily Contract Execution Team meetings using the Contract Execution Team reports as the basis, and perform the actions such as track the status of due and overdue Kanban Cards, track any open issues to closure, track to closure any open dependencies, manage any open risks, track delayed delivered defects to closure, etc. Conduct one-on-one virtual meetings with specific Freelancers as needed, to address any of the following, persisting Freelancer performance or availability issues, persisting Freelancer quality issues, etc. Generate Contract financial reconciliation transactions report, to assess the status of various invoices and payments within the Contract.

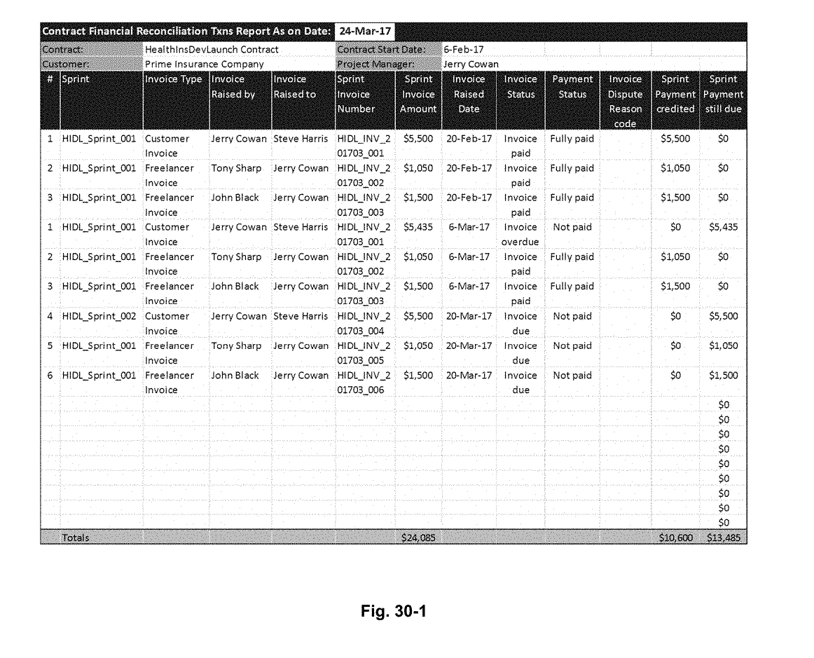

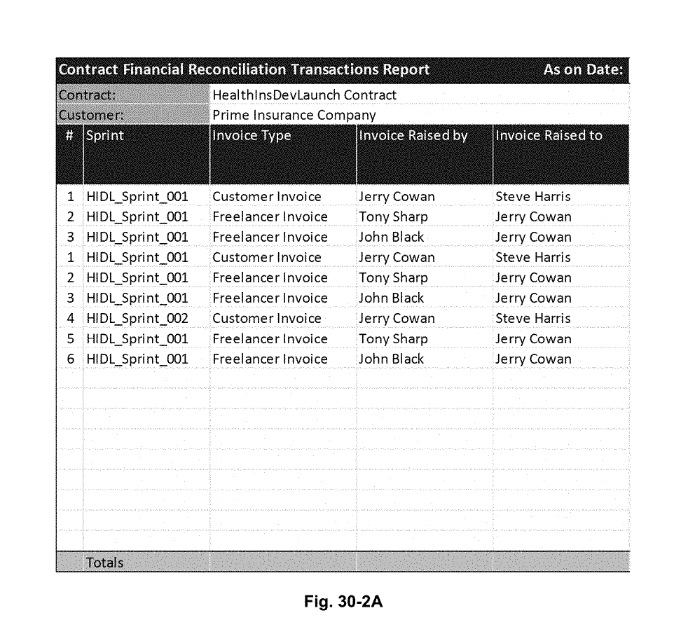

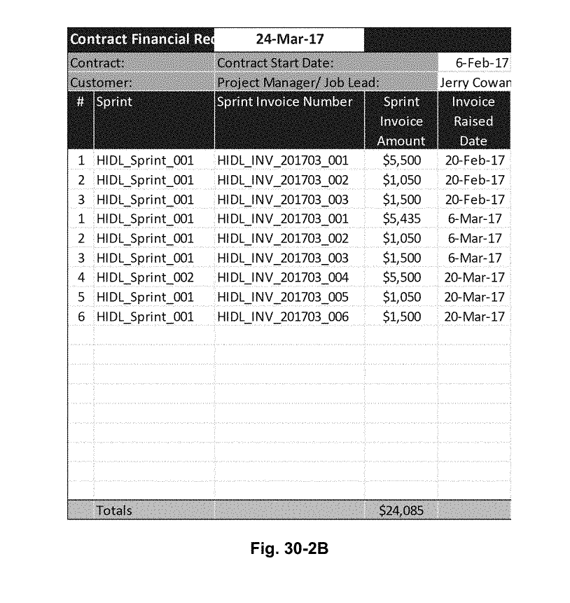

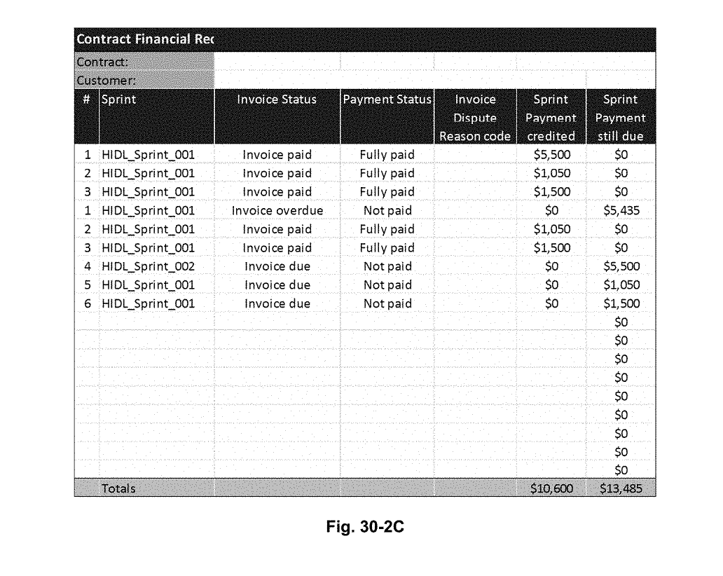

FIG. 30-1 depicts an exemplary embodiment of the Contract financial reconciliation transactions report. The report includes the information elements like Sprint invoice type with possible values may include Customer invoice or Freelancer invoice, invoice raised by indicating the person who has raised the invoice, invoice raised to with the recipient of the invoice, invoice number which is an invoice unique identifier, invoice amount, invoice raised date, invoice status consisting of status of posting or payment of the invoice. The possible values of the invoice status include invoice posted on which the invoice has been submitted to the recipient, invoice due having invoice payment is due, or current date is “x” days away from the invoice payment due date. Here, “x” is defined within the Contract. Additionally, invoice paid as to when invoice payment has been credited by the recipient to the Service Provider, invoice overdue indicating invoice payment is overdue, and “y” days have passed after the invoice payment due date, “y” is defined within the Contract, invoice in red with the invoice payment is significantly overdue, and “z” days have passed after the invoice payment due date. Potential to move to collection agents, “z” is defined within the Contract, invoice disputed with the invoice been disputed by the recipient. Status of payment of the invoice and possible values of this field may include fully paid referring to the invoice amount has been fully settled by the recipient, partially paid if the invoice amount has been only partially settled by the recipient, and the remainder stands still due to the Service Provider. In this scenario, the invoice status would be set to “invoice due”, “invoice overdue”, “invoice in red”, etc. as appropriate. Further, not paid if the invoice amount has not been paid by the recipient, and the entire invoice amount stands due to the Service Provider, invoice dispute reason code, if the invoice has been disputed by the recipient, then the dispute reason code may be captured here. The values possible in the dispute reason code include invoice amount incorrect, service delivery quality inadequate, and service delivery delayed. The invoice recipient is disputing the invoice, giving the reason as “invoice amount is incorrect” refers to the value invoice amount incorrect. The value of service delivery quality inadequate is if the invoice recipient is disputing the invoice, giving the reason as “service delivery quality inadequate”, possibly because the Sprint was delivered with too many defects, and the planned scope has not been delivered. The invoice recipient is disputing the invoice, giving the reason as “service delivery delayed”, possibly because the Sprint was delivered in a significantly delayed fashion is called service delivery delayed. Generate Contract financial reconciliation report, to assess the summary status of various invoices and payments within the Contract.

FIG. 30-2A, FIG. 30-2B, and FIG. 30-2C jointly depict an exemplary embodiment of the Contract financial reconciliation report. The report includes the information elements such as Sprint, incoming payments details, outgoing payments details, and net invoices and payments. The Sprint for which the summary record row has been generated. The incoming payments details consist of the amount invoiced, amount paid, amount disputed, the amount due, amount overdue, and the amount in red. The outgoing payments details are amount invoiced, the amount paid, amount disputed, amount due, amount overdue, and the amount in red. The net invoices and payments and incoming payments and outgoing payments with amount invoiced, amount paid, amount disputed, amount due, amount overdue, and an amount in red.

Generate Contract Governance reports, such as Contract Release Plan vs. status, issues heat map, risks heat map, Contract delivery quality summary Sprint-wise report. The Contract Release Plan vs. status report may be used to track Sprints in a Contract release. The list of User Stories and delivered defects scheduled in each Sprint. The status of each such work item, etc. FIG. 23 may be used as a template for the Contract Release Plan vs. status report. The issues heat map may be used to present a visual representation of the issues log while providing emphasis on higher impact or more urgent issues, so that a viewer can very quickly identify the problem areas to put immediate focus on, and so that the Customer and Project Manager can jointly attack any concerns before they start impacting the Contract delivery and its timeliness or quality.

FIG. 27-1 may be used as a template to depict the issue heat map. FIG. 27-2 may be used as a guide for positioning of issue heat map elements. The risks heat map may be used to present a visual representation of the risks log while providing emphasis on higher probability or higher impact or more urgent risks, so that a viewer can very quickly identify the problem areas to put immediate focus on, and so that the Customer and Project Manager can jointly attack any concerns before they start impacting the Contract delivery and its timeliness or quality. FIG. 12-1 may be used as an exemplary embodiment for a template to depict the risk heat map. FIG. 12-2 may be used as an exemplary embodiment for a guide for positioning of risk heat map elements. FIG. 12-3 may be used as an exemplary embodiment for a guide for sizing of risk heat map bubbles. The Contract delivery quality summary—Sprint-wise report may be used to assess the quality of performance or delivery in each Sprint within the Contract. This assessed quality shall be used by the Project Manager to monitor and guide the delivery and effectiveness of Sprints, so as to meet and exceed Contractual expectations.

FIG. 28-2 may be used as an exemplary embodiment of a template to depict the Contract delivery quality summary—Sprint-wise report, and may include the information elements like Sprint ID or name, count of User Stories planned, count of User Stories delivered, sum of Story Points planned, sum of Story Points delivered, User Story delivery ratio, delivered defects count, sum of delivered defect severity values (indicates total delivered defect severity value by Freelancer in Sprint), injected defect density, delivered defect Story Points (Story Points related to delivered defects injected by Freelancer in Sprint), bad fixes count (number of defects which were resolved and resubmitted, only to be returned by the Customer as failed after next round of acceptance test or validation cycle), defect resolution effort ratio, bad fixes ratio, etc. where,

$$1 ) User Story Deliver Ratio = \frac{Sum of Story Points delivered}{Sum of Story Points planned}$$

$$2 \text{)} Injected Defects Density = \frac{Sum of Defect Severity values}{Sum of Story Points}$$

$$3 \text{)} Defect Resolution Effort Ratio = \frac{Delivered Defect Story Points}{Sum of Story Points}$$

$$4 \text{)} Bad Fixes Ratio = \frac{Bad Fixes Count}{Delivered Defects Count}$$

The Contract Governance reports are analysed in order to collect Sprint Plan vs. status, identify significant open issues that need Customer action or awareness, identify significant open risks that need Customer action or awareness, identify major open dependencies that need Customer action or awareness, etc. Conduct Contract Governance meetings with participation from the Customer, using Contract Governance reports as the basis, and perform the following actions, Report Sprint Plan vs. status, report any significant delays or potential significant delays, and corrective actions being taken or planned to address the challenge, report any significant open issues that need Customer action, report any significant open risks that need Customer action, report any major open dependencies that need Customer action, etc.

FIG. 29 may be used as an exemplary embodiment of the project dashboard, used as inputs to the daily virtual stand-up meetings, and comprises of the various analyses performed and described previously.

The Customer may perform the activities during the Sprint cycle such as Validate or Test Sprint deliverables submitted by the Project Manager, raise delivered defects in case of defects being identified during validation or testing, Raise change requests to Project Manager if changes are needed to the business process flow or solution approach as documented in the Epics or User Stories, provide delivery support to the Contract Execution Team in terms of support on open dependencies, issues and risks, etc., attend Contract Governance meetings with the Project Manager, etc.

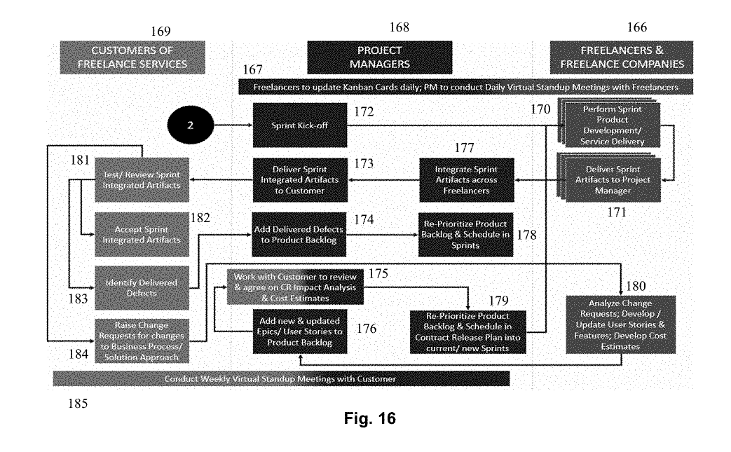

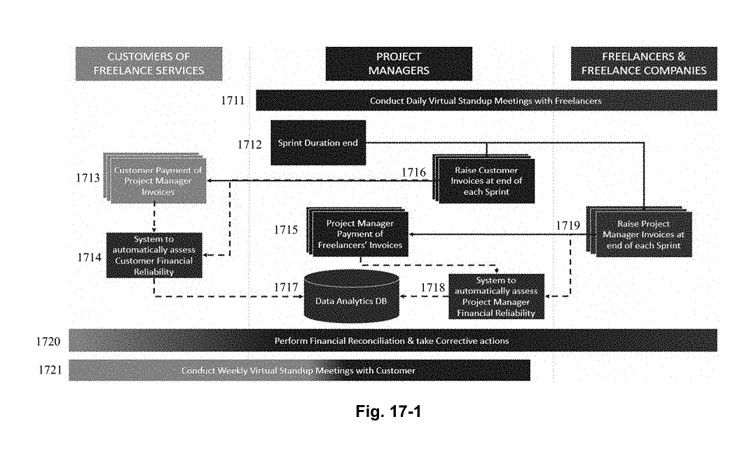

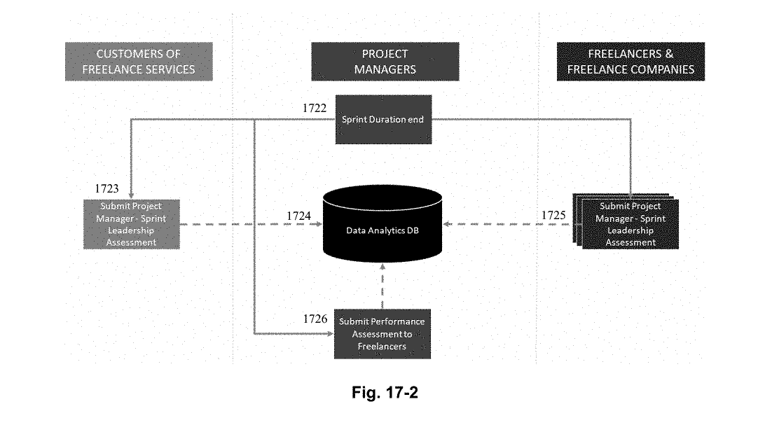

FIG. 17-1 may depict an embodiment of a freelance project Sprint invoicing and payments flow and maps to workflow component 810 in FIG. 8 in the proposed Online Freelancing system.

The Project Manager may perform the activities like raise Customer invoices at the end of each Sprint 1716, after all Sprint deliverables have been accepted by the Customer 1712, make payments against Freelancers' invoices 1715, Freelancers and Freelance companies working in the Sprint may perform the activities such as raise Project Manager invoices 1719 at the end of each Sprint, Customers may perform the following activities, and pay Project Manager invoices 1713.

The proposed Online Freelancing system may perform the actions such as automatically assess Customer financial reliability 1718, by determining timeliness and completeness or accuracy of payments made against Project Manager invoices in that Sprint, schedule variance of Project Manager Sprint invoice payments, payment accuracy or completeness of Sprint invoice payments.

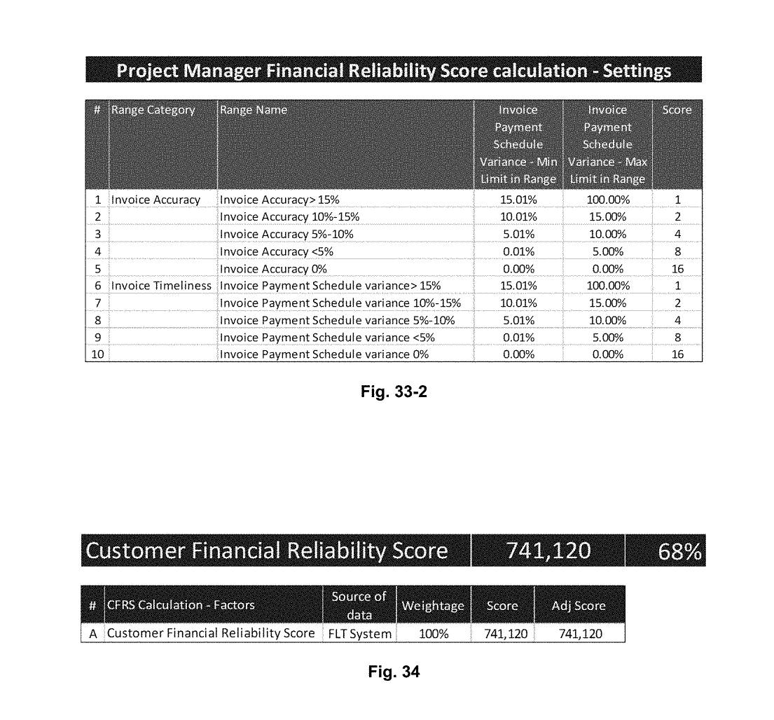

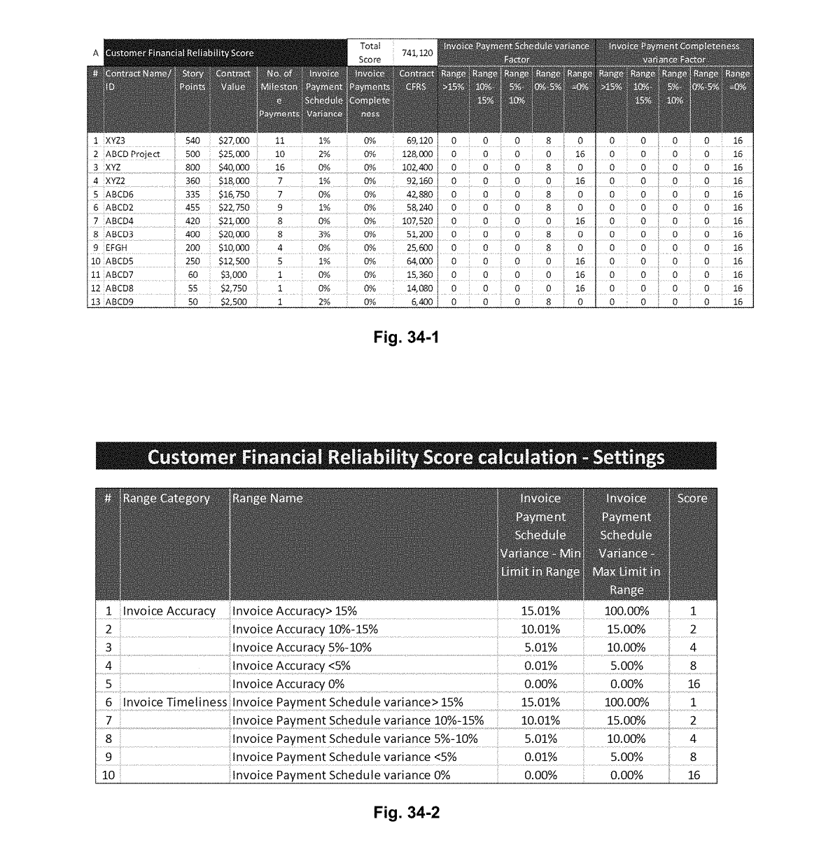

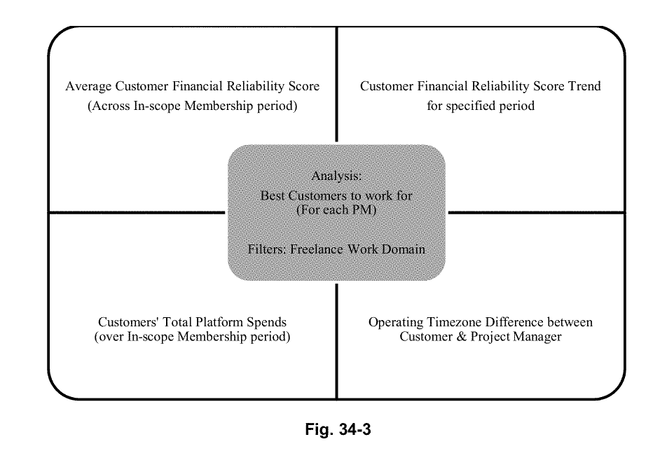

FIG. 34 depicts an exemplary embodiment of a Customer financial reliability calculator. FIG. 34-1 depicts an exemplary embodiment of a detailed Customer financial reliability calculator. Customer financial reliability is measured from two perspectives, schedule variance of Project Manager invoice payments, and completeness and accuracy of Project Manager invoice payments, and automatically assess Project Manager financial reliability, by assessing timeliness and completeness or accuracy of payments made against Freelancers' invoices in that Sprint.

$$1 ) Schedule variance of Project Manager Sprint invoice Payments = \frac{( Actual invoice Payment date - invoice Submission date )}{( Planned invoice Payment date - invoice Submission date )}$$

Where,

1) Actual invoice Payment date=Date on which Customer has made a payment against a specific Project Manager invoice,

2) invoice Submission date=Date on which Project Manager has submitted the invoice to the Customer, and

3) Planned invoice Payment date=Date on which the Customer is mandated by Contract to pay a specific invoice. Typically, within “x” days after “invoice Submission date”, where “x” is defined in the Customer Contract.

$$4 ) Payment accuracy or completeness of Sprint invoice payments = \frac{( Sprint Payment submitted - Sprint invoice Amount )}{Sprint invoice Amount}$$

Where Sprint invoice amount=The amount stated in the Project Manager's Sprint invoice submitted to the Customer, and Sprint Payment submitted=The amount of payment submitted by the Customer against a Project Manager invoice. FIG. 34-2 depicts an exemplary embodiment of all settings on the Customer financial reliability calculator.

FIG. 34-3 depicts an embodiment of an approach to identify the most “likeable” Customers on the proposed Online Freelancing system.

FIG. 17-2 may depict an embodiment of a freelance project Sprint Freelancer performance assessments or Project Manager leadership assessments flow, and maps to workflow component 811 in FIG. 8 in the proposed Online Freelancing system.

The Customer may provide Project Manager leadership assessment at the end of each Sprint 1723. FIG. 31 is an exemplary embodiment of a tool which may be used to calculate Project Manager leadership score. Project Manager leadership score is derived from four separate measurement components which are Project Manager Contract leadership assessment score, Contract Team selection effectiveness rating, and Contract Team leadership effectiveness rating. The Project Manager Contract leadership assessment score, a system-calculated score that uses as inputs various Project Management performance aspects such as job proposal completeness rating which indicates the quality of job proposals submitted by Project Managers in response to a Customer job. This rating is submitted by the Customer against job proposals submitted, and this value is not shared with the respective Project Managers who have submitted the job proposals. It is measured by examining job proposal coverage on aspects such as coverage of job requirements as stated by the Customer, job proposal solutions or approaches mapping to job requirements, job requirements and solutions dependencies identification, job requirements and solutions risks identification, Job Proposal Team mapping to job requirements execution skills needed, etc.

The Contract Team selection effectiveness rating indicates the Project Manager's diligence in searching for, identifying, and engaging the right group of Freelancers—with the right Freelance work domain expertise, required skills and skill levels, and required work Portfolio experience—to be part of the Contract Execution Team, and to execute a given Contract in the manner most satisfactory to the Customer. The Contract Team selection effectiveness rating is submitted by the Customer at the end of each Contract. The Contract Team leadership effectiveness rating indicates the Project Manager's diligence in forcing teaming, clarity of roles, collaboration and efficiency into a Contract Execution Team.

FIG. 31-1A, FIG. 31-1B, and FIG. 31-1C taken jointly is an exemplary embodiment of a tool which may be used to calculate Project Manager detailed Contract leadership score. The Project Manager detailed Contract leadership score is calculated by the multiplying scores related to three components. Project type weightage factor are scores corresponding to different Contract types applicable to the specific Contract like BOT, project, and operations. Contract leadership factor score refers to scores and weightages corresponding to the following Contract leadership factors applicable to the specific Contract. Job proposal completeness rating indicates the quality of job proposals submitted by Project Managers in response to a Customer job. This rating is submitted by the Customer against job proposals submitted, and this value is not shared with the respective Project Managers who have submitted the job proposals. It is measured by examining job proposal coverage on aspects such as coverage of job requirements as stated by the Customer, job proposal solutions and approaches mapping to job requirements, job requirements and solutions dependencies identification, job requirements and solutions risks identification, Job Proposal Team mapping to job requirements execution skills needed, etc. Contract Team selection effectiveness rating indicates the Project Manager's diligence demonstrated in selecting the right mix of Contract Execution Team to execute a given Contract. The ideal team has a strong match with attributes such as Freelance work domain, skills Mix, skill levels, work Portfolios, etc. Contract Team leadership effectiveness rating indicates the Project Manager's ability and interest in driving alignment of a Contract Execution Team on a specific Contract into a collaborative, cohesive, and unified team, using team forming or norming or storming or performing techniques. Key factors or contextual elements that impact team formation includes cultural aspects tied to a country of origin, geographical location, religion, etc., education, prior work experience and working culture in previous Organizations, language, operating time zone, etc. Key techniques that may be used to drive team formation may include Contract Execution Team—vision setting, Contract Execution Team—Responsibility or Accountability or Consulting or Information (RACI) matrix definition, Contract Execution Team—team charter definition, etc.

Product Backlog completeness (Scope Coverage) rating indicates the Project Manager's diligence demonstrated on developing a complete Product Backlog for a specific Contract that addresses all the required components as explicitly stated in the job as well as other required components that are to be implicitly understood given the right insight into the Freelance work domain, skill areas, etc. Release planning effectiveness rating indicates the Project Manager's diligence demonstrated on developing a comprehensive Contract Release Plan for a specific Contract, considering all job-related attributes such as Epics, User Stories, User Story dependencies, and other qualifications like User Story Criticality, User Story Deployment Urgency, User Story usage level, User Story size or complexity, etc., as well as Contract Execution Team-related attributes such as Freelancer Team availability planning, Freelancer team capacity planning, Customer Team availability planning, etc.

Work Execution Management effectiveness rating signifies the Project Manager's perceived effectiveness in managing work execution from the Contract Execution Team's perspective on a specific Contract. In order to drive effectiveness, the Project Manager may leverage the following techniques drive daily updates of Kanban Boards and Kanban Cards in line with job execution, download available Contract execution reports, such as Sprint Burn-up or Burn-down chart, issues log, risks log, delivered defects log, etc., Conduct virtual stand-up meetings with the Contract Execution Team, use actions register to document and track meeting action items to closure, etc.

Sprint or release Governance effectiveness rating indicates the Project Manager's effectiveness in planning and performing Governance of Contract release and Contract Sprints, both from a Customer perspective as well as from a Contract Execution Team perspective on a specific Contract. The Project Manager may also plan for and execute appropriate corrective actions, such as deep-dive analysis, re-plans, etc., to recover Contracts that are moving away from the plan. Product Quality Management rating indicates the Project Manager's ability to drive quality of the Products delivered to the Customer, measured by the ratio of Delivered Defects per Story Point. Meeting Management Effectiveness Rating indicates the Project Manager's effectiveness on a specific Contract in planning, scheduling and conducting Customer and or Freelancer meetings, as well as following up on and tracking to a closure of actions due that have been raised during the meetings.

Communication Management effectiveness rating indicates the Project Manager's effectiveness on a specific Contract in planning and performing Contract communications from perspectives such as communications scope or content planning, frequency of communications, depth of planned coverage of communications, tailored to various Stakeholders and their needs and expectations, delivering to plan on the scope or content and schedule, etc. Invoicing accuracy rating indicates the Project Manager's diligence on a specific Contract in raising Customer Sprint invoices that are consistently accurate throughout the life of the Contract. Payments accuracy rating refers to the Project Manager's diligence on a specific Contract in making payments against Freelancer Sprint invoices that are consistently accurate throughout the life of the Contract. Payments timeliness rating refers to the Project Manager's diligence on a specific Contract in making payments against Freelancer Sprint invoices that consistently meets the “invoice payment turnaround time” metric, throughout the life of the Contract. The “invoice payment turnaround time” metric may be defined as part of the Customer Contract. Product and Contract ownership rating indicates the Project Manager's perceived (from Customer's perspective) breadth and depth of interest, involvement, and Customer engagement on a specific Contract on developing services, deliverables, or outcomes for the Customer, covering aspects such as,

1) Does the Project Manager lead and drive the Contract Execution Team on a given Contract to gain insights into both stated or explicit and unstated or implicit requirements?

2) Does the Project Manager lead and drive the Contract Execution Team on a given Contract to think of the Customer's Organizational and Market context, so as to define the most complete solutions possible?

3) Does the Project Manager lead and drive the Contract Execution Team on a given Contract to actively collaborate with and engage the Customer team, and validate assumptions, approaches, solutions, etc., so as to achieve expected job outcomes in the most productive and efficient manner?

Contract flexibility rating signifies the Project Manager's perceived (from Customer's perspective) flexibility on a specific Contract, in accommodating changes to stated job requirements, and containing impacts to the Contract terms and conditions, Contract costs, Contract schedules, etc., to a reasonable level.

FIG. 31-2 is an exemplary embodiment of a tool which may be used to calculate Project Manager's Project Management certifications score.

FIG. 31-3 is an exemplary embodiment of a tool which may be used to calculate Project Manager's Project Management experience score.

FIG. 31-4 is an exemplary embodiment of a tool which may be used to calculate Project Manager's Project Management skills score.

FIG. 31-5 is an exemplary embodiment of a group of settings that may be used in tools embodied in FIGS. 31, 31-1, 31-2, 31-3, and 31-4, to support the various calculations.

The Project Manager may provide Freelancer performance assessment at the end of each Sprint, to each Freelancer in the Contract Execution Team. Freelancer skills score is the overall skill ownership of a Freelancer. FIG. 32-2 is an exemplary embodiment of a tool which may be used to calculate Freelancer skills score. It assesses a skill level score for each skill that the Freelancer possesses and aggregates these scores to calculate an overall Freelancer skills score. Freelancer Portfolio score quantifies the overall work Portfolio of a Freelancer, by quantifying and aggregating work experience related scores for the Freelancer. FIG. 32-3 depicts an exemplary embodiment of a tool which may be used to calculate Freelancer Portfolio score. FIG. 32-4 is an exemplary embodiment of a guide that is used as settings on the Freelancer Profile score calculator tool. The Freelancers in the Contract Execution Team may provide Project Manager leadership assessment at the end of each Sprint. FIG. 31 is an exemplary embodiment of a tool which may be used to calculate Project Manager Contract leadership score.

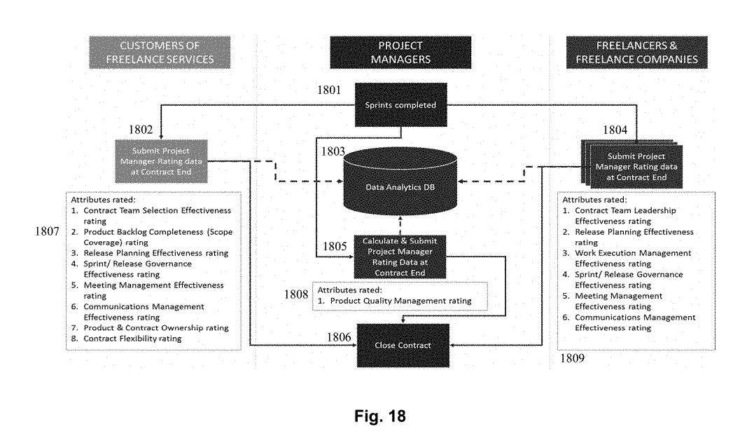

FIG. 18 may depict an embodiment of a Freelance Project Contract Closure flow and maps to workflow component 812 in FIG. 8 in the proposed Online Freelancing system. This flow starts after all delivery Sprints are completed and the Contract is ready to be closed. The Customer may submit rating data for the Project Manager 1802, on the attributes 1807 such as Contract Team selection effectiveness rating, Product Backlog completeness (Scope Coverage) rating, release planning effectiveness rating, Sprint or release Governance effectiveness rating, Meeting Management effectiveness rating, Communications Management effectiveness rating, Product and Contract ownership rating, and Contract flexibility rating. The Contract Team selection effectiveness rating is the Project Manager's diligence demonstrated in selecting the right mix of Contract Execution Team to execute a given Contract. The ideal team has a strong match with attributes such as Freelance work domain, skills Mix, skill levels, work Portfolios, etc.

The Product Backlog completeness (Scope Coverage) rating indicates the Project Manager's diligence demonstrated on developing a complete Product Backlog that addresses all the required components as explicitly stated in the job as well as other required components that are to be implicitly understood given the right insight into the Freelance work domain, skill areas, etc. The release planning effectiveness rating is the Project Manager's diligence demonstrated on developing a comprehensive Contract Release Plan considering all job-related attributes such as Epics, User Stories, User Story dependencies, and other qualifications like User Story criticality, User Story deployment urgency, User Story usage level, User Story size or complexity, etc., as well as Contract Execution Team-related attributes such as Freelancer Team availability planning, Freelancer Team capacity planning, and Customer Team availability planning, etc.

The Sprint or release Governance effectiveness rating indicates the Project Manager's effectiveness in planning and performing Governance of Contract release and Contract Sprints, both from a Customer perspective as well as from a Contract Execution Team perspective. The Project Manager may also plan for and execute appropriate corrective actions, such as deep-dive analysis, re-plans, etc., to recover Contracts that are moving away from the plan. The Meeting Management effectiveness rating is the Project Manager's effectiveness in planning, scheduling and conducting Customer and or Freelancer meetings, as well as following up on and tracking to a closure of actions due that have been raised during the meetings.

The Communications Management effectiveness rating is the Project Manager's effectiveness in planning and performing Contract communications from the following perspectives, communications scope or content planning, frequency of communications, depth of planned coverage of communications, tailored to various Stakeholders and their needs and expectations, delivering to plan on the scope or content and schedule, etc.

The product and Contract ownership rating is the Project Manager's perceived (from Customer's perspective) breadth and depth of interest, involvement, and Customer engagement on developing services, deliverables, or outcomes for the Customer, covering aspects such as,

1) Does the Project Manager lead and drive the Contract Execution Team to gain insights into both stated or explicit and unstated or implicit requirements?

2) Does the Project Manager lead and drive the Contract Execution Team to think of the Customer's Organizational and market context, so as to define the most complete solutions possible?

3) Does the Project Manager lead and drive the Contract Execution Team to actively collaborate with and engage the Customer team, and validate assumptions, approaches, solutions, etc., so as to achieve expected job outcomes in the most productive and efficient manner?

The Contract flexibility rating indicates the Project Manager's perceived (from Customer's perspective) flexibility in accommodating changes to stated job requirements and containing impacts to the Contract terms and conditions, Contract costs, Contract schedules, etc., to a reasonable level. The Freelancers in the Contract Execution Team may submit rating data for the Project Manager, on the attributes like Contract Team leadership effectiveness rating indicates the Project Manager's ability and interest in driving alignment of the Contract Execution Team into a collaborative, cohesive, and unified team, using team forming or norming or storming or performing techniques. Key factors or contextual elements that impact team formation includes cultural aspects tied to a country of origin, geographical location, religion, etc., education, previous work experience and the organization culture in previous organizations, language, time zone, etc. Key techniques that may be used to drive team formation may include Contract Execution Team—vision setting, Contract Execution Team—responsibility or accountability or consulting or information (RACI) matrix definition, Contract Execution Team—Team Charter definition, etc. The release planning effectiveness rating is the Project Manager's diligence demonstrated on developing a comprehensive Contract Release Plan, considering all job-related attributes such as Epics, User Stories, User Story dependencies, and other qualifications such as User Story criticality, User Story deployment urgency, User Story usage level, User Story size or complexity, etc., as well as Contract Execution Team-related attributes such as Freelancer team availability planning, Freelancer team capacity planning, Customer Team availability planning, etc.

The work Execution Management effectiveness rating is Project Manager's perceived effectiveness in managing work execution from the Contract Execution Team's perspective. In order to drive effectiveness, the Project Manager may leverage the techniques such as drive daily updates of Kanban Boards and Kanban Cards in line with job execution, download available Contract execution reports, such as Sprint Burn-up or Burn-down chart, issues log, risks log, delivered defects log, etc., Conduct virtual stand-up meetings with the Contract Execution Team, use actions register to document and track meeting action items to closure, etc.

Sprint or release Governance effectiveness rating indicates the Project Manager's effectiveness in planning and performing Governance of Contract release and Contract Sprints, both from a Customer perspective as well as from a Contract Execution Team perspective. The Project Manager may also plan for and execute appropriate corrective actions, such as deep-dive analysis, re-plans, etc., to recover Contracts that are moving away from the plan. The Meeting Management effectiveness rating indicates the Project Manager's effectiveness in planning, scheduling and conducting Customer and/or Freelancer meetings, as well as following up on and tracking to a closure of actions due that have been raised during the meetings. Communications Management effectiveness rating is the Project Manager's effectiveness in planning and performing Contract communications from the following perspectives communications scope or content planning, a frequency of communications, depth of planned coverage of communications, tailored to various Stakeholders and their needs and expectations, delivering to plan on the scope or content and schedule, etc.

The proposed Online Freelancing system may submit rating data for the Project Manager, on the following attributes, Product Quality Management rating indicates the Project Manager's ability to drive quality of the products delivered to the Customer, measured by the ratio of delivered defects per Story Point.

FIG. 35 is an exemplary embodiment of a Customer Organizational work stream, including one or more Customer Project Portfolios. A Customer Project Portfolio may be characterized by the following:

1) Maybe typically associated with a single Customer strategy or strategic objective.

2) May include multiple jobs or projects, which when executed in an appropriate sequence, enables the achievement of the Customer strategy or strategic objective associated with the Project Portfolio.

3) Such jobs or projects may have dependencies applicable across them, necessitating a pre-determined sequential execution of the jobs or projects.

4) Some or all of the jobs or projects that belong to the Customer Project Portfolio may be executed within the boundaries of the proposed Online Freelancing system, other remaining jobs or projects in the Customer Project Portfolio may be executed outside the proposed Online Freelancing system.

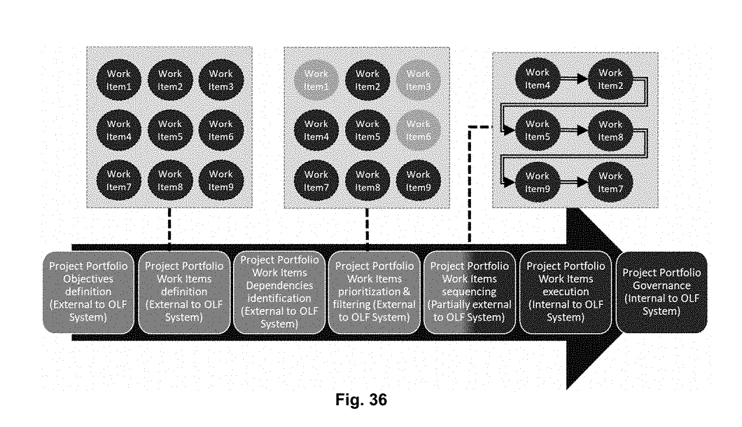

FIG. 36 is an exemplary embodiment of a Customer Project Portfolio Management process. The Customer Project Portfolio Management process may include the following major steps:

1) Customer Project Portfolio objectives definition where the key objectives and or measures of success of the Project Portfolio are defined. Customer Project Portfolio objectives may be derived from the Customer strategy and or Customer strategic objective that characterizes the Project Portfolio. For example, a Customer strategy called “billing systems convergence” may include objectives such as “migrate billing functionality from existing disparate systems to a single system while limiting Customer exposure”, and key measures of success such as number of billing systems in use in one calendar year, Total duration to complete migration to single billing system, etc. A Project Portfolio may be qualified by the following, an Organizational context for the Project Portfolio objective, which may include Customer's Organizational process maturity, Customer's Organizational resources and know how, the available timeline to achieve the Project Portfolio objective, Customer's Organization's political context, etc. An external context for the Project Portfolio objective, which may include Customer's market environment, Customer's competition, etc.

Examples of Customer Organizational objectives may be, cost reduction 15% in Organizational spend within one year, improvement of a market share of a specific product by 20%, etc. The Customer Project Portfolio objectives definition process step may typically be executed outside the proposed Online Freelancing system.

2) Customer Project Portfolio work items definition where the jobs, projects and other work items in the Project Portfolio are defined. This may typically be achieved in three steps. Firstly, analyse the existing Organizational work stream to identify jobs, projects and other work items that may belong to a specific Project Portfolio. Secondly, performing a top-down analysis of the strategic objective to define a set of jobs, projects, and other work items, targeted to achieve the strategic objective. Finally, compiling the outputs from the above two steps, eliminating any duplicate work items or overlapping work items, and generating a unique list of work items that are targeted to achieve the strategic objective.

The Customer Project Portfolio work Items definition process step may typically be executed outside the proposed Online Freelancing system.

3) Customer Project Portfolio work items dependencies identification where the various dependencies on all component work items are identified. This may be achieved through multiple mechanisms, such work items analysis in which the Stakeholders for each identified work item may work together as a team to identify dependencies for the work item, prioritize the impact, complexity, and sequencing of the dependency. Subsequently, the owners or Project Managers for each work item get together to aggregate the various dependencies into a unified dependency plan for the entire Project Portfolio, top-down analysis where key resources from business, technical etc., may work together to identify the required business process for the Project Portfolio, identify key milestones, challenges and dependencies, and generate a dependency plan that would then need to be decomposed to a work Item level by the Contract Execution Team for that work item and the Customer Project Portfolio work items dependencies identification process step may typically be executed outside the proposed Online Freelancing system.

4) Customer Project Portfolio work items prioritization and filtering where the various work items are prioritized based on pre-determined attributes and filtered to focus on the right work items. The key steps involved may are, key Stakeholders at the Customer business, Project Portfolio, and projects levels may work together to define the set of attributes for prioritization of the various work items. The attributes for prioritization and filtering may include work item cost work item criticality of deployment like mandatory or legal, critical to business, must-have for business, good-to-have for business, etc. work item urgency of deployment consisting immediate (maybe 0-3 months), short-term (maybe 4-6 months), medium-term (maybe 7-12 months), long-term (may be 13-24 months), etc. Work item return on investment timelines are short-term horizon (may be 3-6 months), medium term horizon (may be 7-12 months), long term horizon (may be 13-24 months), very long-term horizon (may be 25-36 months), horizon not visible (may be >=37 months), etc. work item usage pattern comprises very high (daily usage), high (several times a week usage), medium (few times per month), low (few times per quarter), very low (few times per annum), etc. The Customer Project Portfolio work items prioritization and filtering process step may typically be executed outside the proposed Online Freelancing system.

5) Customer Project Portfolio work items sequencing where the shortlisted work items, after prioritization and filtering, are formed into an appropriate sequence for execution planning. This step uses the dependencies identified earlier to define the sequencing of work items. A key action in this step is to identify the work items that may be executed in-house within the Customer environment, vs. the work items that may be outsourced to outsourcing partners, vs. the work items that may be executed via the proposed Online Freelancing system. The Customer Project Portfolio work items sequencing process step may typically be executed partially outside the proposed Online Freelancing system, and only apply to those work items that are shortlisted for execution via the proposed Online Freelancing system.

6) Customer Project Portfolio work items execution where the work items shortlisted for execution via the proposed Online Freelancing system are executed.

7) Customer Project Portfolio work items Governance:=where the execution Governance of the work items shortlisted for execution via the proposed Online Freelancing system is performed.

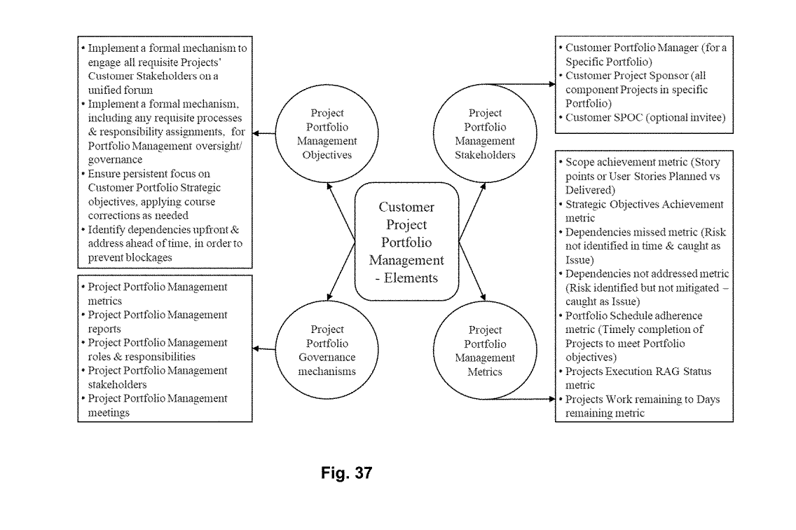

FIG. 37 is an embodiment of the various elements that may be included in a Customer Project Portfolio Management. Customer Project Portfolio Management objectives are the list of major Customer objectives that the Project portfolio has been implemented in order to achieve. Examples of Customer Project Portfolio Management objectives may include cut down operations costs by 10% in the space of one year, conduct the launch of a new market product on a specified date, etc., Customer Project Portfolio Management mechanisms, such as Customer Project Portfolio Management metrics, Customer Project Portfolio Management reports, Customer Project Portfolio Management Stakeholders, roles and responsibilities, Customer Project Portfolio Management meetings, etc. Customer Project Portfolio Management Stakeholders are the Customer resources who perform the various required functions and responsibilities in order to enable effective Management of the Project Portfolio. Customer Project Portfolio Management metrics are the key measures that are designed by the Customer team to measure the level of achievement of the Customer Project Portfolio objectives, etc.

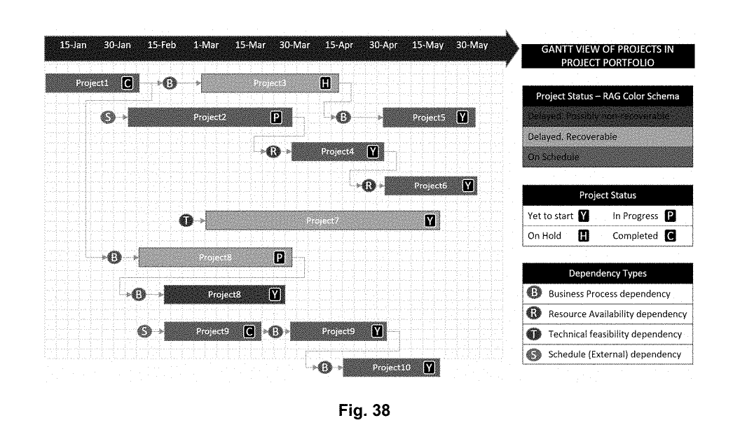

Customer Project Portfolio Management metrics may typically include scope achievement metric, Portfolio schedule adherence metric, projects execution RAG status metric, projects work remaining to days remaining metric, dependencies missed metric, dependencies not addressed metric. The scope achievement metric assesses the status of implementation or development of the Customer's strategic objectives and the related Project Portfolio scope in terms of project requirements and acceptance criteria. The Portfolio schedule adherence metric assesses the schedule variance of Portfolio projects implementation against the plan, and thus, the schedule variance of Portfolio objectives or scope achievement against the plan. FIG. 38 which is an exemplary embodiment of a GANTT view of the Customer Project Portfolio, and FIG. 39 which is an exemplary embodiment of the Project Portfolio strategic objectives achievement tracker report, may be used to augment the Portfolio Schedule adherence metric.

The project's execution RAG status metric measures the status of each Project vis-à-vis the plan, by measuring the following aspects of status, Sprints completed vs. planned, elapsed time spent vs. remaining, number of delivered defects raised vs. still lying unresolved, etc. In this report, the statuses essentially mean the following:

1) R (red): Execution behind the plan, unlikely to complete the project on time with the currently planned scope of User Stories,

2) A (amber): Execution behind the plan, likely to recover the project on time with some extra effort,

3) G (green): Execution on or ahead of the plan.

The projects work remaining to days remaining metric supports the assessment of the likelihood of project completion on time, by comparing work remaining (User Stories not yet delivered) to days remaining (project plan end date—current date). This comparison can provide a reasonable outlook of the likelihood of completion of the project, especially when combined with the project RAG status report. The dependencies missed metric reports risks not identified in time and identified only as the issue, resulting in delays or blockage of project execution. Each issue identified is analysed for source and attribution, to assess the “missed dependency” aspect of the issue. The dependencies not addressed metric reports risks identified but not mitigated in a timely fashion, resulting in delays or blockage of project execution. Each risk identified is analysed for source and attribution, to assess the “missed dependency” aspect of the risk.

FIG. 40 provides an exemplary embodiment of a Customer Project Portfolio dashboard and enables the reporting of the above metrics. Customer Project Portfolio Management reports may typically include Customer Project Portfolio delivery GANTT views such as the Customer Project Portfolio delivery GANTT view report enables a GANTT chart view of the Project portfolio, with key dependencies information overlaid. This report enables the Portfolio Manager to gain a radar-like view of the entire Portfolio execution planning, and this helps to plan for and address key concerns before they hit the projects.

FIG. 38 provides an exemplary embodiment of the Customer Project Portfolio delivery GANTT view report. The Customer Project Portfolio strategic objectives achievement tracker report contains a breakup of the Customer Project Portfolio strategic objectives into component requirements that are further broken down into projects in the Project Portfolio. The projects thus identified are mapped to an execution timeline, and the actual status is also updated on this tracker. Thus, this report enables a view of achievement of strategic objectives and its component requirements on a graphical timeline base.

FIG. 39 is an exemplary embodiment of the Project Portfolio strategic objectives achievement tracker. The Customer Project Portfolio dashboard covers the reporting of all of the metrics defined to support Customer Project Portfolio Management earlier in this section and provides a visual representation of the various metrics and reporting elements, thus enabling easy and effective Governance of the various aspects of the Project Portfolio.

FIG. 40 provides an exemplary embodiment of a Customer Project Portfolio dashboard and enables the reporting of the several Project Portfolio Management metrics. The Customer Project Portfolio financial status report documents all Financial transactions (invoices and payments, disputes, etc.) that are applicable to the various projects within the Customer Project Portfolio. This detailed report is used as input to generate other financial summary charts that are presented on the Customer Project Portfolio dashboard as depicted in the exemplary embodiment in FIG. 40.

FIG. 41 provides an exemplary embodiment of the Customer Project Portfolio financial transactions report, which contains all invoices against all projects within the Project Portfolio, along the information elements such as project name or ID, Sprint name or ID, invoice amount, invoice status, payment status, invoice dispute reason codes, Sprint payment credited amount, Sprint invoice disputed amount, Sprint payment still due amount, etc. The Customer Project Portfolio financial summary report documents a work item-wise summary of financial transactions for all the work items within the Customer Project Portfolio.

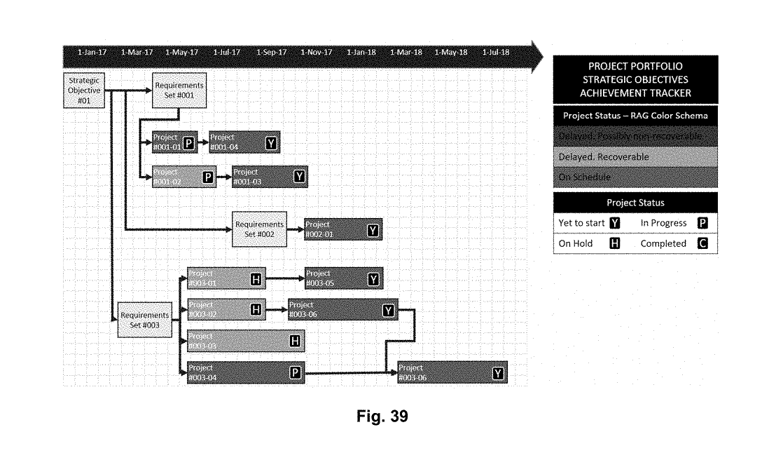

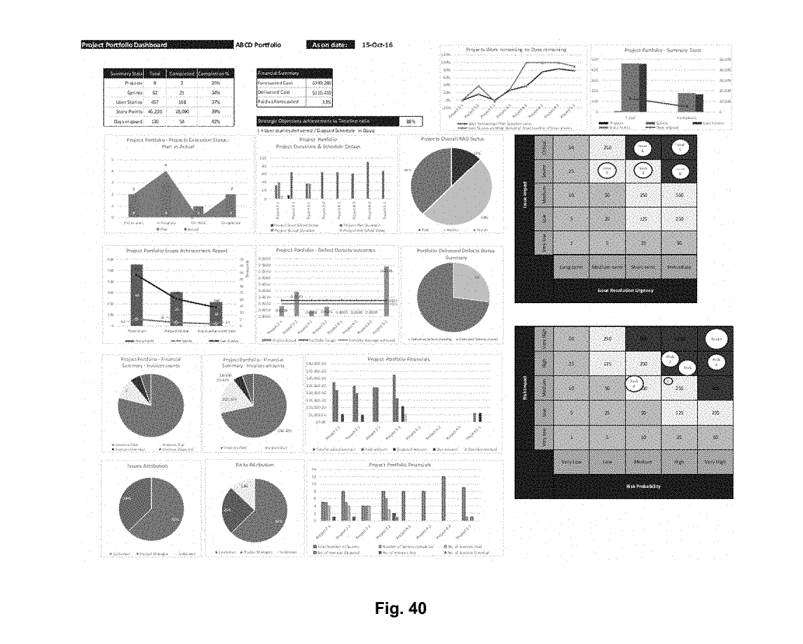

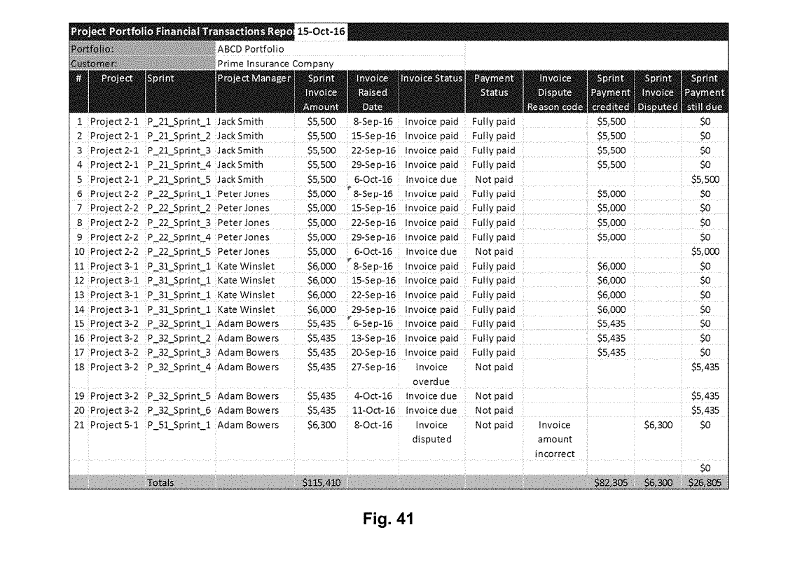

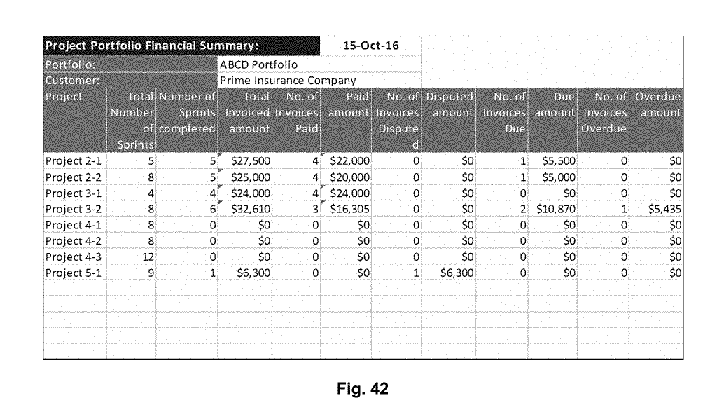

FIG. 42 provides an exemplary embodiment of the Customer Project Portfolio Financial Summary, which contains the following information elements, project name or ID, total number of Sprints, number of Sprints completed, total invoiced amount, number of invoices paid, disputed amount, number of invoices where payment is due, invoice due amount, number of invoices overdue, overdue amount, etc. The Customer Project Portfolio risks heat map may be used to present a visual representation of the major risks from the Portfolio risks log while providing emphasis on higher probability or higher impact or more urgent risks, so that the Customer Portfolio Manager and the Customer Senior Management can very quickly identify the problem areas to put immediate focus on.

FIG. 40 contains an exemplary embodiment of the Customer Project Portfolio dashboard, which includes a depiction of the Customer Project Portfolio risk heat map. FIG. 12-2 is an exemplary embodiment of risk heat map items positioning guide. FIG. 12-3 is an exemplary embodiment of risk heat map bubble sizing guide. The Customer Project Portfolio issues heat map may be used to present a visual representation of the major issues from the Portfolio issues log while providing emphasis on higher impact or more urgent issues so that the Customer Portfolio Manager and the Customer Senior Management can very quickly identify the problem areas to put immediate focus on.

FIG. 40 contains an exemplary embodiment of the Customer Project Portfolio dashboard, which includes a depiction of the Customer Project Portfolio issues heat map. FIG. 27-2 is an exemplary embodiment of issues heat map items positioning guide. Customer Project Portfolio Management Stakeholders may typically include Customer Portfolio Manager and Customer Project Sponsor. The Customer Portfolio Manager is the one who owns the oversight and Governance of the Customer Project Portfolio, schedules and conducts periodic Project Portfolio Governance meetings with other appropriate Customer Stakeholders such as Customer Sponsors to ensure appropriate progress of projects execution. The progress of projects execution is measured by factors such as projects completion on time and with the right quality, Project Portfolio Scope achievement, Project Portfolio Strategic objectives achievement, Project Portfolio financial control, etc.

The Customer Project Sponsor is one who owns a Project from the business and funding perspectives. Ensures that all project roadblocks are addressed in a timely fashion, and all project dependencies are resolved ahead or on time, so as to eliminate impacts to project execution. Attends (directly or via a delegate) all necessary project Governance meetings as well as any necessary Project Portfolio Governance meetings and is measured by project success.

FIG. 43 is an exemplary embodiment of a Freelance Company Project portfolio. A Freelance Company Project Portfolio may be characterized by the following, associated with a specific Customer for the Freelance Company, includes all the projects that the Freelance Company may be executed for the specific Customer, may include multiple jobs or projects, jobs or projects may have dependencies applicable across them, necessitating a sequential execution of the jobs or projects.

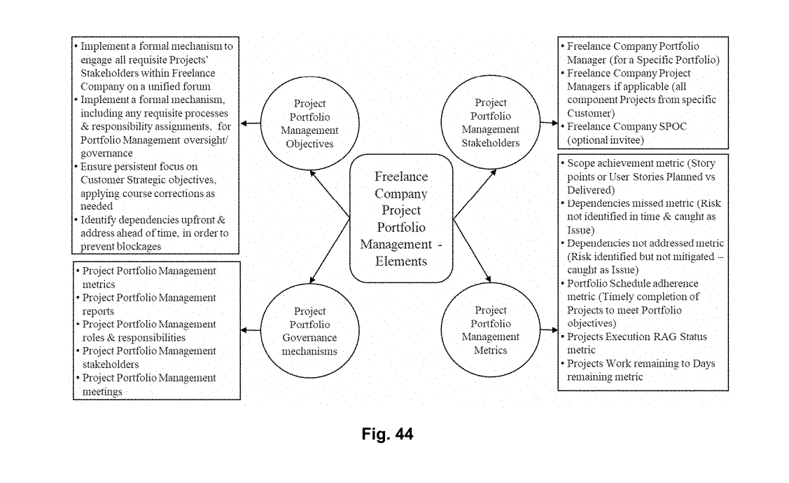

FIG. 44 is an embodiment of the various elements that may be included in a Freelance Company Project Portfolio Management. Freelance Company Project Portfolio Management objectives are the list of major Freelance Company objectives that the Project Portfolio has been implemented in order to achieve. Examples of Customer Project Portfolio Management objectives may include improving Customer projects retention or a new business by 20% within one year, etc., Freelance Company Project Portfolio Management mechanisms, such as Freelance Company Project Portfolio Management metrics, Freelance Company Project Portfolio Management reports, Freelance Company Project Portfolio Management Stakeholders, roles and responsibilities, Freelance Company Project Portfolio Management meetings, etc. Freelance Company Project Portfolio Management Stakeholders are the Freelance Company resources who perform the various required functions and responsibilities in order to enable Effective Management of the Project Portfolio. Freelance Company Project Portfolio Management metrics are the key measures that are designed by the Customer team to measure the level of achievement of the Freelance Company Project Portfolio objectives, etc.

Freelance Company Project Portfolio Management metrics may typically include scope achievement metric, Portfolio schedule adherence metric, projects execution RAG status metric, projects work remaining to days remaining metric, dependencies missed metric, and dependencies not addressed metric.

The scope achievement metric assesses the status of implementation or development of the Customer's strategic objectives and the related project Portfolio scope in terms of Project requirements and acceptance criteria. The Portfolio schedule adherence metric assesses the schedule variance of Portfolio projects implementation against the plan, and thus, the schedule variance of Portfolio objectives or scope achievement against the plan. FIG. 38, which provides an exemplary embodiment of a GANTT view of the Customer Project Portfolio, may be used to augment the Portfolio Schedule adherence metric.

The projects execution RAG status metric measures the status of each project vis-à-vis the plan, by measuring the following aspects of status, Sprints completed vs. planned, elapsed time spent vs. remaining, number of delivered defects raised vs. still lying unresolved, etc. In this report, the statuses essentially mean the following:

1) R (red): Execution behind the plan, unlikely to complete the project on time with the currently planned scope of User Stories

2) A (amber): Execution behind the plan, likely to recover the project on time with some extra effort

3) G (green): Execution on or ahead of the plan.

The projects work remaining to days remaining metrics supports the assessment of the likelihood of project completion on time, by comparing work remaining (User Stories not yet delivered) to days remaining (project plan end date—current date). This comparison can provide a reasonable outlook of the likelihood of completion of the project, especially when combined with the project RAG status report. The dependencies missed metric reports risks not identified in time and identified only as an issue, resulting in delays or blockage of project execution. Each issue identified is analysed for source and attribution, to assess the “missed dependency” aspect of the issue. The dependencies not addressed metric reports risks identified but not mitigated in a timely fashion, resulting in delays or blockage of project execution. Each risk identified is analysed for source and attribution, to assess the “missed dependency” aspect of the risk.

FIG. 40 provides an exemplary embodiment of a Freelance Company Project Portfolio dashboard and enables the reporting of the above metrics. Freelance Company Project Portfolio Management reports may typically include Freelance Company Project Portfolio dashboard, Freelance Company Project Portfolio delivery GANTT view, Freelance Company Project Portfolio financial status, Freelance Company Project Portfolio financial summary, Freelance Company, Project Portfolio risk heat map, Freelance Company Project Portfolio issue heat map. The Freelance Company Project Portfolio dashboard covers the reporting of all of the metrics defined to support Freelance Company Project Portfolio Management earlier in this section and provides a visual representation of the various metrics and reporting elements, thus enabling easy and effective Governance of the various aspects of the Project Portfolio.

FIG. 40 provides an exemplary embodiment of a Freelance Company Project Portfolio dashboard and enables the reporting of several Freelance Company Project Portfolio Management metrics. The Freelance Company Project Portfolio delivery GANTT view report enables a GANTT chart view of the Project Portfolio, with key dependencies information overlaid. This report enables the Portfolio Manager to gain a radar-like view of the entire Portfolio execution planning, and this helps to plan for and address key concerns before they hit the projects.

FIG. 38 provides an exemplary embodiment of the Freelance Company Project Portfolio delivery GANTT view report. The Freelance Company Project Portfolio financial status report documents all financial transactions (invoices and payments, disputes, etc.) that are applicable to the various projects within the Freelance Company Project Portfolio. This detailed report is used as input to generate other financial summary charts that are presented on the Freelance Company Project Portfolio dashboard as depicted in the exemplary embodiment in FIG. 40.

FIG. 41 provides an exemplary embodiment of the Freelance Company Project Portfolio financial status report. The Freelance Company Project Portfolio financial summary report documents a work item-wise summary of financial transactions for all the work items within the Freelance Company Project Portfolio.

FIG. 42 provides an exemplary embodiment of the Freelance Company Project Portfolio financial summary report. The Freelance Company Project Portfolio risks heat map may be used to present a visual representation of the major risks from the Portfolio risks log while providing emphasis on higher probability or higher impact or more urgent risks, so that the Freelance Company Portfolio Manager and the Freelance Company Senior Management can very quickly identify the problem areas to put immediate focus on.

FIG. 40 contains an exemplary embodiment of the Freelance Company Project Portfolio dashboard, which includes a depiction of the Freelance Company Project portfolio risk heat map. FIG. 12-2 is an exemplary embodiment of risk heat map items positioning guide. FIG. 12-3 is an exemplary embodiment of risk heat map bubble sizing guide. The Freelance Company Project Portfolio issues heat map may be used to present a visual representation of the major issues from the Portfolio issues log while providing emphasis on higher impact or more urgent issues, so that the Freelance Company Portfolio Manager and the Freelance Company Senior Management can very quickly identify the problem areas to put immediate focus on.

FIG. 40 contains an exemplary embodiment of the Freelance Company Project Portfolio dashboard, which includes a depiction of the Freelance Company Project Portfolio issues heat map. FIG. 27-2 is an exemplary embodiment of issue heat map items positioning guide.

Freelance Company Project Portfolio Management Stakeholders may typically include Freelance Company Portfolio Manager and Freelance Company Project Manager. The Freelance Company Portfolio Manager is one who owns the oversight and Governance of the Customer Project Portfolio. Schedules and conducts periodic Project Portfolio Governance meetings with other appropriate Freelance Company Stakeholders to ensure appropriate progress of projects execution. The progress of projects is measured by projects completion on time and with the right quality, Project Portfolio scope achievement, Project Portfolio Strategic objectives achievement, Project Portfolio financial control, etc.

The Freelance Company Project Manager owns a project from the Freelance Company's Project execution perspective. Ensures that all project roadblocks are addressed in a timely fashion, and all project dependencies are resolved ahead or on time, so as to eliminate impacts to project execution. Attends (directly or via a delegate) all necessary project Governance meetings as well as any necessary project Portfolio Governance meetings and is measured by project success.

While specific language has been used to describe the invention, any limitations arising on account of the same are not intended. As would be apparent to a person skilled in the art, various working modifications may be made to the method in order to implement the inventive concept as taught herein.

The Figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, an order of processes described herein may be changed and are not limited to the manner described herein. Moreover, the actions of any flow diagram need not be implemented in the order shown, nor do all of the acts need to be necessarily performed. Also, those acts that are not dependent on other acts may be performed in parallel with the other acts. The scope of embodiments is by no means limited by these specific examples.

### REFERENCES

1. “What is Project Management?”, PMI, https://www.pmi.org/about/learn-about-pmi/what-is-project-management.
2. “Portfolio Management Professional”, PMI, http://www.pmi.org/certifications/types/portfolio-management-pfmp.
3. “Standard for Portfolio Management”, PMI, http://marketplace.pmi.org/Pages/ProductDetail.aspx?GMProduct=00101388901.
4. “Waterfall Methodology”, Wikipedia, https://en.wikipedia.org/wiki/Waterfall_model.
5. “Agile Methodology”, http://agilemethodology.org/.
6. Agile Software Development, Wikipedia, https://en.wikipedia.org/wiki/Agile_software_development.
7. Kanban, Wikipedia, https://en.wikipedia.org/wiki/Kanban.
8. “What is Kanban?”, Planview Leankit® https://leankit.com/learn/kanban/what-is-kanban/.
9. “Daily Scrum Meeting”, Mount Goat Software, (Daily Standup Meeting) https://www.mountaingoatsoftware.com/agile/scrum/meetings/daily-scrum.
10. Michael Lum, “5 Scrum Meeting Best Practices: Master the Daily Standup”, Mar. 2, 2016, https://sprint.ly/blog/scrum-meeting-best-practices/.
11. “Learn About Scrum”, ScrumAlliance®, (What is Scrum?) https://www.scrumalliance.org/why-scrum.
12. “Scrum Methodology”, http://scrummethodology.com/.
13. “Sprint (Software Development)”, Wikipedia, https://en.wikipedia.org/wiki/Sprint_(software_development).
14. “Scrum Methodology”, http://scrummethodology.com/scrum-sprint/
15. “Story Mapping Technique”, Agile Alliance, https://www.agilealliance.org/glossary/storymap/.
16. M. David Green, “3 Powerful Estimation techniques for Agile Teams” Entrepreneur, Jul. 1, 2014, https://www.sitepoint.com/3-powerful-estimation-techniques-for-agile-teams/.
17. Requirements Traceability, Wikipedia, https://en.wikipedia.org/wiki/Requirements_traceability.
18. CMMi, Wikipedia, http://cmmiinstitute.com/.
19. CMMi (Capability Maturity Model Integration), Wikipedia, https://en.wikipedia.org/wiki/Capability_Maturity_Model_Integration.
19. CMMi (Capability Maturity Model Integration), Wikipedia, https://en.wikipedia.org/wiki/Capability_Maturity_Model_Integration.

What is claimed is:

1. An Online Freelancing system 300 having (a) an Online Freelance platform 302, (b) plurality of Project and Program Managers 304, (c) plurality of Freelancers 306, (d) plurality of Customers 308, (f) plurality of Freelance Companies 309, (g) plurality of jobs, wherein:
(i) The Online Freelance Platform 302 forms a hub of the proposed Online Freelancing system and connects other major elements;
(ii) The Customer 308 publishes the job on the proposed Online Freelancing system 300;
(iii) The Project or Program Manager 304 (henceforth termed Project Manager) reviews, analyses, and estimates the job, and determine the tentative number of Freelancers 306 required to perform work within the specified job timeline, he or she then leverages to search for, invite and engage the required number of the most appropriate Freelancers with relevant skills and skill levels in the appropriate Freelance work domain, and once the job is awarded, execute the work as planned;
(iv) The Project Manager 304 also searches for, invite and engage the Freelance Company 309, which have on its rolls an appropriate number of Freelancers that are required by the job; and
(v) The Project Manager 304 also engages a combination of Freelance Company 309 and Freelancers 306 as required by the job published.

2. The Online Freelancing system 300 of claim 1, wherein said system include a variety of components such as Freelancers network, Freelance Companies network, Customers network, Project Managers network, projects and Project Portfolios database, requirements database, job proposals database, Contracts database, Freelance work domains and skills database, collaboration engine, external interfaces such as Secure Payment Gateway, etc.

3. The Online Freelancing system 300 of claim 1, when Customers publish jobs, the proposed Online Freelancing system 300 enforces a structure-driven decomposition of a job 39 into job requirements groups 40, job requirement groups 40 into job requirements 41, and job requirements acceptance criteria 42, wherein:
(i) The job requirements 41 are validated or tested using defined job requirement acceptance criteria 42;
(ii) There may be a one-to-many (1:X) relationship between a job 39 and corresponding job requirement groups 40;
(iii) There may be a one-to-many (1:Y) relationship between a job requirement group 40 and corresponding job requirements 41; and
(iv) There may be a one-to-many (1:Z) relationship between a job requirement 41 and corresponding job requirement acceptance criteria 42.

4. The Online Freelancing system 300 of claim 1, wherein decomposed job with various definition elements as well as implementation elements, relationships and qualifications identified comprises:
(i) A Job 43 decomposed to define its definition elements such that said Job 43 is progressively elaborated to define Job Requirement Groups 44;
(ii) The Job Requirement Groups 44 are progressively elaborated to define Job Requirements 45; and
(iii) The Job Requirements 45 are validated or qualified using Acceptance Criteria 46, after a contract is signed against a given job, the job is decomposed to define its implementation elements.

5. The Online Freelancing system 300 of claim 1, wherein said system automatically prioritizes various job proposals submitted by different Project Managers and presents a prioritized list to the Customer, significant factors considered to prioritize are job proposal price, job proposal schedule completion date, Project Manager leadership score, average of Freelancer performance scores, delivered defect density on Project Managers' previous projects, schedule variance on Project Managers' previous projects, Project Managers' financial reliability score, Project Managers' Portfolio match with current job, Job Proposal Teams' Portfolios match with job requirement assignments, etc., the Customer chooses the best job proposal and awards the job to the Project Manager who has submitted that job proposal.

6. The Online Freelancing system 300 of claim 1, wherein system-prioritized list of integrated job proposals submitted by competing Project Managers are viewed by the Customer using a “job proposal prioritization settings slider” which comprises:
(i) Said slider essentially works by comparing job proposals and competing Job Proposal Teams based on several factors; and
(ii) The customers assign different weightages or importance to each factor, various factors considered may include average defect density on the Project Manager's previous projects, schedule variance on the Project Manager's previous projects, Project Manager's leadership score, average of Freelancer profile scores across all Freelancers or Freelance Company Consultants in a Job Proposal Team, Project Manager's financial reliability score, Project Manager's Portfolio match with current job, Job Proposal Team's Portfolio match with current job requirement group assignments, job proposal cost and job proposal execution schedule.

7. The Online Freelancing system 300 of claim 6, wherein average defect density on the Project Manager's previous projects comprises:
(i) Average Defect Density=Average of Sprint Delivered Defect Density across all jobs or all Sprints in jobs delivered; and
$$( ii ) Defect Density = \frac{\sum Delivered Defect Count \times Defect Severity}{\sum Sprint User Stories size in Story points}$$

8. The Online Freelancing system 300 of claim 1, wherein schedule variance on the Project Manager's previous projects comprises:
(i) Average Schedule variance=Average of Schedule variance across all jobs or all Sprints in jobs delivered; and
$$( ii ) Schedule variance = \frac{Actual Sprint duration excluding Change Requests}{Planned Sprint duration excluding Change Requests}$$

9. The Online Freelancing system 300 of claim 1, wherein Project Manager leadership score is an indicator of the Project Manager's capabilities on the job in the Project Management skill area within the proposed Online Freelancing system.

10. The Online Freelancing system 300 of claim 1, wherein a Project Manager can search for, identify, and invite the “Most suitable Freelancers” for a given Customer Job, further:
(i) A pre-Contract award process where a Project Manager can search for and identifies the most suitable Freelancers for a given Customer Job;
(ii) An approach to identify the most suitable Freelancers for a given Customer Job, using attributes such as: Capability match, Availability match, and Timezone match; and
(iii) “Freelancers' Team's Portfolio match to Customer job template” function is used to evaluate a Freelancer's Portfolio match to a given Customer Job and its requirements.

11. The Online Freelancing system 300 of claim 1, wherein highly-granular and partially automated “Freelancer Profile score” comprising Freelancer Performance Assessment score, Freelancer Job Continuity score, Freelancer Skills score and Freelancer Portfolio score based on the settings used on the Freelancer Profile score, further comprises:
(i) Freelancer Contract Performance Assessment scores across all worked jobs is aggregated and averaged to calculate the overall Freelancer Performance Assessment score for the Freelancer, said score is calculated using input factors comprising:
A. Number of delivered defects delivered by Freelancer;
B. Number of Story Points worked on by the Freelancer=Sum of Story points for the User Stories assigned to the Freelancer;
$$C . Defect density = \frac{Number of delivered defects}{Sum of Freelancer Story Points worked} ;$$
D. Quality score weightage=Weightage applied to defect density score while calculating Freelancer performance assessment score;
E. Schedule adherence=Adherence to Kanban Card plan dates across all User Stories assigned to Freelancer;
F. Timeliness score weightage=Weightage applied to schedule adherence score while calculating Freelancer performance assessment score;
G. Scope match score=Scoring for actual scope delivered vis-à-vis scope assigned to Freelancer. Measured by acceptance criteria met vs acceptance criteria defined;
H. Scope match weightage=Weightage applied to scope match score while calculating Freelancer performance assessment score;
I. Ownership score=Manual score provided by Project Manager to Freelancer, to assess the level of perceived interest and capability displayed by Freelancer in identifying and addressing the Customer's stated and unstated needs while working on assigned User Stories in a contract; and
J. Ownership score weightage=Weightage applied to ownership score while calculating Freelancer performance assessment score;
(ii) The Freelancer Skills score indicates the overall skill ownership of the Freelancer which is calculated by assessing a skill level score for each skill and skill level that the Freelancer possesses and aggregating these scores to calculate an overall Freelancer skills score;
(iii) Freelancer Portfolio score quantifies the overall work Portfolio of the Freelancer, by quantifying and aggregating work experience related scores for the Freelancer; and
(iv) Freelancer Job Continuity score quantifies the propensity of a Freelancer to take a contracted Job to its logical completion, across all contracted Jobs.

12. The Online Freelancing system 300 of claim 1, wherein a Customer can search for and invite the most suitable Project Managers for a given Customer Job, comprises:
(i) A list of Project Managers most suitable to execute a given Customer Job, given a variety of factors such as Capability match, Availability match, and Timezone match;
(ii) Identify the most suitable Project Managers for a given Customer Job and match; and
(iii) Evaluate a Project Manager's Work Portfolio match to a given Customer Job.

13. The Online Freelancing system 300 of claim 1, wherein highly-granular or partially automated “Project Manager Leadership Assessment score” which uses four factors to arrive such as Project Manager Contract Leadership Assessment score, Project Manager Project Management Certifications score, Project Manager Project Management Experience score, and Project Manager Project Management Skills score, further:
(i) The Project Manager detailed Contract Leadership score is calculated by the proposed Online Freelancing system, by multiplying scores related to the components job proposal completeness rating, Contract Team selection effectiveness rating, Contract Team leadership effectiveness rating, Product Backlog completeness (scope coverage) rating, release planning effectiveness rating, work Execution Management effectiveness rating, Sprint or release governance effectiveness rating, Product Quality Management rating, Meeting Management effectiveness rating, Communication Management effectiveness rating, invoicing accuracy rating, payments accuracy rating, payments timeliness rating, product and contract ownership rating, contract flexibility rating, and project type weightage factor;
(ii) Job proposal completeness rating indicates quality of job proposals submitted by Project Managers in response to a Customer job, said rating is submitted by the Customer against job proposals submitted, and this value is not shared with the respective Project Managers who have submitted the job proposals which is measured by examining job proposal coverage on aspects such as, coverage of job requirements as stated by the Customer, job proposal solutions or approaches mapping to job requirements, job requirements and solutions dependencies identification, job requirements and solutions risks identification, Job Proposal Team mapping to job requirements execution skills needed, etc.;
(iii) The Contract Team selection effectiveness rating indicates the Project Manager's diligence in searching for, identifying, and engaging right group of Freelancers with the right freelance work domain expertise, required skills and skill levels, and required work Portfolio experience to be part of the Contract Execution team, and to execute a given contract in the manner most satisfactory to the Customer, the Contract Team selection effectiveness rating is submitted by the Customer at the end of each contract;
(iv) The Contract Team leadership effectiveness rating indicates the Project Manager's ability and interest in driving alignment of a Contract Execution Team on a specific contract into a collaborative, cohesive, and unified team, using team forming or norming or storming or performing techniques, key factors or contextual elements that impact team formation includes cultural aspects tied to Country of origin, geographical location, religion, etc., education, prior work experience and working culture in previous organizations, language, operating time zone, etc and key techniques used to drive team formation may include Contract Execution Team vision setting, Contract Execution Team responsibility or accountability or consulting or information (RACI) Matrix definition, Contract Execution Team's team charter definition, etc.;
(v) The Product Backlog completeness (scope coverage) rating denotes the Project Manager's diligence demonstrated on developing a complete Product Backlog for a specific contract that addresses all required components as explicitly stated in the job as well as other required components that are to be implicitly understood given the right insight into Freelance work domain, skill areas, etc.;
(vi) The release planning effectiveness rating specifies the Project Manager's diligence demonstrated on developing a comprehensive contract release plan for a specific contract, considering job-related attributes such as Epics, User Stories, User Story dependencies, and other qualifications which includes User Story criticality, User Story deployment urgency, User Story usage level, User Story size or complexity, etc., as well as Contract Execution Team-related attributes such as Freelancer Team availability planning, Freelancer Team capacity planning, Customer Team availability planning, etc.
(vii) The work Execution Management effectiveness rating indicates Project Manager's perceived effectiveness in managing work execution from the Contract Execution team's perspective on a specific contract;
(viii) In order to drive effectiveness, the Project Manager may leverage the following techniques, drive daily updates of Kanban Boards and Kanban Cards in line with job execution, download available contract execution reports, such as Sprint Burn-up or Burn-down chart, issues log, risks log, delivered defects log, etc., conduct virtual stand-up meetings with the Contract Execution team, use actions register to document and track meeting action items to closure, etc.;
(ix) The Sprint or Release governance effectiveness rating indicates Project Manager's effectiveness in planning and performing governance of contract release and contract Sprints, both from a Customer perspective as well as from a Contract Execution Team perspective on a specific contract;
(x) The Project Manager also plans for and execute appropriate corrective actions, such as deep-dive analysis, re-plans, etc., to recover contracts that are moving away from plan;
(xi) The product Quality Management rating indicates the Project Manager's ability to drive quality of the products delivered to the Customer, measured by the ratio of delivered defects per Story Point;
(xii) Meeting Management effectiveness rating indicates the Project Manager's effectiveness on a specific contract in planning, scheduling and conducting Customer and or Freelancer meetings, as well as following up on and tracking to closure of actions due that have been raised during the meetings;
(xiii) The Communication Management effectiveness rating indicates the Project Manager's effectiveness on a specific contract in planning and performing contract communications from the following perspectives communications scope or content planning, frequency of communications, depth of planned coverage of communications, tailored to various Stakeholders and their needs and expectations, delivering to plan on scope or content and schedule, etc.;
(xiv) The invoicing accuracy rating indicates the Project Manager's diligence on a specific contract in raising Customer Sprint invoices that are consistently accurate throughout the life of the contract;
(xv) The payments accuracy rating indicates the Project Manager's diligence on a specific contract in making payments against Freelancer Sprint invoices that are consistently accurate throughout the life of the contract;
(xvi) The payments timeliness rating indicates the Project Manager's diligence on a specific contract in making payments against Freelancer Sprint invoices that are consistently meets the “invoice payment turnaround time” metric, throughout the life of the contract;
(xvii) The “invoice payment turnaround time” metric may be defined as part of the Customer contract;
(xviii) The Product and contract ownership rating specifies the Project Manager's perceived (from Customer's perspective) breadth and depth of interest, involvement, and customer engagement on a specific contract on developing services, deliverables, or outcomes for the Customer, covering aspects such as,
A. Does the Project Manager lead and drive the contract execution team on a given contract to gain insights into both stated or explicit and unstated or implicit requirements?
B. Does the Project Manager lead and drive the contract execution team on a given contract to think from the Customer's organizational and market context, so as to define the most complete solutions possible?
C. Does the Project Manager lead and drive the contract execution team on a given contract to actively collaborate with and engage the Customer team, and validate assumptions, approaches, solutions, etc., so as to achieve expected job outcomes in the most productive and efficient manner?
(xix) The contract flexibility rating indicates the Project Manager's perceived (from Customer's perspective) flexibility on a specific contract, in accommodating changes to stated job requirements, and containing impacts to the contract terms and conditions, contract costs, contract schedules, etc. to a reasonable level;
(xx) The project type weightage factor are scores corresponding to different contract types applicable to the specific contract such as Build-Operate-Transfer (BOT), project, and operations;
(xxi) The Project Manager Project Management certifications score is a score that provides insight into the relative acceptability of various Project Management certifications that a Project Manager may hold;
(xxii) The Project Manager's Project Management certifications score calculator uses the Project Management certifications data that is manually submitted by the Project Manager as input, Project Manager Project Management experience score is a score that provides insight into the Project Management experience that a Project Manager holds;
(xxiii) The Project Manager's Project Management experience score calculator may use the Project Management experience data that is manually submitted by the Project Manager as input, Project Manager Project Management skills score is a score that provides insight into the Project Management skills that a Project Manager has acquired by attending various training programmes, as well as by executing various work tasks or projects; and
(xxiv) The Project Manager's Project Management skills score uses the Project Management skills data that is manually submitted by the Project Manager as input.

14. The Online Freelancing system 300 of claim 1, wherein highly-granular or fully automated “Project Manager Financial Reliability Assessment score” is calculated by Project Manager financial reliability calculator which uses the formula,
(i) Project Manager financial reliability is measured from two perspectives such as Schedule variance of Freelancer invoice payments, and completeness or accuracy of Freelancer invoice payments;
A. Actual invoice payment date is date on which the Project Manager has made a payment against a specific Freelancer invoice;
B. Invoice submission date is the date on which the Freelancer has submitted the invoice to the Project Manager; and
C. Planned invoice payment date is the date on which the Project Manager is mandated by contract to pay a specific invoice, typically, within “x” days after “invoice submission date”, where “x” is defined in the Freelancer sub-contract;
$$( ii ) Schedule variance of Freelancer Sprint invoice payments = \frac{( Actual invoice payment date - invoice submission date )}{( Planned invoice payment date - invoice submission date )}$$
$$( iii ) Payment accuracy or completeness of Sprint invoice payments = \frac{( Sprint Payment submitted - Sprint invoice amount )}{Sprint invoice amount}$$
A. Sprint invoice amount is the amount stated in the Freelancer's Sprint invoice submitted to the Project Manager, and Sprint Payment submitted is the amount of payment submitted by the Project Manager against a Freelancer invoice; and
(iv) Settings on the Project Manager financial reliability calculator.

15. The Online Freelancing system 300 of claim 1, wherein highly granular or fully automated “Customer Financial Reliability Assessment score” by a Customer financial reliability calculator, said Customer financial reliability is measured from two perspectives, schedule variance of Project Manager invoice payments, and completeness and accuracy of Project Manager invoice payments, and automatically assess Customer financial reliability, by assessing timeliness and completeness or accuracy of payments made against Project Manager invoices in that Sprint,
$$( i ) Schedule variance of Project Manager Sprint invoice Payments = \frac{( Actual invoice Payment date - invoice Submission date )}{( Planned invoice Payment date - invoice Submission date )}$$
A. Actual invoice Payment date=Date on which Customer has made a payment against a specific Project Manager invoice;
B. Invoice Submission date=Date on which Project Manager has submitted the invoice to the Customer; and
C. Planned invoice Payment date=Date on which the Customer is mandated by contract to pay a specific invoice, typically, within “x” days after “invoice Submission date”, where “x” is defined in the Customer contract; and
$$( ii ) Payment accuracy or completeness of Sprint invoice payments = \frac{( Sprint Payment submitted - Sprint invoice Amount )}{Sprint invoice Amount}$$
A. Sprint invoice amount=The amount stated in the Project Manager's Sprint invoice submitted to the Customer, and Sprint Payment submitted=The amount of payment submitted by the Customer against a Project Manager invoice.

16. The Online Freelancing system 300 of claim 1, wherein Project Managers, Freelancers, and Freelance Companies can identify the “most likeable Customers” to work for, based on a variety of attributes such as Customer Financial Reliability score, Customer Financial Reliability score trends, Customer Platform spends, and the Operating Timezone difference between the Customers' Operating Timezone and that of the user in question, further,
(i) Customer Financial Reliability score is calculated and averaged across all Jobs executed by a Customer on the Online Freelancing system;
(ii) Customer Financial Reliability score trends are calculated across all Jobs executed by a Customer within a specific period on the Online Freelancing system;
(iii) Customer Platform spends is calculated by aggregating all the Project Manager Invoices raised against the Customer across all Jobs executed within a specific period; and
(iv) The Timezone difference between a Customer's primary Operating Timezone and that of a given Project Manager, is also used to prioritize the most likeable Customers.

17. A method of job proposal development subsequent to a Customer publishing a job in the Online Freelancing system 300 of claim 1, comprising the steps of:
(i) The Customer publishes the job on the said system;
(ii) The Project Manager search for, invite and engage a Virtual Team of Freelancers who fit the job's context in terms of Freelance work domain, skills, skill levels, and work Portfolio, and assigns job requirements to each Freelancer in the team;
(iii) Freelancers in the team analyse the job and develop job component proposals in response to their respective job requirement assignments and submits to the Project Manager;
(iv) The Project Manager integrates the job component proposals to develop an integrated job proposal; and
(v) The Project Manager then develops a corresponding cost proposal; and
(vi) The Project Manager submits the integrated job proposal and cost proposal to the Customer.
